(19) United States
(12) Patent Application Publication
(10) Pub. No.: US 2025/0172731 A1
(43) Pub. Date: May 29, 2025

(54) POLARIZING PLATE

(71) Applicant: FUJIFILM Corporation, Tokyo (JP)

(72) Inventors: Mayumi NOJIRI, Kanagawa (JP); Yuki HIRAI, Kanagawa (JP); Kazuyoshi OKADA, Kanagawa (JP); Ryoji HIMENO, Kanagawa (JP)

(73) Assignee: FUJIFILM Corporation, Tokyo (JP)

(21) Appl. No.: 19/039,481

(22) Filed: Jan. 28, 2025

Related U.S. Application Data
(63) Continuation of application No. PCT/JP2023/026883, filed on Jul. 21, 2023.

(30) Foreign Application Priority Data
Jul. 29, 2022 (JP) 2022-122203

(51) Int. Cl. G02B 5/30

(52) U.S. Cl. CPC G02B 5/3041; G02B 5/3083

(57) ABSTRACT

A polarizing plate including a first light absorption anisotropic layer containing a first dichroic coloring agent, which has a first light absorption property in which an absorbance is maximal at a first wavelength, and has a first absorption axis exhibiting the first light absorption property along one direction, and a second light absorption anisotropic layer containing a second dichroic coloring agent, which has a second light absorption property in which an absorbance is maximal at a second wavelength different from the first wavelength, and has a second absorption axis exhibiting the second light absorption property along one direction, in which the first light absorption anisotropic layer and the second light absorption anisotropic layer are laminated in an aspect in which the first absorption axis and the second absorption axis intersect with each other.

### CROSS-REFERENCE TO RELATED APPLICATIONS

This application is a continuation of International Application No. PCT/JP2023/026883, filed on Jul. 21, 2023, which was published under PCT Article 21(2) in Japanese, and which claims priority from Japanese Patent Application No. 2022-122203, filed on Jul. 29, 2022. The entire disclosure of each of the above applications is incorporated herein by reference.

### BACKGROUND

### 1. Technical Field

The present disclosure relates to a polarizing plate.

### 2. Description of the Related Art

As an optical element capable of extracting polarized light in which a vibration direction of an electric field is regular, from natural light in which the vibration direction of the electric field is random, a polarizer has been known. The polarized light has a shape such as linearly polarized light, circularly polarized light, and elliptically polarized light, according to a change in trajectory of a tip of an electric field vector in a case of being viewed in a propagation direction. The shape of such polarized light can be changed by controlling a relative retardation between two components of the electric field vector orthogonal to each other in a plane perpendicular to the propagation direction of light. A retardation control element has been known as an optical element which controls the retardation between two components of the electric field vector.

WO2018/221598A proposes an optical control device capable of extracting two linearly polarized light which are linearly polarized light having different two wavelength ranges in an infrared range and a visible range, from natural light having both the wavelength ranges in the infrared range and the visible range, and are linearly polarized lights in different vibration directions (also referred to as polarization directions). The optical control device of WO2018/221598A includes a polarizer for an infrared range, having optical properties capable of extracting linearly polarized light in an infrared range from the natural light; a polarizer for a visible range, having optical properties capable of extracting linearly polarized light in a visible range from the natural light; and a retardation control element. In the optical control device of WO2018/221598A, each of the optical elements of the polarizer for an infrared range, the polarizer for a visible range, and the retardation control element is an independent constituent element.

### SUMMARY

In a case where each of the plurality of polarizers and the retardation control element is independent as in the optical control device of WO2018/221598A, there is a problem that handling is difficult.

Technology of the present disclosure provides a polarizing plate which is easy to handle and can convert light in a plurality of different wavelength ranges into linearly polarized lights in different polarization directions.

The polarizing plate according to the present disclosure includes a first light absorption anisotropic layer containing a first dichroic coloring agent, which has a first light absorption property in which an absorbance is maximal at a first wavelength, and has a first absorption axis exhibiting the first light absorption property along one direction, and a second light absorption anisotropic layer containing a second dichroic coloring agent, which has a second light absorption property in which an absorbance is maximal at a second wavelength different from the first wavelength, and has a second absorption axis exhibiting the second light absorption property along one direction, in which the first light absorption anisotropic layer and the second light absorption anisotropic layer are laminated in an aspect in which the first absorption axis and the second absorption axis intersect with each other.

At least one of the first wavelength or the second wavelength may be in a range of 700 nm or more and 1500 nm or less.

Both of the first wavelength or the second wavelength may be in a range of 700 nm or more and 1500 nm or less.

It is preferable that an absolute value of a difference between the first wavelength at which a maximal value is exhibited in a first absorption spectrum of the first light absorption anisotropic layer and the second wavelength at which a maximal value is exhibited in a second absorption spectrum of the second light absorption anisotropic layer is larger than an average value of a half width at half maximum of the first absorption spectrum and a half width at half maximum of the second absorption spectrum.

An average of single transmittances in a wavelength range of 400 nm or more and less than 700 nm may be 50% or more.

It is preferable that the first absorption axis and the second absorption axis are orthogonal to each other, and no retardation layer which provides a retardation in transmitted light is provided between the first light absorption anisotropic layer and the second light absorption anisotropic layer.

Alternatively, the first absorption axis and the second absorption axis may be not orthogonal to each other; the polarizing plate may include, between the first light absorption anisotropic layer and the second light absorption anisotropic layer, a first retardation layer that is a retardation layer which provides a retardation in transmitted light, in which in a case where the first wavelength is denoted by λ1, a retardation generated in light having the first wavelength λ1, which has been transmitted through the second light absorption anisotropic layer, is denoted by ReP2(λ1), and a retardation generated in light having the first wavelength λ1, which has been transmitted through the retardation layer, is denoted by ReR1(λ1), the following expression E1 is satisfied, and the first retardation layer may be disposed in an aspect in which a first slow axis which is a slow axis of the first retardation layer is orthogonal to the second absorption axis.

$$Re P 2 ( λ 1 ) / Re R 1 ( λ1 ) = 1 \pm 0.2 \qquad Expression E 1$$

Furthermore, the first absorption axis and the second absorption axis may be not orthogonal to each other, and in a case where the first wavelength is denoted by λ1 and a retardation generated in light having the first wavelength λ1, which has been transmitted through the second light absorption anisotropic layer, is denoted by ReP2(λ1), the following expression E2-1 or E2-2 may be satisfied.

$$Re P 2 ( λ 1 ) / λ 1 = 1 \pm 0.2 \qquad Expression E 2 - 1$$

$$Re P 2 ( λ 1 ) / λ 1 = 0.5 \pm 0.1 \qquad Expression E 2 - 2$$

The polarizing plate according to the present disclosure may further include a third light absorption anisotropic layer containing a third dichroic coloring agent, which has a third light absorption property in which an absorbance is maximal at a third wavelength different from the first wavelength and the second wavelength, and has a third absorption axis exhibiting the first light absorption property along one direction, in which the third light absorption anisotropic layer may be disposed in an aspect in which the third absorption axis intersects with at least one of the first absorption axis or the second absorption axis.

In the polarizing plate according to the present disclosure, in a case of including the third light absorption anisotropic layer, the third light absorption anisotropic layer, the first light absorption anisotropic layer, and the second light absorption anisotropic layer may be laminated in this order from an incident direction of light, the first absorption axis and the third absorption axis may be parallel to each other, and in a case where the third wavelength is denoted by λ3 and a retardation generated in light having the third wavelength λ3, which has been transmitted through the second light absorption anisotropic layer, is denoted by ReP2(λ3), two expressions of the expression E2-1 and the following expression E3-1 may be satisfied, or two expressions of the expression E2-2 and the following expression E3-2 may be satisfied.

$$Re P 2 ( λ 3 ) / λ 3 = 0.5 \pm 0.1 \qquad Expression E 3 - 1$$

$$Re P 2 ( λ 3 ) / λ 3 = 1 \pm 0.2 \qquad Expression E 3 - 2$$

In the polarizing plate according to the present disclosure, in a case of including the first retardation layer and the third light absorption anisotropic layer, it is preferable that the third light absorption anisotropic layer, the first light absorption anisotropic layer, the first retardation layer, and the second light absorption anisotropic layer are laminated in this order from an incident direction of light, the first absorption axis and the third absorption axis are orthogonal to each other, and in a case where the third wavelength is denoted by λ3, a retardation generated in light having the third wavelength λ3, which has been transmitted through the second light absorption anisotropic layer, is denoted by ReP2(λ3), and a retardation generated in light having the third wavelength λ3, which has been transmitted through the first retardation layer, is denoted by ReR1(λ3), the following expression E4 is satisfied.

$$Re P 2 ( λ 3 ) / Re R 1 ( λ3 ) = 1 \pm 0.2 \qquad Expression E4$$

In the polarizing plate according to the present disclosure, in a case of including the first retardation layer and the third light absorption anisotropic layer, the first light absorption anisotropic layer, the first retardation layer, the second light absorption anisotropic layer, and the third light absorption anisotropic layer may be laminated in this order from an incident direction of light, the third light absorption anisotropic layer may be disposed in an aspect in which the third absorption axis intersects with the first absorption axis and the second absorption axis, the polarizing plate may further include, between the second light absorption anisotropic layer and the third light absorption anisotropic layer, a second retardation layer which provides a retardation in transmitted light, in a case where a retardation generated in light having a second wavelength λ2, which has been transmitted through the third light absorption anisotropic layer, is denoted by ReP3(λ2), and a retardation generated in light having the second wavelength λ2, which has been transmitted through the second retardation layer, is denoted by ReR2(λ2), the second retardation layer may satisfy the following expression E5, and the second retardation layer may be disposed in an aspect in which a second slow axis which is a slow axis of the second retardation layer is orthogonal to the third absorption axis.

$$Re P 3 ( λ 2 ) / Re R 2 ( λ 2 ) = 1 \pm 0.2 \qquad Expression E5$$

In the polarizing plate according to the present disclosure, in a case of including the second retardation layer, it is preferable that the first absorption axis and the third absorption axis intersect with each other and are not orthogonal to each other, and in a case where a retardation generated in light having the first wavelength λ1, which has been transmitted through the third light absorption anisotropic layer, is denoted by ReP3(λ1), and a retardation generated in light having the first wavelength λ1, which has been transmitted through the second retardation layer, is denoted by ReR2(λ1), the second retardation layer satisfies the following expression E6.

$$Re P 3 ( λ 1 ) / Re R 2 ( λ 1 ) = 1 \pm 0.2 \qquad Expression E5$$

The first light absorption anisotropic layer may contain a fourth dichroic coloring agent in addition to the first dichroic coloring agent, and have a fourth light absorption property in which an absorbance is maximal at a fourth wavelength different from the first wavelength and the second wavelength, in which the first absorption axis is an absorption axis exhibiting the fourth light absorption property in addition to the first light absorption property; the first light absorption anisotropic layer, a third retardation layer, a fourth retardation layer, and the second light absorption anisotropic layer may be laminated in this order from an incident direction of light; the third retardation layer may be a retardation layer which selectively provides a retardation for changing a polarization direction with respect to one light having the first wavelength or the fourth wavelength, which is output from the first light absorption anisotropic layer; in a case where the first wavelength is denoted by λ1, the fourth wavelength is denoted by λ4, a retardation generated in light having the first wavelength λ1 transmitted through the fourth retardation layer is denoted by ReR4(λ1), a retardation generated in light having the first wavelength λ1, which has been transmitted through the second light absorption anisotropic layer, is denoted by ReP2(λ1), a retardation generated in light having the fourth wavelength λ4 transmitted through the fourth retardation layer is denoted by ReR4(λ4), and a retardation generated in light having the fourth wavelength λ4, which has been transmitted through the second light absorption anisotropic layer, is denoted by ReP2(λ4), the fourth retardation layer may satisfy at least one of the following expression E7-1 or E7-2; and the fourth retardation layer may be disposed in an aspect in which a fourth slow axis which is a slow axis of the fourth retardation layer is orthogonal to the second absorption axis.

$$Re P 2 ( λ 1 ) / Re R 4 ( λ 1 ) = 1 \pm 0.2 \qquad Expression E 7 - 1$$

$$Re P 2 ( λ 4 ) / Re R 4 ( λ 4 ) = 1 \pm 0.2 \qquad Expression E 7 - 2$$

The polarizing plate according to the present disclosure is easily handled and can convert light in a plurality of different wavelength ranges into linearly polarized lights in different polarization directions.

### BRIEF DESCRIPTION OF THE DRAWINGS

FIG. 1 is a perspective view showing an overall configuration of a polarizing plate according to a first embodiment.

FIG. 2 is an explanatory view for describing each layer of the polarizing plate according to the first embodiment and a polarization state in a case in which light is transmitted through each layer.

FIG. 3 is an explanatory diagram of a first absorption spectrum and a second absorption spectrum.

FIG. 4 is a perspective view showing an overall configuration of a polarizing plate according to a second embodiment.

FIG. 5 is an explanatory view for describing each layer of the polarizing plate according to the second embodiment and a polarization state in a case which light is transmitted through each layer.

FIG. 6 is an explanatory view for describing each layer of a polarizing plate according to a third embodiment and a polarization state in a case in which light is transmitted through each layer.

FIG. 7 is a perspective view showing an overall configuration of a polarizing plate according to a fourth embodiment.

FIG. 8 is an explanatory view for describing each layer of the polarizing plate according to the fourth embodiment and a polarization state in a case in which light is transmitted through each layer.

FIG. 9 is a diagram showing an example of a wavelength dependence of a retardation of a second light absorption anisotropic layer in the polarizing plate according to the fourth embodiment.

FIG. 10 is an explanatory view for describing each layer of a polarizing plate according to a fifth embodiment and a polarization state in a case in which light is transmitted through each layer.

FIG. 11 is a diagram showing an example of a wavelength dependence of a retardation of a second light absorption anisotropic layer and a wavelength dependence of a retardation of a first retardation layer in the polarizing plate according to the fifth embodiment.

FIG. 12 is an explanatory view for describing each layer of a polarizing plate according to a sixth embodiment and a polarization state in a case in which light is transmitted through each layer.

FIG. 13 is an explanatory view for describing each layer of a polarizing plate according to a seventh embodiment and a polarization state in a case in which light is transmitted through each layer.

FIG. 14 is a diagram showing an example of a wavelength dependence of a retardation of a third light absorption anisotropic layer and a wavelength dependence of a retardation of a second retardation layer in the polarizing plate according to the seventh embodiment.

FIG. 15 is an explanatory view for describing each layer of a polarizing plate according to an eighth embodiment and a polarization state in a case in which light is transmitted through each layer.

FIG. 16 is a schematic diagram showing a configuration example of a multispectral camera to which a polarizing plate is applied.

FIG. 17 is an explanatory view of a method of evaluating discriminability of a polarizing plate of Examples.

### DESCRIPTION OF EMBODIMENTS

Hereinafter, the polarizing plate according to the embodiment of the present disclosure will be described with reference to the drawings. Constituent elements indicated by the same reference numeral in the drawings mean the same constituent element. However, unless otherwise specified in the specification, each constituent element is not limited to one and may be plural.

### First Embodiment

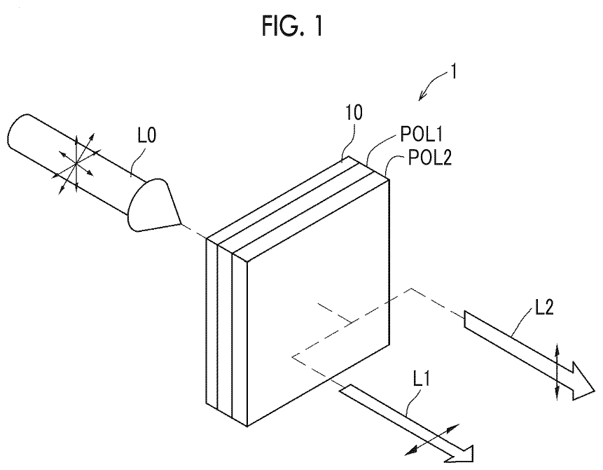

FIG. 1 is a perspective view showing an overall configuration of a polarizing plate 1 according to a first embodiment.

As shown in FIG. 1, the polarizing plate 1 includes a first light absorption anisotropic layer POL1 and a second light absorption anisotropic layer POL2. The polarizing plate 1 has a support 10 having light-transmitting property, and the first light absorption anisotropic layer POL1 and the second light absorption anisotropic layer POL2 are formed on the support 10. In a case where non-polarized incidence ray L0 including light having a first wavelength λ1 and light having a second wavelength λ2 is incident into the polarizing plate 1, the polarizing plate 1 outputs first linearly polarized light L1 and second linearly polarized light L2 having different polarization directions for each of the first wavelength λ1 and the second wavelength λ2. Here, the “non-polarized” means natural light which is an optical wave in which a vibration direction of an electric field is random. In addition, the “polarized” is light in which the vibration direction of the electric field is regular, and the polarization direction is synonymous with the vibration direction of the electric field. The linearly polarized light refers to polarized light in which an orientation of an electric field vector in a plane perpendicular to a propagation direction of light is constant.

In the example of FIG. 1, in order to indicate that the polarization direction is random, the incidence ray L0 is schematically shown in a substantially columnar shape, and arrows radially extending in eight directions from a center of the columnar shape are superimposed on the columnar shape. On the other hand, the first linearly polarized light L1 and the second linearly polarized light L2 having the polarization directions in the one direction are schematically shown in a flat plate shape, and a double arrow is superimposed on each flat plate shape. The polarization directions of the first linearly polarized light L1 and the second linearly polarized light L2 are orthogonal to each other, and in a case where the polarization direction of the first linearly polarized light L1 is a horizontal direction, the polarization direction of the second linearly polarized light L2 is a vertical direction.

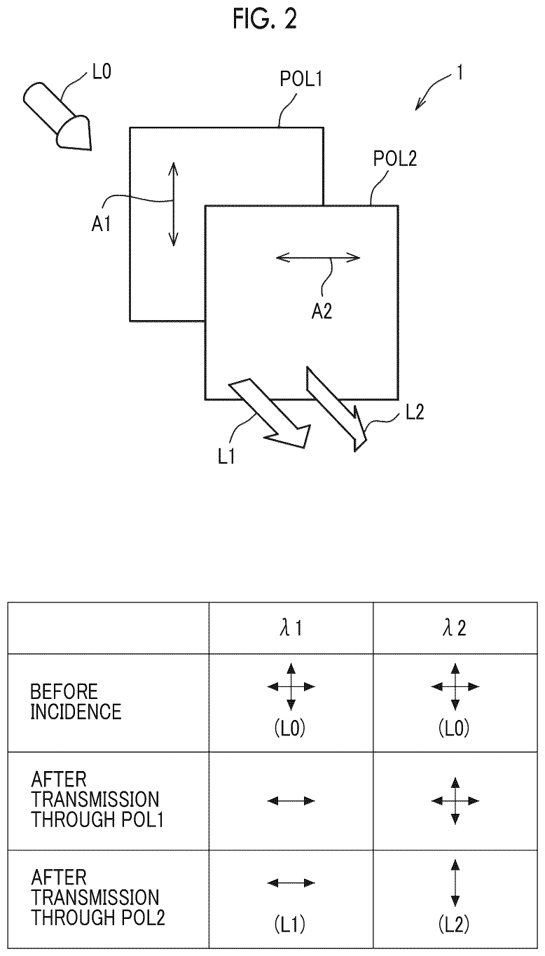

FIG. 2 is a schematic view showing each layer of the polarizing plate 1 in a decomposed manner, and shows two layers of the first light absorption anisotropic layer POL1 and the second light absorption anisotropic layer POL2, in which the support 10 is not shown.

The first light absorption anisotropic layer POL1 contains a first dichroic coloring agent and has a first light absorption property in which an absorbance is maximal at the first wavelength λ1. The first light absorption anisotropic layer POL1 has a first absorption axis A1 exhibiting the first light absorption property in one direction. The second light absorption anisotropic layer POL2 contains a second dichroic coloring agent and has a second light absorption property in which an absorbance is maximal at the second wavelength λ2 different from the first wavelength λ1. The second light absorption anisotropic layer POL2 has a second absorption axis A2 exhibiting the second light absorption property in one direction. Here, the first dichroic coloring agent and the second dichroic coloring agent are dichroic coloring agents different from each other. The first light absorption property in the first light absorption anisotropic layer POL1 is derived from the first dichroic coloring agent and an associated state thereof; and the second light absorption property in the second light absorption anisotropic layer POL2 is derived from the second dichroic coloring agent and an associated state thereof.

The dichroic coloring agent is a coloring agent having an elongated molecular shape, and has a property of, in the incidence ray, absorbing a polarized light component which vibrates in a major axis direction of the molecule and allowing transmission of a polarized light component which vibrates in a direction orthogonal to the major axis direction of the molecule. The first light absorption anisotropic layer POL1 and the second light absorption anisotropic layer POL2 are each imparted with the first absorption axis A1 and the second absorption axis A2 by controlling alignment of the dichroic coloring agent contained in each of the layers. In a case where the non-polarized incidence ray L0 is incident into the first light absorption anisotropic layer POL1, in the light having the first wavelength λ1, the first light absorption anisotropic layer POL1 absorbs a polarized light component which vibrates in an axial direction of the first absorption axis A1, and allows transmission of a polarized light component which vibrates in a direction orthogonal to the first absorption axis A1. The phenomenon in which the light absorption property is exhibited only for the polarized light component in the specific vibration direction is referred to as light absorption anisotropy.

By having such a property, the first light absorption anisotropic layer POL1 can convert the non-polarized incidence light having the first wavelength λ1 into the first linearly polarized light L1 having a polarization direction orthogonal to the first absorption axis A1. Similarly, in the light having the second wavelength λ2, the second light absorption anisotropic layer POL2 absorbs a polarized light component which vibrates in an axial direction of the second absorption axis A2, and allows transmission of a polarized light component which vibrates in a direction orthogonal to the second absorption axis A2. The second light absorption anisotropic layer POL2 can convert the non-polarized light having the second wavelength λ2 into the second linearly polarized light L2 having a polarization direction orthogonal to the second absorption axis A2. Each of the first light absorption anisotropic layer POL1 and the second light absorption anisotropic layer POL2 selectively exhibits the light absorption anisotropy with respect to one of the first wavelength λ1 and the second wavelength λ2. In the following, “the light absorption anisotropy does not act” means that such a light absorption property is not exhibited.

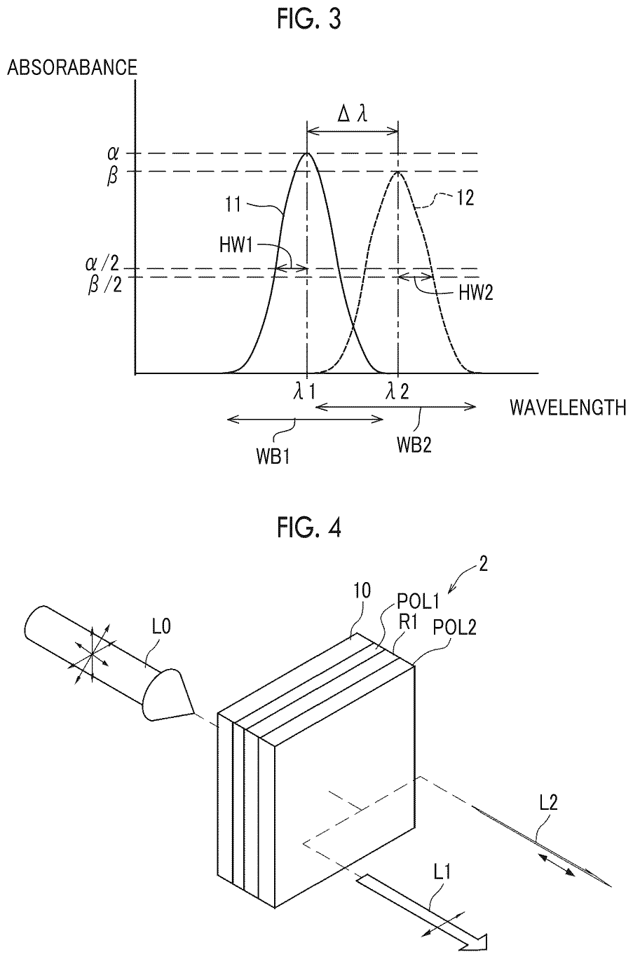

FIG. 3 shows an absorption spectrum 11 of the first light absorption anisotropic layer POL1 (hereinafter, referred to as a first absorption spectrum 11) and an absorption spectrum 12 of the second light absorption anisotropic layer POL2 (hereinafter, referred to as a second absorption spectrum 12). In FIG. 3, the horizontal axis indicates a wavelength, and the vertical axis indicates an absorbance. The first light absorption property is represented by the first absorption spectrum 11 having a peak at which the absorbance is maximal at the first wavelength λ1. A maximal value of the absorbance of the first absorption spectrum 11 is indicated by a. A reference numeral WB1 is the maximum width of the first absorption spectrum 11. A half width HW1 at half maximum of the first absorption spectrum 11 is a half width of the first absorption spectrum 11 at a half value α/2 of the maximal value α.

On the other hand, the second light absorption property is represented by the second absorption spectrum 12 having a peak at which the absorbance is maximal at the second wavelength λ2. A maximal value of the absorbance of the second absorption spectrum 12 is indicated by β. A half width HW2 at half maximum of the second absorption spectrum 12 is a half width of the second absorption spectrum 12 at a half value β/2 of the maximal value β. A reference numeral WB2 is the maximum width of the second absorption spectrum 12.

In this way, the first absorption spectrum 11 and the second absorption spectrum 12 have widths. Therefore, wavelength ranges included in the first linearly polarized light L1 and the second linearly polarized light L2 also have widths. In general, a wavelength at which a peak is exhibited in an absorption spectrum is referred to as an absorption maximal wavelength. That is, the first wavelength λ1 is the absorption maximal wavelength in the first absorption spectrum, and the second wavelength λ2 is the absorption maximal wavelength in the second absorption spectrum. Here, actions of the first light absorption property and the second light absorption property will be described using the first wavelength λ1 and the second wavelength 22, which are the absorption maximal wavelengths.

As shown in FIG. 3, the first absorption spectrum 11 and the second absorption spectrum 12 overlap each other in a tail portion where the absorbance is relatively low, but do not overlap each other in a region where the absorbance is higher than the tail portion and a half value of each of the maximal values is exhibited. Therefore, the first absorption spectrum 11 and the second absorption spectrum 12, and the first light absorption anisotropic layer POL1 and the second light absorption anisotropic layer POL2 have wavelength selectivity for different wavelengths, respectively.

In addition, in the polarizing plate 1, the first light absorption anisotropic layer POL1 having the first light absorption property and the second light absorption anisotropic layer POL2 having the second light absorption property are laminated on the support 10 in an aspect in which the first absorption axis A1 and the second absorption axis A2 intersect with each other.

In particular, in the polarizing plate 1 of the present example, for example, the first light absorption anisotropic layer POL1 and the second light absorption anisotropic layer POL2 are arranged in an aspect in which the first absorption axis A1 and the second absorption axis A2 are orthogonal to each other. In addition, different from examples described later, the polarizing plate 1 of the present example does not include, between the first light absorption anisotropic layer POL1 and the second light absorption anisotropic layer POL2, a retardation layer which provides a retardation in transmitted light. Here, the retardation layer means a retardation control element which controls a relative retardation between two components of an electric field vector orthogonal to a plane perpendicular to a propagation direction of light.

In addition, in the present specification, the fact that two axes “intersect with each other” means that the two axes are not parallel to each other. In addition, in the present specification, the terms “parallel” and “orthogonal” include a range of errors allowed in the technical field to which the present disclosure belongs. Specifically, it means within a range of ±10° from a strict angle related to the “parallel” or “orthogonal”. Therefore, the fact that two axes are “orthogonal to each other” means that an angle formed by the two axes is in a range of 90°±10°. The fact that two axes are “parallel to each other” means that an angle formed by the two axes is in a range of 0°±10°.

Here, an angle formed by the first absorption axis A1 and the second absorption axis A2 is defined as follows using the two axes as an example. The axial direction of the first absorption axis A1 shown in FIG. 2 is defined as a reference, and a clockwise direction is defined as a positive direction. A rotation angle of the second absorption axis A2 in a case where the second absorption axis A2 is rotated with respect to the first absorption axis A1 is set as the angle formed by the first absorption axis A1 and the second absorption axis A2, with a state in which axial directions of the first absorption axis A1 and the second absorption axis A2 completely match each other as an initial position. In a case where the axial directions of the first absorption axis A1 and the second absorption axis A2 completely match each other, that is, in a case where the second absorption axis A2 is at the initial position, the angle formed by the two axes is 0°. Under the premise that the above-described “parallel” includes a range of ±10°, the fact that “the first absorption axis A1 and the second absorption axis A2 intersect with each other”, that is, “the first absorption axis A1 and the second absorption axis A2 are not parallel to each other” means a range excluding 0°±10°, and means that the angle formed by the first absorption axis A1 and the second absorption axis A2 is more than 10° and less than 170°. In addition, under the premise that the above-described “orthogonal” includes a range of +10°, the fact that “the first absorption axis A1 and the second absorption axis A2 are orthogonal to each other” means that the angle formed by the first absorption axis A1 and the second absorption axis A2 is in a range of 90°+10°, that is, 80° or more and 100° or less.

As described above, in a case where the non-polarized incidence ray L0 including the first wavelength λ1 and the second wavelength λ2 is incident into the polarizing plate 1, the first linearly polarized light L1 of the first wavelength λ1 and the second linearly polarized light L2 of the second wavelength λ2 are output. The first linearly polarized light L1 has a polarization direction orthogonal to the first absorption axis A1; and the second linearly polarized light L2 has a polarization direction orthogonal to the second absorption axis A2. As described above, the polarizing plate 1 can output two of the first linearly polarized light L1 and the second linearly polarized light L2 having different polarization directions for each of the first wavelength λ1 and the second wavelength λ2. Since the polarizing plate 1 of the present example has the light absorption properties corresponding to the first absorption spectrum 11 and the second absorption spectrum 12, light having a wavelength other than the wavelengths included in the maximum width WB1 of the first absorption spectrum 11 and the maximum width WB2 of the second absorption spectrum 12 is not absorbed. Therefore, for example, in a case where the incidence ray L0 includes light having a wavelength other than wavelengths in the maximum width WB1 and the maximum width WB2, the polarizing plate 1 transmits the light as it is without being polarized.

The action of the polarizing plate 1 will be described in more detail with reference to the table in FIG. 2. In FIG. 2, the polarizing plate 1 is disposed such that the incidence ray L0 is incident in the order of the first light absorption anisotropic layer POL1 and the second light absorption anisotropic layer POL2. The table in FIG. 2 shows polarization states of each light of the first wavelength λ1 and the second wavelength λ2 included in the incidence ray L0, before incidence into the polarizing plate 1 (shown as “BEFORE INCIDENCE” in the table); polarization states after transmission through the first light absorption anisotropic layer POL1 and before incidence into the second light absorption anisotropic layer POL2 (shown as “AFTER TRANSMISSION THROUGH POL1” in the table); and polarization states after transmission through the second light absorption anisotropic layer POL2 (shown as “AFTER TRANSMISSION THROUGH POL2” in the table). In the table of FIG. 2, non-polarized light is indicated by a symbol in which double arrows in two orthogonal directions are superimposed. Linearly polarized light is indicated by a double arrow in one direction. A case where the orientations of the double arrows are different indicates that the light is linearly polarized in different orientations. The symbols shown in the table of FIG. 2 are the same in the tables of other drawings described later.

The incidence ray L0 is incident into the polarizing plate 1 from the first light absorption anisotropic layer POL1 side. The polarization states of the light having the first wavelength λ1 and the second wavelength λ2 included in the incidence ray L0 are unpolarized as shown in “BEFORE INCIDENCE” in the table of FIG. 2.

The action of the polarizing plate 1 of the present example on the incidence ray L0 shown in FIG. 2 will be described for each of the first wavelength λ1 and the second wavelength 22.

The polarizing plate 1 acts on light having the first wavelength λ1 in the incidence ray as follows. In the first light absorption anisotropic layer POL1 on which the incidence ray L0 is first incident, a polarized light component along the first absorption axis A1 (in the up-down direction in FIG. 2) in the light having the first wavelength λ1, which is included in the incidence ray L0, is absorbed. As a result, as shown in “AFTER TRANSMISSION THROUGH POL1” in the table of FIG. 2, the light having the first wavelength λ1, which has been transmitted through the first light absorption anisotropic layer POL1, is the first linearly polarized light L1 in a direction (left-right direction in the table of FIG. 2) orthogonal to the first absorption axis A1. The light having the first wavelength λ1 is incident into the second light absorption anisotropic layer POL2 as the first linearly polarized light L1. In the second light absorption anisotropic layer POL2, the light absorption anisotropy does not act on the light having the first wavelength λ. Therefore, as shown in “AFTER TRANSMISSION THROUGH POL2” in the table of FIG. 2, the first linearly polarized light L1 is transmitted through the second light absorption anisotropic layer POL2 while maintaining the polarization state after transmitting through the first light absorption anisotropic layer POL1. As a result, the first linearly polarized light L1 is output from the polarizing plate 1.

On the other hand, the polarizing plate 1 acts on light having the second wavelength λ2 in the incidence ray L0 as follows. In the first light absorption anisotropic layer POL1 on which the incidence ray is first incident, the light absorption anisotropy does not act on the light having the second wavelength λ2. Therefore, as shown in “AFTER TRANSMISSION THROUGH POL1” in the table of FIG. 2, the light having the second wavelength λ2 is transmitted through the first light absorption anisotropic layer POL1 in a non-polarized state. In the second light absorption anisotropic layer POL2, a polarized light component along the second absorption axis A2 in the light having the second wavelength λ2 is absorbed. As a result, as shown in “AFTER TRANSMISSION THROUGH POL2” in the table of FIG. 2, the light having the second wavelength λ2, which has been transmitted through the second light absorption anisotropic layer POL2, is the second linearly polarized light L2 in a direction (up-down direction in the table of FIG. 2) orthogonal to the second absorption axis A2.

Due to the above-described actions, the polarizing plate 1 can convert the non-polarized incidence ray L0 into the first linearly polarized light L1 having the first wavelength λ1, and the second linearly polarized light L2 having the second wavelength λ2, which has a polarization direction orthogonal to the first linearly polarized light L1.

As described above, the polarizing plate 1 includes the first light absorption anisotropic layer POL1 having the first light absorption property in which the absorbance is maximal at the first wavelength λ1, and the second light absorption anisotropic layer POL2 having the second light absorption property in which the absorbance is maximal at the second wavelength λ2 different from the first wavelength λ1. The first light absorption anisotropic layer POL1 and the second light absorption anisotropic layer POL2 are laminated in an aspect in which the first absorption axis A1 and the second absorption axis A2, which are an absorption axis of each layer, are not parallel to each other. Since the respective layers included in the polarizing plate 1 are laminated and integrated, handling is easy. The polarizing plate 1 has such a small configuration and can convert the light having a plurality of different wavelengths λ1 and 22 in the non-polarized incidence ray L0 into linearly polarized lights in different directions.

In the above-described example, wavelength ranges of the first wavelength λ1 and the second wavelength λ2 are not particularly limited. The first wavelength λ1 and the second wavelength λ2 may be, for example, in a visible range or in an infrared range. At least one of the first wavelength λ1 or the second wavelength λ2 may be in a near infrared range, specifically, in a range of 700 nm or more and 1500 nm or less. Furthermore, both of the first wavelength λ1 and the second wavelength λ2 may be in the range of 700 nm or more and 1500 nm or less.

In the polarizing plate 1, for example, in a case where at least one of the first wavelength λ1 or the second wavelength λ2 is in the range of 700 nm or more and 1500 nm or less, at least one wavelength of near-infrared light can be converted into linearly polarized light, and wavelengths in other wavelength ranges such as visible light and other near-infrared light can be converted into linearly polarized lights in different directions. The configuration in which at least one of the first wavelength λ1 or the second wavelength λ2 is in the range of 700 nm or more and 1500 nm or less can also be applied to polarizing plates 2 to 8 of embodiments described later, and the same effect can be obtained.

In addition, in the polarizing plate 1, for example, in a case where both of the first wavelength λ1 and the second wavelength λ2 are in the range of 700 nm or more and 1500 nm or less, the first wavelength λ1 and the second wavelength λ2 of the near-infrared light can be converted into linearly polarized lights in different directions. In recent years, a near-infrared sensor using near-infrared light has been used for a wide range of applications such as biometric authentication, distance measurement, eye gaze tracking, and foreign matter detection. These near-infrared sensors are mounted on a mobile device and the like. Sensing using near-infrared light has suitable wavelengths depending on a detection target; and for example, 760 nm is often used for vein authentication, 810 nm is often used for iris authentication, and 940 nm is often used for face authentication and distance measurement. Even in the same near-infrared light, in a case where a plurality of wavelengths used for different applications, for example, light of 760 nm and 940 nm can be distinguished, a plurality of near-infrared sensing can be performed with the same device. As described above, in a case where both of the first wavelength λ1 and the second wavelength λ2 are near-infrared light, the polarizing plate 1 can output the first wavelength λ1 and the second wavelength λ2, which are near-infrared light different from each other, as linearly polarized lights in different directions. Therefore, in a case where such a polarizing plate 1 and an image sensor having a polarization discrimination function capable of discriminating a plurality of linearly polarized lights in different polarization directions are used, it is possible to perform a plurality of infrared sensing with a single device. The configuration in which both of the first wavelength λ1 and the second wavelength λ2 are in the range of 700 nm or more and 1500 nm or less can also be applied to polarizing plates 2 to 8 of embodiments described later, and the same effect can be obtained.

In addition, in the above-described example, as shown in FIG. 3, the first absorption spectrum 11 having the absorption maximal wavelength at the first wavelength λ1 and the second absorption spectrum 12 having the absorption maximal wavelength at the second wavelength λ2 overlap each other in a part. As described above, even in a case where the first absorption spectrum 11 and the second absorption spectrum 12 overlap each other, the absorption maximal wavelengths thereof are different from each other, so that the polarizing plate 1 exhibits wavelength selectivity in which the polarizing plate 1 can be output as linearly polarized lights in different polarization directions for each wavelength.

However, both of the first light absorption anisotropic layer POL1 and the second light absorption anisotropic layer POL2 act on light in the region where the first absorption spectrum 11 and the second absorption spectrum 12 overlap each other. Therefore, as the number of overlapping regions increases, wavelength selection performance of the polarizing plate 1 decreases. In order to improve the wavelength selection performance, it is preferable that the number of overlapping regions is small. Specifically, it is preferable to satisfy the following condition. That is, in the first absorption spectrum 11 of the first light absorption anisotropic layer POL1 and the second absorption spectrum 12 of the second light absorption anisotropic layer POL2, it is preferable that an absolute value A2 of a difference between the first wavelength λ1 at which the maximal value is exhibited in the first absorption spectrum 11 and the second wavelength λ2 at which the maximal value is exhibited in the second absorption spectrum 12 is larger than an average value of the half width HW1 at half maximum of the first absorption spectrum 11 and the half width HW2 at half maximum of the second absorption spectrum 12. By satisfying the condition, favorable wavelength selection performance can be obtained as compared with a case where the condition is not satisfied.

In addition, in the polarizing plate 1, an average of single transmittances in a wavelength range of 400 nm or more and less than 700 nm, which is a visible range, may be more than 50%. The fact that the average of the single transmittances of the polarizing plate 1 in the visible range is more than 50% means that the polarizing plate 1 does not have polarization characteristics with respect to light in the visible range. In this case, the polarizing plate 1 can allow transmission of light in the visible range while maintaining the polarization state of the light to be incident. The configuration in which the average of the single transmittances in the wavelength range of 400 nm or more and less than 700 nm is 50% can also be applied to polarizing plates 2 to 8 of embodiments described later, and the same effect can be obtained. Here, the single transmittance is calculated from the following expression using, in a case where a linearly polarized light L1 is incident, a transmitted light intensity Lt1 in a case where a transmission axis direction of the polarizing plate coincides with a vibration direction of the incidence light, and a transmitted light intensity Lt2 in a case where an absorption axis direction of the polarizing plate coincides with the vibration direction of the incidence light.

Single transmittance=(Lt1+Lt2)/2Li

In the polarizing plate 1 of the present example, the first absorption axis A1 and the second absorption axis A2 are orthogonal to each other. Further, a retardation layer which provides a retardation in transmitted light is not provided between the first light absorption anisotropic layer POL1 and the second light absorption anisotropic layer POL2. The polarizing plate 1 can convert the first wavelength λ1 and the second wavelength λ2 into linearly polarized lights orthogonal to each other. In addition, the polarizing plate 1 does not need to include a retardation layer between the first light absorption anisotropic layer POL1 and the second light absorption anisotropic layer POL2, different from the polarizing plate 2 described later. Therefore, the polarizing plate 1 can be configured to be simple and thin as compared with the polarizing plate 2 described later, which includes the retardation layer.

As described above, in the above-described polarizing plate 1, the first light absorption anisotropic layer POL1 and the second light absorption anisotropic layer POL2 are laminated in an aspect in which the first absorption axis A1 and the second absorption axis A2 are orthogonal to each other. However, the polarizing plate according to the present disclosure is not limited to the above-described aspect, and the first light absorption anisotropic layer POL1 and the second light absorption anisotropic layer POL2 may be laminated in an aspect in which the first absorption axis A1 and the second absorption axis A2 are not parallel to each other.

### Second Embodiment

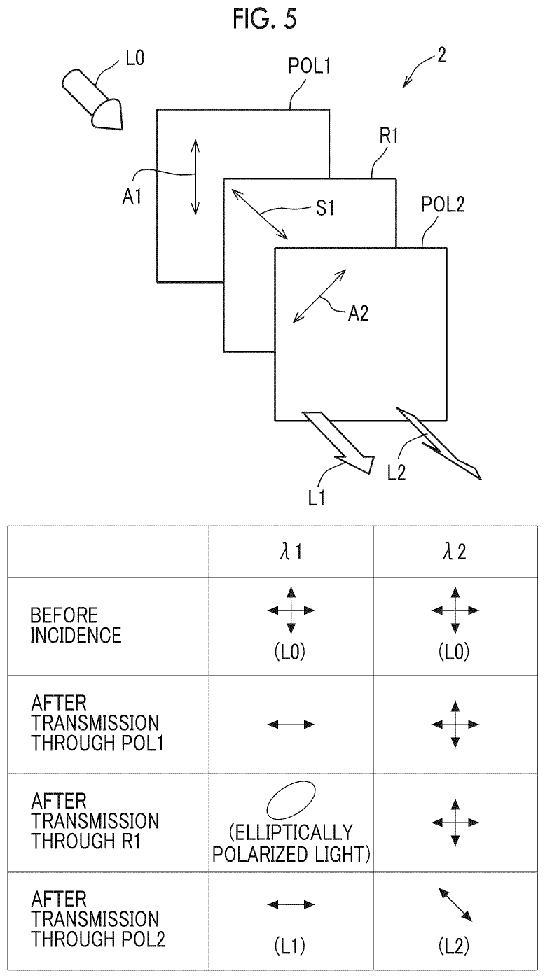

FIG. 4 is a perspective view showing an overall configuration of a polarizing plate 2 according to a second embodiment. FIG. 5 is a schematic view of the polarizing plate 2 showing the polarizing plate 2 decomposed for each layer, in which the support 10 is not shown. In the following embodiments, differences from the polarizing plate 1 according to the first embodiment will be mainly described. As in the polarizing plate 1 shown in FIG. 1, the polarizing plate 2 shown in FIG. 4 outputs the first linearly polarized light L1 and the second linearly polarized light L2 having different polarization directions, in a case where the non-polarized incidence ray L0 is incident. A functional difference between the polarizing plate 2 and the polarizing plate 1 is the polarization direction of the second linearly polarized light L2, and the second linearly polarized light L2 is not orthogonal to the first linearly polarized light L1.

In the polarizing plate 2 according to the second embodiment, as in the polarizing plate 1, the first light absorption anisotropic layer POL1 and the second light absorption anisotropic layer POL2 are laminated on the support 10 in an aspect in which the first absorption axis A1 and the second absorption axis A2 intersect with each other. However, in the polarizing plate 2, the first absorption axis A1 and the second absorption axis A2 are not orthogonal to each other. That is, the angle formed by the first absorption axis A1 and the second absorption axis A2 is in a range of more than 10° and less than 80°, or more than 100° and less than 170°. The polarizing plate 2 includes a first retardation layer R1 which provides a retardation in transmitted light between the first light absorption anisotropic layer POL1 and the second light absorption anisotropic layer POL2. As described above, the polarizing plate 2 is different from the polarizing plate 1 in that the angle formed by the first absorption axis A1 and the second absorption axis A2 is not orthogonal to each other and the first retardation layer R1 is provided.

The first retardation layer R1 is a retardation layer which satisfies the following expression E1, in a case where a retardation generated in the light having the first wavelength 21 by the second light absorption anisotropic layer POL2 is denoted by ReP2(λ1) and a retardation generated in the light having the first wavelength λ1 by the first retardation layer R1 is denoted by ReR1(λ1).

$$Re P 2 ( λ 1 ) / Re R 1 ( λ1 ) = 1 \pm 0.2 \qquad Expression E1$$

In the present specification, the term “retardation” simply means an in-plane retardation.

In the polarizing plate 2, the first retardation layer R1 is disposed in an aspect in which a first slow axis S1 which is a slow axis of the first retardation layer R1 is orthogonal to the second absorption axis A2.

The expression E1 means that the retardation ReP2(λ1) generated in the light having the first wavelength λ1, which has been transmitted through the second light absorption anisotropic layer POL2, and the retardation ReR1(λ1) generated in the light having the first wavelength λ1, which has been transmitted through the first retardation layer R1, are substantially the same. By arranging the first slow axis S1 of the first retardation layer R1 and the second absorption axis A2 of the second light absorption anisotropic layer POL2 in an aspect in which they are orthogonal to each other, the retardation imparted to the first wavelength λ1 by the second light absorption anisotropic layer POL2 is offset by the retardation imparted by the first retardation layer R1.

As shown in FIGS. 4 and 5, in a case where the non-polarized incidence ray L0 including the first wavelength λ1 and the second wavelength λ2 is incident into the polarizing plate 2, the light having the first wavelength λ1 is output as the first linearly polarized light L1 in which the polarization direction is orthogonal to the first absorption axis A1; and the light having the second wavelength λ2 is output as the second linearly polarized light L2 in which the polarization direction is orthogonal to the second absorption axis A2. The polarizing plate 2 is the same as the polarizing plate 1 in that the first linearly polarized light L1 and the second linearly polarized light L2 are output, but is different from the polarizing plate 1 in that the polarization direction of the second linearly polarized light L2 is not orthogonal to that of the first linearly polarized light L1. The first linearly polarized light L1 is linearly polarized light in a direction orthogonal to the first absorption axis A1, and the light having the second wavelength λ2 is linearly polarized light in a direction orthogonal to the second absorption axis A2. In the polarizing plate 2, for example, the angle formed by the first absorption axis A1 and the second absorption axis A2 is 45°. In this case, the angle formed by the polarization directions of the first linearly polarized light L1 and the second linearly polarized light L2 is 45°. The light included in the incidence ray L0, other than the light of the wavelengths absorbed by the first absorption property and the second absorption property of the polarizing plate 2, is transmitted through the polarizing plate 2 in a non-polarized state.

The action of the polarizing plate 2 will be described in more detail with reference to the table in FIG. 5, which is the same as the table in FIG. 2. The table in FIG. 5 shows polarization states of lights having the first wavelength λ1 and the second wavelength λ2, included in the incidence ray L0, before incidence and after transmission through each layer.

The incidence ray L0 is incident into the polarizing plate 2 from the first light absorption anisotropic layer POL1 side. The polarization states of the light having the first wavelength λ1 and the second wavelength λ2 included in the incidence ray L0 are unpolarized as shown in “BEFORE INCIDENCE” in the table of FIG. 5.

The action of the polarizing plate 2 of the present example on the incidence ray L0 shown in FIG. 5 will be described for each of the first wavelength λ1 and the second wavelength 22.

The polarizing plate 2 acts on light having the first wavelength λ1 in the incidence ray L0 as follows. In the first light absorption anisotropic layer POL1 on which the incidence ray L0 is first incident, a polarized light component along the first absorption axis A1 in the light having the first wavelength λ1, which is included in the incidence ray L0, is absorbed. As a result, as shown in “AFTER TRANSMISSION THROUGH POL1” in the table of FIG. 5, the light having the first wavelength λ1, which has been transmitted through the first light absorption anisotropic layer POL1, is linearly polarized light in a polarization direction (left-right direction in the table of FIG. 5) orthogonal to the first absorption axis A1.

The polarization direction of the first wavelength λ1 and the first slow axis S1 of the first retardation layer R1 are not parallel or orthogonal to each other. Therefore, the retardation ReR1(λ1) is imparted to the light having the first wavelength λ1, incident into the first retardation layer R1 as linearly polarized light, by the first retardation layer R1, and as shown in “AFTER TRANSMISSION THROUGH R1” in the table of FIG. 5, the light is elliptically polarized after passing through the first retardation layer R1. The light having the first wavelength λ1 is incident into the second light absorption anisotropic layer POL2 as elliptically polarized light. In the second light absorption anisotropic layer POL2, the light absorption anisotropy does not act on the light having the first wavelength λ1. On the other hand, the second light absorption anisotropic layer POL2 imparts the retardation ReP2(λ1) to the elliptically polarized light of the first wavelength λ1. As described above, the retardation ReP2(λ1) and the retardation ReR1(λ1) are the same (satisfy the expression E1), and the first slow axis S1 of the first retardation layer R1 and the second absorption axis A2 of the second light absorption anisotropic layer POL2 are arranged to be orthogonal to each other. Therefore, the retardation imparted to the light having the first wavelength λ1 by the first retardation layer R1 is offset by the second light absorption anisotropic layer POL2. As a result, as shown in “AFTER TRANSMISSION THROUGH POL2” in the table of FIG. 5, the light having the first wavelength λ1, which has been transmitted through the second light absorption anisotropic layer POL2, returns to linearly polarized light immediately after being transmitted through the first light absorption anisotropic layer POL1. The linearly polarized light is output from the polarizing plate 2 as the first linearly polarized light L1.

On the other hand, the polarizing plate 2 acts on light having the second wavelength λ2 in the incidence ray L0 as follows. In the first light absorption anisotropic layer POL1, the light absorption anisotropy does not act on the light having the second wavelength λ2. Therefore, as shown in “AFTER TRANSMISSION THROUGH POL1” in the table of FIG. 5, the light having the second wavelength λ2 is transmitted through the first light absorption anisotropic layer POL1 in a non-polarized state. Since the light having the second wavelength 22, incident into the first retardation layer R1, is non-polarized light, as shown in “AFTER TRANSMISSION THROUGH R1” in the table of FIG. 5, the first retardation layer R1 transmits the light having the second wavelength λ2 in the non-polarized state. Thereafter, in the second light absorption anisotropic layer POL2, a polarized light component along the second absorption axis A2 in the light having the second wavelength λ2 is absorbed. As a result, as shown in “AFTER TRANSMISSION THROUGH POL2” in the table of FIG. 5, the light having the second wavelength λ2, which has been transmitted through the second light absorption anisotropic layer POL2, is the second linearly polarized light L2 which is linearly polarized light orthogonal to the second absorption axis A2.

Due to the above-described actions, the polarizing plate 2 can convert the non-polarized incidence ray L0 into the first linearly polarized light L1 having the first wavelength λ1, and the second linearly polarized light L2 having the second wavelength λ2, which has a different polarization direction not orthogonal to and not parallel to the polarization direction of the first linearly polarized light L1.

In the polarizing plate 2 of the present example, the first absorption axis A1 and the second absorption axis A2 intersect with each other, but are not orthogonal to each other. Since the polarizing plate 2 includes the first retardation layer R1, the polarizing plate 2 can cause a retardation for offsetting a retardation generated in the light having the first wavelength 21, which has been transmitted through the second light absorption anisotropic layer POL2, with respect to the light having the first wavelength λ1, which has been transmitted through the first retardation layer R1. As in the polarizing plate 2, by adjusting an intersecting angle between the first slow axis S1 of the first retardation layer R1 and the second absorption axis A2 of the second light absorption anisotropic layer POL2, the first linearly polarized light L1 and the second linearly polarized light L2 having the polarization directions intersecting with each other at any angle other than orthogonality can be output, even in a case where the first absorption axis A1 and the second absorption axis A2 are not orthogonal to each other.

### Third Embodiment

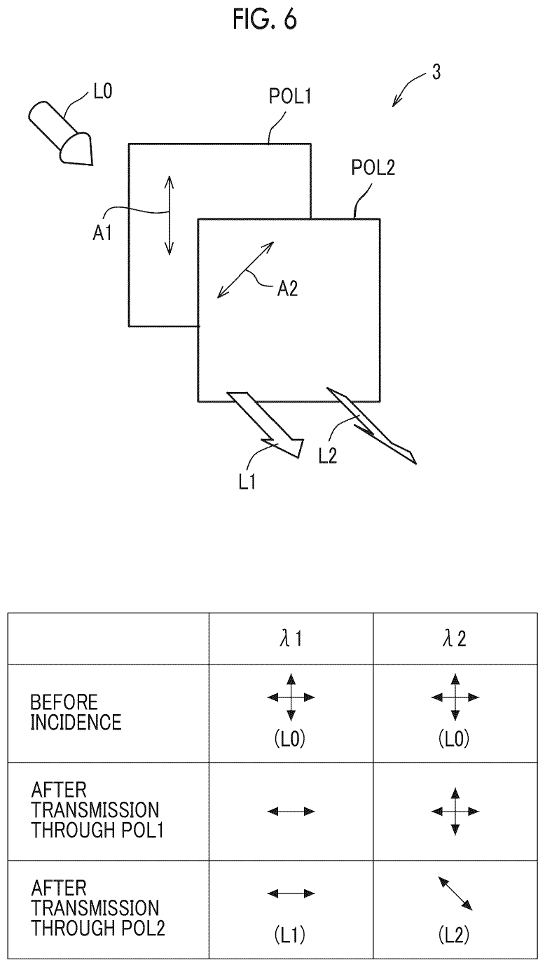

FIG. 6 shows a polarizing plate 3 according to a third embodiment. The polarizing plate 3 has a structure in which the first light absorption anisotropic layer POL1 and the second light absorption anisotropic layer POL2 are laminated, similarly to the polarizing plate 1 according to the first embodiment shown in FIG. 1. On the other hand, in the polarizing plate 3, as in the polarizing plate 2 according to the second embodiment, the first light absorption anisotropic layer POL1 and the second light absorption anisotropic layer POL2 are arranged in an aspect in which the first absorption axis A1 and the second absorption axis A2 are not orthogonal to each other. However, the polarizing plate 3 does not include the first retardation layer R1, different from the polarizing plate 2.

In the second light absorption anisotropic layer POL2, in a case where a retardation generated in the light having the first wavelength, which has been transmitted through the second light absorption anisotropic layer POL2, is denoted by ReP2(λ1), the following expression E2-1 or E2-2 is satisfied.

$$Re P 2 ( λ 1 ) / λ 1 = 1 \pm 0.2 \qquad Expression E 2 - 1$$

$$Re P 2 ( λ 1 ) / λ 1 = 0.5 \pm 0.1 \qquad Expression E 2 - 2$$

The expression E2-1 means that the retardation ReP2(λ1) generated in the light having the first wavelength, which has been transmitted through the second light absorption anisotropic layer POL2, is substantially the same as the first wavelength λ1. In a case where the retardation ReP2(λ1) of the second light absorption anisotropic layer POL2 is substantially the same as the first wavelength λ1, when the light having the first wavelength λ1 is incident into the second light absorption anisotropic layer POL2 as linearly polarized light, the light having the first wavelength λ1 is transmitted through the second light absorption anisotropic layer POL2 while maintaining the polarization direction during the incidence. The expression E2-2 means that the retardation ReP2(λ1) is substantially equivalent to ½ of the first wavelength 21. In a case where the retardation ReP2(λ1) is substantially equivalent to ½ of the first wavelength λ1, when the light having the first wavelength λ1 is incident into the second light absorption anisotropic layer POL2 as linearly polarized light, the light is transmitted through the second light absorption anisotropic layer POL2 to be linearly polarized light having a polarization direction rotated by 90°.

The action of the polarizing plate 3 will be described in more detail with reference to the table in FIG. 6. The table in FIG. 6 is the same as the tables in FIGS. 2 and 5 described above. An example in which the second light absorption anisotropic layer POL2 satisfies the expression E2-1 is shown.

The incidence ray L0 is incident into the polarizing plate 3 from the first light absorption anisotropic layer POL1 side. The polarization states of the light having the first wavelength 21 and the second wavelength λ2 included in the incidence ray L0 are unpolarized as shown in “BEFORE INCIDENCE” in the table of FIG. 6.

The action of the polarizing plate 3 on the incidence ray L0 shown in FIG. 6 will be described for each of the first wavelength λ1 and the second wavelength λ2.

The polarizing plate 3 acts on light having the first wavelength λ1 in the incidence ray L0 as follows. In the first light absorption anisotropic layer POL1 on which the incidence ray L0 is first incident, a polarized light component along the first absorption axis A1 in the light having the first wavelength λ1, which is included in the incidence ray L0, is absorbed. As a result, as shown in “AFTER TRANSMISSION THROUGH POL1” in the table of FIG. 6, the light having the first wavelength λ1, which has been transmitted through the first light absorption anisotropic layer POL1, is linearly polarized light having a polarization direction orthogonal to the first absorption axis A1. In the second light absorption anisotropic layer POL2, the light absorption anisotropy does not act on the light having the first wavelength λ1. On the other hand, since the polarization direction of the linearly polarized light of the first wavelength λ1 and the second absorption axis A2 are not parallel to or orthogonal to each other, the retardation ReP2(λ1) is imparted to the light having the first wavelength λ1. However, since the retardation ReP2(λ1) generated in the first wavelength λ1 transmitted through the second light absorption anisotropic layer POL2 is substantially the same as the first wavelength λ1 (the expression E2-1 is satisfied), the linearly polarized light of the first wavelength λ1 is transmitted through the second light absorption anisotropic layer POL2 while maintaining the polarization direction as shown in “AFTER TRANSMISSION THROUGH POL2” in the table of FIG. 6. The linearly polarized light is output from the polarizing plate 3 as the first linearly polarized light L1.

On the other hand, the polarizing plate 3 acts on light having the second wavelength λ2 in the incidence ray L0 as follows. In the first light absorption anisotropic layer POL1 on which the incidence ray is first incident, the light absorption anisotropy does not act on the light having the second wavelength λ2. Therefore, as shown in “AFTER TRANSMISSION THROUGH POL1” in the table of FIG. 6, the second wavelength λ2 is transmitted through the first light absorption anisotropic layer POL1 in a non-polarized state. In the second light absorption anisotropic layer POL2, a polarized light component along the second absorption axis A2 in the light having the second wavelength λ2 is absorbed. As a result, as shown in “AFTER TRANSMISSION THROUGH POL2” in the table of FIG. 6, the light having the second wavelength λ2, which has been transmitted through the second light absorption anisotropic layer POL2, is the second linearly polarized light L2 having a direction orthogonal to the second absorption axis A2.

Due to the above-described actions, the polarizing plate 3 can convert the non-polarized incidence ray L0 into light including the first linearly polarized light L1 having the first wavelength λ1, and the second linearly polarized light L2 having the second wavelength λ2, which has a polarization direction intersecting with the polarization direction of the first linearly polarized light L1 at an angle other than orthogonality.

In the polarizing plate 3 of the present example, the first absorption axis A1 and the second absorption axis A2 are not parallel to and not perpendicular to each other. The relationship between the retardation ReP2(λ1) generated in the light having the first wavelength 21, which has been transmitted through the second light absorption anisotropic layer POL2, and the first wavelength λ1 satisfies the expression E2-1. As a result, in a case where the first wavelength λ1 is incident as linearly polarized light, the second light absorption anisotropic layer POL2 can allow transmission of the first wavelength λ1 as linearly polarized light. In the above-described example, a case where the relationship between the retardation ReP2(λ1) and the first wavelength λ1 satisfies the expression E2-1 has been described, but the same effect can be obtained even in a case where the expression E2-2 is satisfied. However, in a case where the expression E2-2 is satisfied, the polarization direction of the linearly polarized light of the first wavelength λ1 in the second light absorption anisotropic layer POL2 is rotated by 90°.

In addition, in the polarizing plate 3, since the angle formed by the first absorption axis A1 and the second absorption axis A2 is adjusted, the angle between the polarization directions of the first wavelength λ1 and the second wavelength λ2 is not limited to 90° and can be set to any value. Since the polarizing plate 3 according to the third embodiment does not need to include the first retardation layer R1 different from the polarizing plate 2, a thickness of the polarizing plate 3 can be reduced.

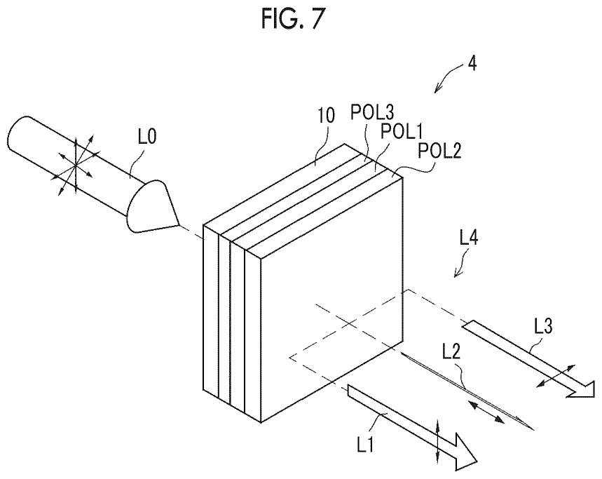

The polarizing plate 1 to the polarizing plate 3 described above have a configuration in which two light absorption anisotropic layers are provided. The polarizing plate according to the present disclosure may include three or more light absorption anisotropic layers. Hereinafter, embodiments of a case in which three light absorption anisotropic layers are provided will be described. In the following fourth to seventh embodiments, the polarizing plate 4 to the polarizing plate 7 further include a third light absorption anisotropic layer POL3 which contains a third dichroic coloring agent and has a third light absorption property in which an absorbance is maximal at a third wavelength λ3 different from the first wavelength λ1 and the second wavelength λ2 (see FIGS. 7, 8, 10, 12, and 13). The third light absorption anisotropic layer POL3 has a third absorption axis A3 exhibiting the first light absorption property in one direction. The third light absorption anisotropic layer POL3 is disposed in an aspect in which the third absorption axis A3 intersects with at least one of the first absorption axis A1 or the second absorption axis A2. In a case where non-polarized incidence ray including the first wavelength, the second wavelength, and the third wavelength is incident, the polarizing plate including the first to third light absorption anisotropic layers outputs emitted light including the first wavelength, the second wavelength, and the third wavelength as linearly polarized lights in different polarization directions.

### Fourth Embodiment

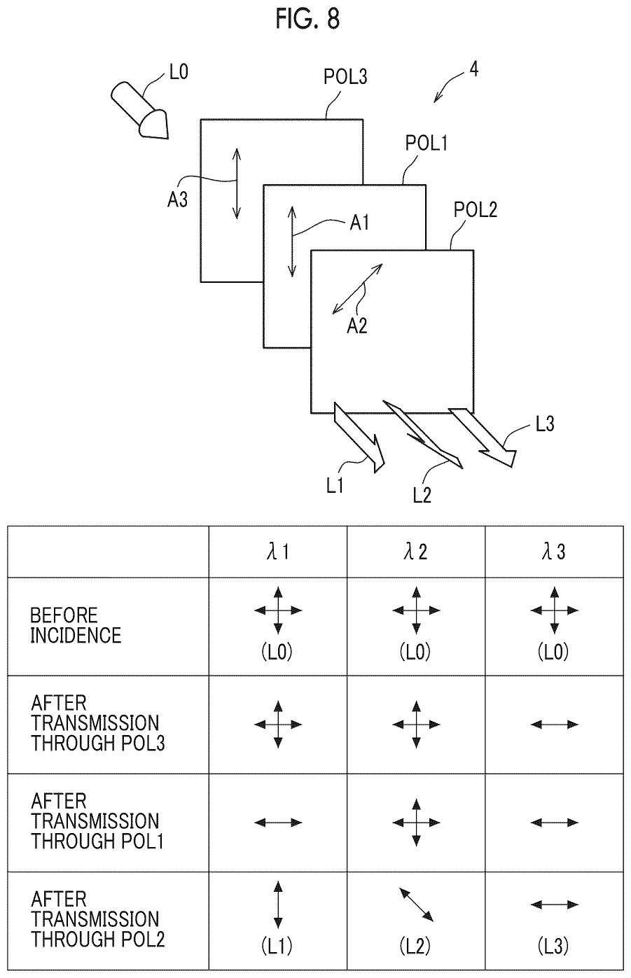

FIG. 7 is a perspective view showing an overall configuration of a polarizing plate 4 according to a fourth embodiment. FIG. 8 is a schematic view of the polarizing plate 4 showing the polarizing plate 4 decomposed for each layer, in which the support 10 is not shown.

The polarizing plate 4 according to the fourth embodiment further includes the third light absorption anisotropic layer POL3 containing a third dichroic coloring agent, in the polarizing plate 3 according to the third embodiment. The third light absorption anisotropic layer POL3 has the third light absorption property in which the absorbance is maximal at the third wavelength λ3 different from the first wavelength λ1 and the second wavelength λ2, and has the third absorption axis A3 exhibiting the first light absorption property along one direction. The polarizing plate 4 shown in FIG. 7 outputs a first linearly polarized light L1, a second linearly polarized light L2, and a third linearly polarized light L3 having different polarization directions, in a case where the non-polarized incidence ray L0 is incident.

As shown in FIG. 7, in the polarizing plate 4 of the present example, the third light absorption anisotropic layer POL3, the first light absorption anisotropic layer POL1, and the second light absorption anisotropic layer POL2 are laminated in this order from the light incident side. As shown in FIG. 8, the third light absorption anisotropic layer POL3 is disposed with respect to the first light absorption anisotropic layer POL1 in an aspect in which the first absorption axis A1 and the third absorption axis A3 are parallel to each other. In the polarizing plate 4, a relationship between the first light absorption anisotropic layer POL1 and the second light absorption anisotropic layer POL2 is the same as that in the case of the polarizing plate 3.

In the polarizing plate 4, in a case where a retardation generated in the light having the third wavelength λ3 transmitted through the second light absorption anisotropic layer POL2 is indicated by ReP2(λ3), two expressions of the above-described expression E2-1 and the following expression E3-1 are satisfied, or two expressions of the above-described expression E2-2 and the following expression E3-2 are satisfied.

$$Re P 2 ( λ 3 ) / λ 3 = 0.5 \pm 0.1 \qquad Expression E 3 - 1$$

$$Re P 2 ( λ 3 ) / λ 3 = 1 \pm 0.2 \qquad Expression E 3 - 2$$

The expression E3-1 means that the retardation ReP2(λ3) generated in the light having the third wavelength λ3, which has been transmitted through the second light absorption anisotropic layer POL2, is substantially the same as the third wavelength λ3. In a case where the retardation ReP2(λ3) generated in the third wavelength λ3 transmitted through the second light absorption anisotropic layer POL2 is substantially the same as the third wavelength λ3, when the light having the third wavelength λ3 is incident into the second light absorption anisotropic layer POL2 as linearly polarized light, the light having the third wavelength λ3 is transmitted through the second light absorption anisotropic layer POL2 while maintaining the polarization direction during the incidence.

The expression E3-2 means that the retardation ReP2(λ3) is substantially equivalent to ½ of the third wavelength λ3. In a case where the retardation ReP2(λ3) is substantially equivalent to ½ of the third wavelength λ3, when the light having the third wavelength λ3 is incident into the second light absorption anisotropic layer POL2 as linearly polarized light, the light is transmitted through the second light absorption anisotropic layer POL2 to be linearly polarized light having a polarization direction rotated by 90°.

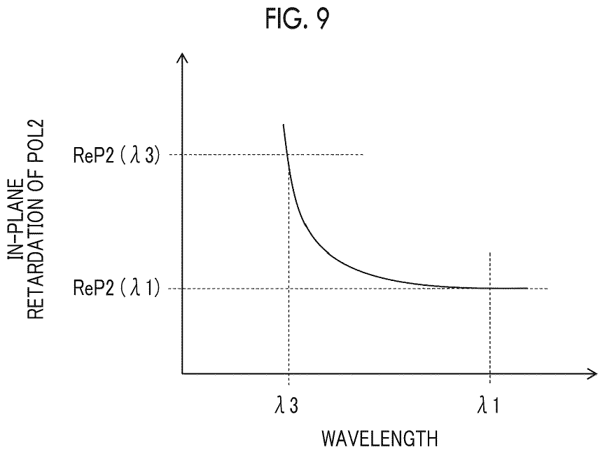

FIG. 9 shows an example of a wavelength dependence of the retardation of the second light absorption anisotropic layer POL2 in the polarizing plate 4. In the second light absorption anisotropic layer POL2 of the example shown in FIG. 9, the retardation ReP2(λ1) with respect to the first wavelength λ1 is the same as ½ of the first wavelength λ1, and the retardation ReP2(λ3) with respect to the third wavelength λ3 is the same as the third wavelength 23. That is, in the example shown in FIG. 9, the second light absorption anisotropic layer POL2 satisfies the expression E2-2 and the expression E3-2. Hereinafter, a case in which the second light absorption anisotropic layer POL2 of the polarizing plate 4 has the wavelength dependence of the retardation shown in FIG. 9 will be described, and the action of the polarizing plate 4 on the incidence ray L0 will be described.

As shown in FIG. 7, in a case where the non-polarized incidence ray L0 including the first wavelength λ1, the second wavelength λ2, and the third wavelength λ3 is incident into the polarizing plate 4 from the third light absorption anisotropic layer POL3 side, the first wavelength λ1 is output as the first linearly polarized light L1, the second wavelength λ2 is output as the second linearly polarized light L2 having a polarization direction different from that of the first linearly polarized light L1, and the third wavelength λ3 is output as the third linearly polarized light L3 having a polarization direction different from that of the first linearly polarized light L1 and the second linearly polarized light L2. That is, the polarizing plate 4 converts the non-polarized incidence ray L0 into light including the first linearly polarized light L1, the second linearly polarized light L2, and the third linearly polarized light L3.

The action of the polarizing plate 4 will be described in more detail with reference to the table in FIG. 8. The table in FIG. 8 shows polarization states of lights having the first wavelength λ1, the second wavelength λ2, and the third wavelength λ3, included in the incidence ray L0, before incidence and after transmission through each layer.

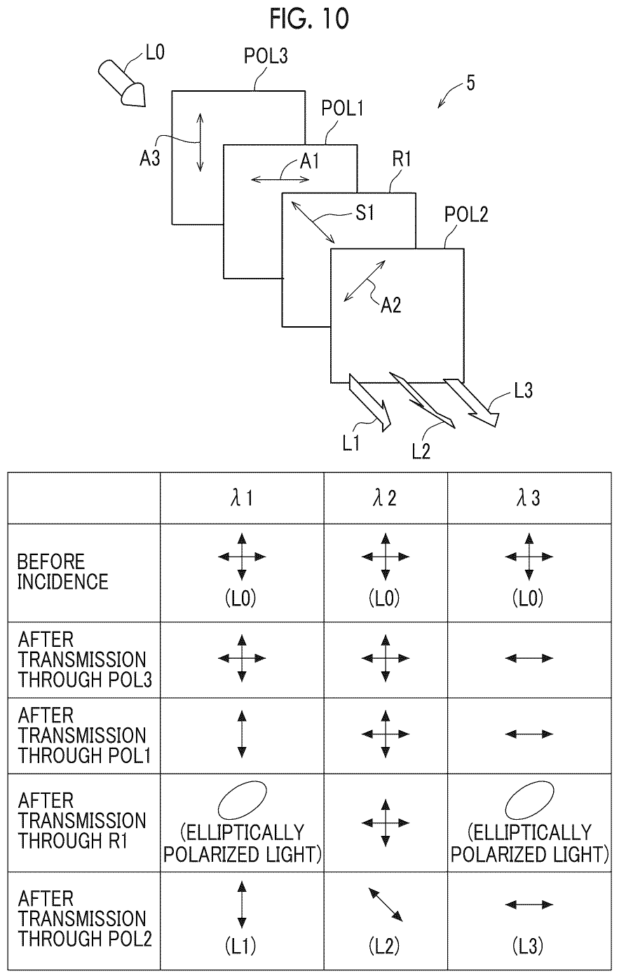

The incidence ray L0 is incident into the polarizing plate 4 from the third light absorption anisotropic layer POL3 side. The polarization states of the light having the first wavelength 21, the second wavelength λ2, and the third wavelength λ3 included in the incidence ray L0 are unpolarized as shown in “BEFORE INCIDENCE” in the table of FIG. 10.

The action of the polarizing plate 4 of the present example on the incidence ray L0 shown in FIG. 8 will be described for each of the first wavelength λ1, the second wavelength 22, and the third wavelength λ3.

The polarizing plate 4 acts on light having the first wavelength λ1 in the incidence ray L0 as follows. In the third light absorption anisotropic layer POL3 on which the incidence ray L0 is first incident, the light absorption anisotropy does not act on the light having the first wavelength λ1. Therefore, as shown in “AFTER TRANSMISSION THROUGH POL3” in the table of FIG. 8, the light having the first wavelength λ1 is transmitted through the third light absorption anisotropic layer POL3 in a non-polarized state. The light having the first wavelength λ1 is incident into the first light absorption anisotropic layer POL1 in the non-polarized state. In the first light absorption anisotropic layer POL1, a polarized light component along the first absorption axis A1 in the light having the first wavelength λ1 is absorbed. As a result, as shown in “AFTER TRANSMISSION THROUGH POL1” in the table of FIG. 8, the light having the first wavelength λ1, which has been transmitted through the first light absorption anisotropic layer POL1, is linearly polarized light having a direction orthogonal to the first absorption axis A1. The light having the first wavelength λ1 is incident into the second light absorption anisotropic layer POL2 as the linearly polarized light. In the second light absorption anisotropic layer POL2, the light absorption anisotropy does not act on the light having the first wavelength λ1. On the other hand, the second light absorption anisotropic layer POL2 imparts the retardation ReP2(λ1) to the linearly polarized light of the first wavelength λ1. Here, since the second light absorption anisotropic layer POL2 satisfies the expression E2-2 and the retardation ReP2(λ1) is substantially ½ of A1, the linearly polarized light of the first wavelength λ1 is rotated by 90° in the polarization direction by the second light absorption anisotropic layer POL2, and is output as the first linearly polarized light L1 having a polarization direction rotated by 90° from the polarization direction in a case of being incident into the second light absorption anisotropic layer POL2.

The polarizing plate 4 acts on light having the second wavelength λ2 in the incidence ray L0 as follows. In the third light absorption anisotropic layer POL3 on which the incidence ray L0 is first incident and in the first light absorption anisotropic layer POL1, the light absorption anisotropy does not act on the light having the second wavelength λ2. Therefore, as shown in “AFTER TRANSMISSION THROUGH POL3” and “AFTER TRANSMISSION THROUGH POL1” in the table of FIG. 8, the light having the second wavelength λ2 is transmitted through the third light absorption anisotropic layer POL3 and the first light absorption anisotropic layer POL1 in a non-polarized state. Thereafter, in the second light absorption anisotropic layer POL2, a polarized light component along the second absorption axis A2 in the light having the second wavelength λ2, which has been incident in the non-polarized state, is absorbed. As a result, as shown in “AFTER TRANSMISSION THROUGH POL2” in the table of FIG. 8, the light having the second wavelength λ2, which has been transmitted through the second light absorption anisotropic layer POL2, is the second linearly polarized light L2 having a direction orthogonal to the second absorption axis A2.

The polarizing plate 4 acts on light having the third wavelength λ3 in the incidence ray L0 as follows. In the third light absorption anisotropic layer POL3 on which the incidence ray L0 is first incident, a polarized light component along the third absorption axis A3 in the light having the third wavelength λ3 is absorbed. As a result, as shown in “AFTER TRANSMISSION THROUGH POL3” in the table of FIG. 8, the light having the third wavelength λ3, which has been transmitted through the third light absorption anisotropic layer POL3, is linearly polarized light having a direction orthogonal to the third absorption axis A3. The light having the third wavelength λ3 is incident into the first light absorption anisotropic layer POL1 as the linearly polarized light. In the first light absorption anisotropic layer POL1, the light absorption anisotropy does not act on the light having the third wavelength λ3. In addition, since the first absorption axis A1 is orthogonal to the polarization direction of the linearly polarized light of the third wavelength λ3, the first light absorption anisotropic layer POL1 does not impart a retardation in the linearly polarized light of the third wavelength λ3. Therefore, as shown in “AFTER TRANSMISSION THROUGH POL1” in the table of FIG. 8, the linearly polarized light of the third wavelength λ3 is transmitted through the first light absorption anisotropic layer POL1 in a state in which the polarization direction does not change. The light having the third wavelength λ3 is incident into the second light absorption anisotropic layer POL2 as the linearly polarized light. In the second light absorption anisotropic layer POL2, the light absorption anisotropy does not act on the light having the third wavelength λ3. On the other hand, the second light absorption anisotropic layer POL2 imparts the retardation ReP2(λ3) to the light having the third wavelength λ3. However, since the retardation ReP2(λ3) generated in the light having the third wavelength λ3, which has been transmitted through the second light absorption anisotropic layer POL2, is substantially the same as the third wavelength λ3 (the expression E3-2 is satisfied), the polarization during the incidence is maintained. Therefore, as shown in “AFTER TRANSMISSION THROUGH POL2” in the table of FIG. 8, the light having the third wavelength λ3 is transmitted through the second light absorption anisotropic layer POL2 and output as the third linearly polarized light L3 in a polarization direction in a case where the light is incident into the second light absorption anisotropic layer POL2 as linearly polarized light.

Due to the above-described actions, the polarizing plate 4 can convert the non-polarized incidence ray L0 into light including the first linearly polarized light L1 having the first wavelength λ1, the second linearly polarized light L2 having the second wavelength λ2 in a polarization direction different from that of the first linearly polarized light L1, and the third linearly polarized light L3 having the third wavelength λ3 in a polarization direction different from that of the first linearly polarized light L1 and the second linearly polarized light L2.

In the polarizing plate 4 of the present example, the third absorption axis A3 and the first absorption axis A1 are parallel to each other. On the other hand, the two absorption axes A1 and A3 and the second absorption axis A2 are not parallel to and are not orthogonal to each other. In the polarizing plate 4, the relationship between the retardation ReP2(λ1) generated in the light having the first wavelength λ1, which has been transmitted through the second light absorption anisotropic layer POL2, and the first wavelength λ1 satisfies the above-described expression E2-2. As a result, in a case where the first wavelength λ1 is incident as linearly polarized light, the second light absorption anisotropic layer POL2 rotates the polarization direction of the linearly polarized light of the first wavelength λ1 by 90°, and outputs the linearly polarized light. The relationship between the retardation ReP2(λ3) generated in the light having the third wavelength λ3, which has been transmitted through the second light absorption anisotropic layer POL2, and the third wavelength λ3 satisfies the expression E3-2. As a result, in a case where the third wavelength λ3 is incident as linearly polarized light, the second light absorption anisotropic layer POL2 can allow transmission of the third wavelength λ3 as linearly polarized light. That is, the second light absorption anisotropic layer POL2 can output linearly polarized light of the first wavelength λ1 and linearly polarized light of the third wavelength 23, which are incident as linearly polarized light in the same polarization direction, as linearly polarized lights in polarization directions orthogonal to each other.

In the above-described example, a case where the relationship between the retardation ReP2(λ1) and the first wavelength λ1 satisfies the expression E2-2 and the relationship between the retardation ReP2(λ3) and the third wavelength λ3 satisfies the expression E3-2 has been described, but the same effect can be obtained even in a case where the expression E2-1 and the expression E3-1 are satisfied. However, in a case where the expression E2-1 and the expression E3-1 are satisfied, in the second light absorption anisotropic layer POL2, the polarization direction of the linearly polarized light of the first wavelength λ1 does not change, and the polarization direction of the linearly polarized light of the third wavelength λ3 rotates by 90°.

Since the polarizing plate 4 does not need to include the above-described first retardation layer R1 or a second retardation layer R2 described later, a thickness of the polarizing plate 4 can be reduced.

### Fifth Embodiment

FIG. 10 is a schematic view of a polarizing plate 5 according to a fifth embodiment, showing the polarizing plate 5 decomposed for each layer. In practice, the polarizing plate 5 is integrated by laminating the respective layers on the support 10, as in the polarizing plates 1 to 4.

The polarizing plate 5 according to the fifth embodiment includes the first light absorption anisotropic layer POL1, the first retardation layer R1, and the second light absorption anisotropic layer POL2 in this order, same as the polarizing plate 2 according to the second embodiment. The polarizing plate 5 further includes a third light absorption anisotropic layer POL3 containing a third dichroic coloring agent. The third light absorption anisotropic layer POL3 has the third light absorption property in which the absorbance is maximal at the third wavelength λ3 different from the first wavelength λ1 and the second wavelength λ2, and has the third absorption axis A3 exhibiting the first light absorption property along one direction. Similarly to the polarizing plate 4, the polarizing plate 5 shown in FIG. 10 outputs a first linearly polarized light L1, a second linearly polarized light L2, and a third linearly polarized light L3 having polarization directions different from each other, in a case where the non-polarized incidence ray L0 is incident.

As shown in FIG. 10, in the polarizing plate 5 of the present example, the third light absorption anisotropic layer POL3, the first light absorption anisotropic layer POL1, the first retardation layer R1, and the second light absorption anisotropic layer POL2 are laminated in this order from the light incident side. As shown in FIG. 10, the first light absorption anisotropic layer POL1, the second light absorption anisotropic layer POL2, and the third light absorption anisotropic layer POL3 are arranged in an aspect in which the first absorption axis A1, the second absorption axis A2, and the third absorption axis A3 are not parallel to each other. The third light absorption anisotropic layer POL3 is disposed with respect to the first light absorption anisotropic layer POL1 in an aspect in which the first absorption axis A1 and the third absorption axis A3 are orthogonal to each other.

In the polarizing plate 5, a relationship between the first retardation layer R1 and the second light absorption anisotropic layer POL2 is the same as that in the case of the polarizing plate 3. That is, in the polarizing plate 5, the first slow axis S1 and the second absorption axis A2 are orthogonal to each other, and the above-described expression E1 is satisfied. Therefore, the retardation imparted to the first wavelength λ1 by the second light absorption anisotropic layer POL2 is offset by the retardation due to the first retardation layer R1.

Furthermore, in the polarizing plate 5, in a case where a retardation generated in the light having the third wavelength λ3, which has been transmitted through the second light absorption anisotropic layer POL2, is denoted by ReP2(λ3) and a retardation generated in the light having the third wavelength λ3, which has been transmitted through the first retardation layer R1, is denoted by ReR1(λ3), the following expression E4 is satisfied.

$$Re P 2 ( λ 3 ) / Re R 1 ( λ3 ) = 1 \pm 0.2 \qquad Expression E 4$$

The expression E4 means that the retardation ReP2(λ3) generated in the light having the third wavelength λ3, which has been transmitted through the second light absorption anisotropic layer POL2, and the retardation ReR1(λ3) generated in the light having the third wavelength 23, which has been transmitted through the first retardation layer R1, are substantially the same. By arranging the first slow axis S1 of the first retardation layer R1 and the second absorption axis A2 of the second light absorption anisotropic layer POL2 in an aspect in which they are orthogonal to each other, the retardation imparted to the light having the third wavelength λ3 by the second light absorption anisotropic layer POL2 is offset by the first retardation layer R1.

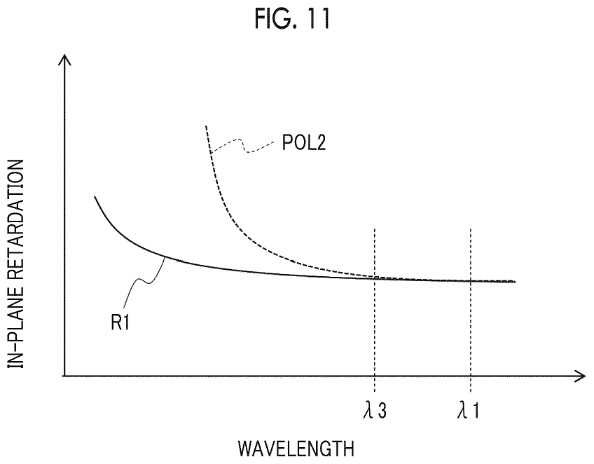

FIG. 11 shows an example of a wavelength dependence of the retardation of the second light absorption anisotropic layer POL2 and a wavelength dependence of the retardation of the first retardation layer R1 in the polarizing plate 5. As shown in FIG. 11, in the polarizing plate 5, the retardation ReP2(λ1) of the second light absorption anisotropic layer POL2 with respect to the first wavelength λ1 and the retardation ReR1(λ1) of the first retardation layer R1 with respect to the first wavelength λ1 are substantially the same; and the retardation ReP2(λ3) of the second light absorption anisotropic layer POL2 with respect to the third wavelength λ3 and the retardation ReR1(λ3) of the first retardation layer R1 with respect to the third wavelength 23 are substantially the same.

In a case where the non-polarized incidence ray L0 including the first wavelength λ1, the second wavelength λ2, and the third wavelength λ3 is incident into the polarizing plate 5 from the third light absorption anisotropic layer POL3 side, light having the first wavelength λ1 is output as the first linearly polarized light L1, light having the second wavelength λ2 is output as the second linearly polarized light L2 having a direction different from that of the first linearly polarized light L1, and light having the third wavelength λ3 is output as the third linearly polarized light L3 having a direction different from that of the first linearly polarized light L1 and the second linearly polarized light L2. That is, the polarizing plate 5 on which the incidence ray L0 is incident converts the incidence ray L0 into light including the first linearly polarized light L1, the second linearly polarized light L2, and the third linearly polarized light L3.

The action of the polarizing plate 5 will be described in more detail with reference to the table in FIG. 10. The table in FIG. 10 shows polarization states of lights having the first wavelength λ1, the second wavelength λ2, and the third wavelength λ3, included in the incidence ray L0, before incidence and after transmission through each layer.

The incidence ray L0 is incident into the polarizing plate 5 from the third light absorption anisotropic layer POL3 side. The polarization states of the light having the first wavelength 21, the second wavelength λ2, and the third wavelength λ3 included in the incidence ray L0 are unpolarized as shown in “BEFORE INCIDENCE” in the table of FIG. 10.

The action of the polarizing plate 5 of the present example on the incidence ray L0 shown in FIG. 10 will be described for each of the first wavelength λ1, the second wavelength 22, and the third wavelength λ3.

The polarizing plate 5 acts on light having the first wavelength λ1 in the incidence ray L0 as follows. In the third light absorption anisotropic layer POL3 on which the incidence ray L0 is first incident, the light absorption anisotropy does not act on the light having the first wavelength λ1. Therefore, as shown in “AFTER TRANSMISSION THROUGH POL3” in the table of FIG. 10, the light having the first wavelength λ1 is transmitted through the third light absorption anisotropic layer POL3 in a non-polarized state. The light having the first wavelength λ1 is incident into the first light absorption anisotropic layer POL1 in the non-polarized state. In the first light absorption anisotropic layer POL1, a polarized light component along the first absorption axis A1 in the light having the first wavelength λ1 is absorbed. As a result, as shown in “AFTER TRANSMISSION THROUGH POL1” in the table of FIG. 10, the light having the first wavelength λ1, which has been transmitted through the first light absorption anisotropic layer POL1, is linearly polarized light having a direction orthogonal to the first absorption axis A1. The light having the first wavelength λ1 is incident into the first retardation layer R1 as the linearly polarized light. The polarization direction of the linearly polarized light of the first wavelength λ1 and the first slow axis S1 of the first retardation layer R1 are not parallel or orthogonal to each other. Therefore, the first retardation layer R1 imparts the retardation ReR1(λ1) to the linearly polarized light of the first wavelength λ1 incident into the first retardation layer R1. Therefore, as shown in “AFTER TRANSMISSION THROUGH R1” in the table of FIG. 10, the linearly polarized light of the first wavelength λ1 is elliptically polarized light after passing through the first retardation layer R1. The light having the first wavelength λ1 is incident into the second light absorption anisotropic layer POL2 as elliptically polarized light. In the second light absorption anisotropic layer POL2, the second light absorption anisotropy does not act on the light having the first wavelength λ1. On the other hand, the second light absorption anisotropic layer POL2 imparts the retardation ReP2(λ1) to the elliptically polarized light of the first wavelength λ1. As described above, the retardation ReP2(λ1) and the retardation ReR1(λ1) are the same (satisfy the expression E1), and the first slow axis S1 of the first retardation layer R1 and the second absorption axis A2 of the second light absorption anisotropic layer POL2 are arranged to be orthogonal to each other. Therefore, the retardation imparted to the light having the first wavelength λ1 by the first retardation layer R1 is offset by the second light absorption anisotropic layer POL2. As a result, as shown in “AFTER TRANSMISSION THROUGH POL2” in the table of FIG. 10, the light having the first wavelength λ1, which has been transmitted through the second light absorption anisotropic layer POL2, returns to linearly polarized light immediately after being transmitted through the first light absorption anisotropic layer POL1. The linearly polarized light is output from the polarizing plate 5 as the first linearly polarized light L1.

The polarizing plate 5 acts on light having the second wavelength λ2 in the incidence ray L0 as follows. In the third light absorption anisotropic layer POL3 on which the incidence ray L0 is first incident and in the first light absorption anisotropic layer POL1, the light absorption anisotropy does not act on the light having the second wavelength λ2. Therefore, as shown in “AFTER TRANSMISSION THROUGH POL3” and “AFTER TRANSMISSION THROUGH POL1” in the table of FIG. 10, the light having the second wavelength λ2 is transmitted through the third light absorption anisotropic layer POL3 and the first light absorption anisotropic layer POL1 in a non-polarized state. Thereafter, since the light having the second wavelength λ2, incident into the first retardation layer R1, is non-polarized light, as shown in “AFTER TRANSMISSION THROUGH R1” in the table of FIG. 10, the first retardation layer R1 transmits the light having the second wavelength λ2 in the non-polarized state. The light having the second wavelength λ2 is incident into the second light absorption anisotropic layer POL2 in the non-polarized state. Thereafter, in the second light absorption anisotropic layer POL2, a polarized light component along the second absorption axis A2 in the light having the second wavelength λ2 is absorbed. As a result, as shown in “AFTER TRANSMISSION THROUGH POL2” in the table of FIG. 10, the light having the second wavelength λ2, which has been transmitted through the second light absorption anisotropic layer POL2, is the second linearly polarized light L2 having a direction orthogonal to the second absorption axis A2.

The polarizing plate 5 acts on light having the third wavelength λ3 in the incidence ray L0 as follows. In the third light absorption anisotropic layer POL3 on which the incidence ray L0 is first incident, a polarized light component along the third absorption axis A3 in the light having the third wavelength λ3 is absorbed. As a result, as shown in “AFTER TRANSMISSION THROUGH POL3” in the table of FIG. 10, the light having the third wavelength λ3, which has been transmitted through the third light absorption anisotropic layer POL3, is linearly polarized light having a direction orthogonal to the third absorption axis A3. Therefore, the light having the third wavelength λ3 is incident into the first light absorption anisotropic layer POL1 as the linearly polarized light. In the first light absorption anisotropic layer POL1, the first light absorption anisotropy does not act on the light having the third wavelength λ3. In addition, since the first absorption axis A1 is parallel to the polarization direction of the light having the third wavelength λ3, the first light absorption anisotropic layer POL1 does not affect the polarization state of the linearly polarized light of the third wavelength 23. Therefore, the light having the third wavelength λ3 is transmitted through the first light absorption anisotropic layer POL1 in a state of being linearly polarized without changing the polarization direction. The light having the third wavelength λ3 is incident into the first retardation layer R1 as the linearly polarized light. Since the polarization direction of the third wavelength λ3 and the first slow axis S1 of the first retardation layer R1 are not parallel or orthogonal to each other, the linearly polarized light of the third wavelength λ3 incident into the first retardation layer R1 is imparted to the retardation ReR1(λ3) by the first retardation layer R1. Therefore, the linearly polarized light of the third wavelength λ3 is elliptically polarized light after passing through the first retardation layer R1. The third wavelength λ3 is incident into the second light absorption anisotropic layer POL2 as elliptically polarized light. In the second light absorption anisotropic layer POL2, the second light absorption anisotropy does not act on the light having the third wavelength λ3. On the other hand, the second light absorption anisotropic layer POL2 imparts the retardation ReP2(λ3) to the elliptically polarized light of the third wavelength λ3. As described above, the retardation ReP2(λ3) and the retardation ReR1(λ3) are the same (satisfy the expression E4), and the first slow axis S1 of the first retardation layer R1 and the second absorption axis A2 of the second light absorption anisotropic layer POL2 are arranged to be orthogonal to each other. Therefore, the retardation imparted to the light having the third wavelength λ3 by the first retardation layer R1 is offset by the second light absorption anisotropic layer POL2. As a result, as shown in “AFTER TRANSMISSION THROUGH R1” in the table of FIG. 10, the light having the third wavelength 23, which has been transmitted through the second light absorption anisotropic layer POL2, returns to linearly polarized light immediately after being transmitted through the first light absorption anisotropic layer POL1. The linearly polarized light is output from the polarizing plate 5 as the third linearly polarized light L3.

Due to the above-described actions, the polarizing plate 5 can convert the non-polarized incidence ray L0 into light including the first linearly polarized light L1 having the first wavelength λ1, the second linearly polarized light L2 having the second wavelength λ2, and the third linearly polarized light L3 having the third wavelength λ3.

Since the respective layers of the polarizing plate 5 of the present example are laminated and integrated, handling is easy. In addition, according to the present polarizing plate 5, due to the above-described actions, light having different wavelengths 21, 22, and 23 in the non-polarized incidence ray L0 can be converted into linearly polarized lights in different directions.

### Sixth Embodiment

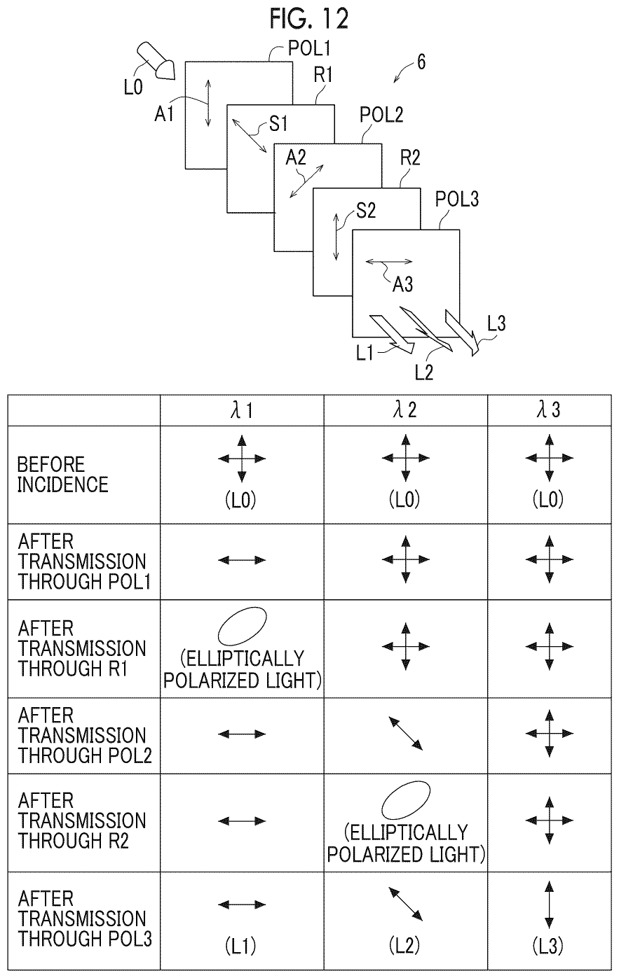

FIG. 12 is a schematic view of a polarizing plate 6 according to a sixth embodiment, showing the polarizing plate 6 decomposed for each layer. In practice, the polarizing plate 6 is integrated by laminating the respective layers on the support 10, as in the polarizing plates 1 to 4.

The polarizing plate 6 according to the sixth embodiment includes the first light absorption anisotropic layer POL1, the first retardation layer R1, and the second light absorption anisotropic layer POL2 in this order, same as the polarizing plate 2 according to the second embodiment. The polarizing plate 6 further includes a third light absorption anisotropic layer POL3 containing a third dichroic coloring agent. The third light absorption anisotropic layer POL3 has the third light absorption property in which the absorbance is maximal at the third wavelength λ3 different from the first wavelength λ1 and the second wavelength λ2, and has the third absorption axis A3 exhibiting the third light absorption property along one direction. The third light absorption anisotropic layer POL3 is disposed in an aspect in which the third absorption axis A3 intersects with the first absorption axis A1 and the second absorption axis A2. That is, the first absorption axis A1, the second absorption axis A2, and the third absorption axis A3 intersect with each other. In particular, in the third light absorption anisotropic layer POL3 of the present example, the third absorption axis A3 is disposed in an aspect of being orthogonal to the first absorption axis A1.

The polarizing plate 6 further includes a second retardation layer R2 which provides a retardation in transmitted light between the second light absorption anisotropic layer POL2 and the third light absorption anisotropic layer POL3. That is, as shown in FIG. 12, in the polarizing plate 6, the first light absorption anisotropic layer POL1, the first retardation layer R1, the second light absorption anisotropic layer POL2, the second retardation layer R2, and the third light absorption anisotropic layer POL3 are laminated in this order from the light incident side. Similarly to the polarizing plates 4 and 5, the polarizing plate 6 shown in FIG. 12 outputs a first linearly polarized light L1, a second linearly polarized light L2, and a third linearly polarized light L3 having polarization directions different from each other, in a case where the non-polarized incidence ray L0 is incident.

In the polarizing plate 6, a relationship between the first retardation layer R1 and the second light absorption anisotropic layer POL2 is the same as that in the case of the polarizing plate 2. That is, in the polarizing plate 6, the first slow axis S1 and the second absorption axis A2 are orthogonal to each other, and the above-described expression E1 is satisfied. Therefore, the retardation imparted to the first wavelength λ1 by the second light absorption anisotropic layer POL2 is offset by the retardation due to the first retardation layer R1.

In a case where a retardation generated in the light having the second wavelength λ2, which has been transmitted through the third light absorption anisotropic layer POL3, is denoted by ReP3(λ2) and a retardation generated in the light having the second wavelength λ2, which has been transmitted through the second retardation layer R2, is denoted by ReR2(λ2), the second retardation layer R2 satisfies the following expression E5.

$$Re P 3 ( λ 2 ) / Re R 2 ( λ 2 ) = 1 \pm 0.2 \qquad Expression E5$$

The second retardation layer R2 is disposed in an aspect in which a second slow axis S2 which is a slow axis thereof is orthogonal to the third absorption axis A3.

The expression E5 means that the retardation ReP3(λ2) generated in the light having the second wavelength λ2, which has been transmitted through the third light absorption anisotropic layer POL3, and the retardation ReR2(λ2) generated in the light having the second wavelength 22, which has been transmitted through the second retardation layer R2, are substantially the same. By arranging the second slow axis S2 of the second retardation layer R2 and the third absorption axis A3 of the third light absorption anisotropic layer POL3 in an aspect in which they are orthogonal to each other, the retardation imparted to the second wavelength λ2 by the third light absorption anisotropic layer POL3 is offset by the retardation imparted by the second retardation layer R2.

The action of the polarizing plate 6 will be described in more detail with reference to the table in FIG. 12. The table in FIG. 12 shows polarization states of lights having the first wavelength λ1, the second wavelength λ2, and the third wavelength λ3, included in the incidence ray L0, before incidence and after transmission through each layer.

The incidence ray L0 is incident into the polarizing plate 5 from the third light absorption anisotropic layer POL3 side. The polarization states of the light having the first wavelength 21, the second wavelength λ2, and the third wavelength λ3 included in the incidence ray L0 are unpolarized as shown in “BEFORE INCIDENCE” in the table of FIG. 10.

The action of the polarizing plate 6 of the present example on the incidence ray L0 shown in FIG. 12 will be described for each of the first wavelength λ1, the second wavelength 22, and the third wavelength λ3.

The polarizing plate 6 acts on light having the first wavelength λ1 in the incidence ray L0 as follows. In the first light absorption anisotropic layer POL1 on which the incidence ray L0 is first incident, a polarized light component along the first absorption axis A1 in the light having the first wavelength λ1 is absorbed. As a result, as shown in “AFTER TRANSMISSION THROUGH POL1” in the table of FIG. 12, the light having the first wavelength λ1, which has been transmitted through the first light absorption anisotropic layer POL1, is linearly polarized light having a polarization direction orthogonal to the first absorption axis A1.

The polarization direction of the first wavelength λ1 and the first slow axis S1 of the first retardation layer R1 are not parallel or orthogonal to each other. Therefore, the first retardation layer R1 imparts the retardation ReR1(λ1) to the light having the first wavelength λ1 incident into the first retardation layer R1 as linearly polarized light. Therefore, as shown in “AFTER TRANSMISSION THROUGH R1” in the table of FIG. 12, the light having the first wavelength λ1 is elliptically polarized light after passing through the first retardation layer R1. The light having the first wavelength λ1 is incident into the second light absorption anisotropic layer POL2 as elliptically polarized light. In the second light absorption anisotropic layer POL2, the light absorption anisotropy does not act on the light having the first wavelength λ1. On the other hand, the second light absorption anisotropic layer POL2 imparts the retardation ReP2(λ1) to the linearly polarized light of the first wavelength λ1. As described above, the retardation ReP2(λ1) and the retardation ReR1(λ1) are the same (satisfy the expression E1), and the first slow axis S1 of the first retardation layer R1 and the second absorption axis A2 of the second light absorption anisotropic layer POL2 are arranged to be orthogonal to each other.

Therefore, the retardation imparted to the light having the first wavelength λ1 by the first retardation layer R1 is offset by the second light absorption anisotropic layer POL2. As a result, as shown in “AFTER TRANSMISSION THROUGH POL2” in the table of FIG. 12, the light having the first wavelength λ1, which has been transmitted through the second light absorption anisotropic layer POL2, returns to linearly polarized light immediately after being transmitted through the first light absorption anisotropic layer POL1.

Since the second slow axis S2 of the second retardation layer R2 is orthogonal to the polarization direction of the linearly polarized light of the first wavelength λ1, the second retardation layer R2 does not act on the first wavelength λ1. Therefore, the light having the first wavelength λ1 is transmitted through the second retardation layer R2 while maintaining the polarization direction in a case where the light is incident into the second retardation layer R2. In addition, in the third light absorption anisotropic layer POL3, the light absorption anisotropy does not act on the first wavelength λ1. In addition, since the third absorption axis A3 is parallel to the polarization direction of the linearly polarized light of the first wavelength 21, the third light absorption anisotropic layer POL3 does not affect the polarization state of the linearly polarized light of the first wavelength λ1. Therefore, the linearly polarized light of the first wavelength λ1 is transmitted through the third light absorption anisotropic layer POL3 while maintaining the polarization direction in a case of being incident into the third light absorption anisotropic layer POL3. The linearly polarized light is output from the polarizing plate 6 as the first linearly polarized light L1.

The polarizing plate 6 acts on light having the second wavelength λ2 in the incidence ray L0 as follows. In the first light absorption anisotropic layer POL1 on which the incidence ray L0 is first incident, the light absorption anisotropy does not act on the light having the second wavelength λ2. Therefore, as shown in “AFTER TRANSMISSION THROUGH POL1” in the table of FIG. 12, the second wavelength λ2 is transmitted through the first light absorption anisotropic layer POL1 in a non-polarized state. Since the first retardation layer R1 does not impart a substantial retardation in non-polarized light, as shown in “AFTER TRANSMISSION THROUGH R1” in the table of FIG. 12, the light having the second wavelength λ2 incident in the non-polarized state is transmitted through the first retardation layer R1 as the non-polarized light. The light having the second wavelength λ2 is incident into the second light absorption anisotropic layer POL2 in the non-polarized state. In the second light absorption anisotropic layer POL2, a polarized light component along the second absorption axis A2 in the light having the second wavelength λ2 is absorbed. As a result, as shown in “AFTER TRANSMISSION THROUGH POL2” in the table of FIG. 12, the light having the second wavelength λ2, which has been transmitted through the second light absorption anisotropic layer POL2, is linearly polarized light having a direction orthogonal to the second absorption axis A2.

The polarization direction of the linearly polarized light of the second wavelength λ2 and the second slow axis S2 of the second retardation layer R2 are not parallel or orthogonal to each other. Therefore, the retardation ReR2(λ2) is imparted to the linearly polarized light of the second wavelength λ2, incident into the second retardation layer R2, by the second retardation layer R2, and as shown in “AFTER TRANSMISSION THROUGH R2” in the table of FIG. 12, the light is elliptically polarized after passing through the second retardation layer R2. In the third light absorption anisotropic layer POL3, the light absorption anisotropy does not act on the light having the second wavelength λ2. On the other hand, the third light absorption anisotropic layer POL3 imparts the retardation ReP3(λ2) to the light having the second wavelength λ2. As described above, the retardation ReP3(λ2) and the retardation ReR2(λ2) are the same (satisfy the expression E5), and the second slow axis S2 of the second retardation layer R2 and the third absorption axis A3 of the third light absorption anisotropic layer POL3 are arranged to be orthogonal to each other. Therefore, the retardation imparted to the light having the second wavelength λ2 by the second retardation layer R2 is offset by the third light absorption anisotropic layer POL3, and the light having the second wavelength λ2, which has been transmitted through the third light absorption anisotropic layer POL3, returns to linearly polarized light immediately after being transmitted through the second light absorption anisotropic layer POL2. The linearly polarized light is output from the polarizing plate 6 as the second linearly polarized light L2.

The polarizing plate 6 acts on light having the third wavelength λ3 in the incidence ray L0 as follows. In the first light absorption anisotropic layer POL1 on which the incidence ray L0 is first incident, the light absorption anisotropy does not act on the light having the third wavelength λ3. Therefore, as shown in “AFTER TRANSMISSION THROUGH POL1” in the table of FIG. 12, the third wavelength λ3 is transmitted through the first light absorption anisotropic layer POL1 in a non-polarized state. Since the first retardation layer R1 does not impart a substantial retardation in non-polarized light, as shown in “AFTER TRANSMISSION THROUGH R1” in the table of FIG. 12, the light having the third wavelength λ3 incident in the non-polarized state is transmitted through the first retardation layer R1 as the non-polarized light. Furthermore, in the second light absorption anisotropic layer POL2, the light absorption anisotropy does not act on the light having the third wavelength λ3. Therefore, as shown in “AFTER TRANSMISSION THROUGH POL2” in the table of FIG. 12, the light having the third wavelength λ3 incident in the non-polarized state is transmitted through the second light absorption anisotropic layer POL2 as the non-polarized light. In addition, since the second retardation layer R2 does not impart a substantial retardation in non-polarized light, as shown in “AFTER TRANSMISSION THROUGH R2” in the table of FIG. 12, the light having the third wavelength λ3 incident in the non-polarized state is transmitted through the second retardation layer R2 as the non-polarized light. The light having the third wavelength λ3 is incident into the third light absorption anisotropic layer POL3 in the non-polarized state. In the third light absorption anisotropic layer POL3, a polarized light component along the third absorption axis A3 in the light having the third wavelength λ3 is absorbed. As a result, as shown in “AFTER TRANSMISSION THROUGH POL3” in the table of FIG. 12, the light having the third wavelength λ3, which has been transmitted through the third light absorption anisotropic layer POL3, is the third linearly polarized light L3 having a direction orthogonal to the third absorption axis A3.

Due to the above-described actions, the polarizing plate 6 can convert the non-polarized incidence ray L0 into light including the first linearly polarized light L1 having the first wavelength λ1, the second linearly polarized light L2 having the second wavelength λ2, and the third linearly polarized light L3 having the third wavelength λ3.

Since the respective layers of the polarizing plate 6 of the present example are laminated and integrated, handling is easy. In addition, according to the present polarizing plate 6, due to the above-described actions, light having different wavelengths 21, 22, and 23 in the non-polarized incidence ray L0 can be converted into linearly polarized lights in different directions.

### Seventh Embodiment

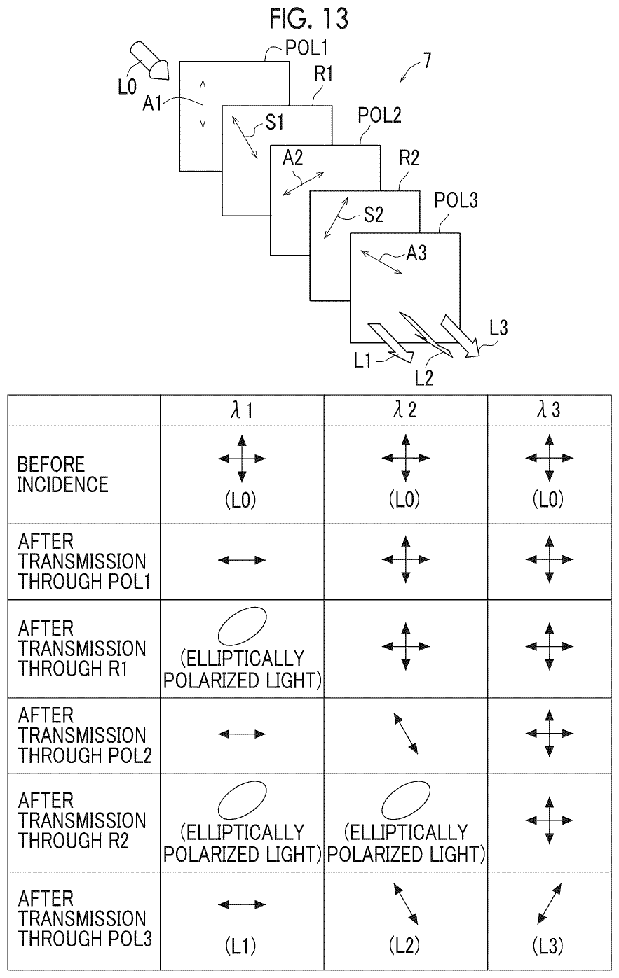

FIG. 13 is a view showing a polarizing plate 7 according to a seventh embodiment. In practice, the polarizing plate 7 is integrated by laminating the respective layers on the support 10, as in the polarizing plates 1 to 4.

The polarizing plate 7 according to the seventh embodiment includes the first light absorption anisotropic layer POL1, the first retardation layer R1, the second light absorption anisotropic layer POL2, the second retardation layer R2, and the third light absorption anisotropic layer POL3 in this order, same as the polarizing plate 6 according to the sixth embodiment. However, different from the polarizing plate 6, the third light absorption anisotropic layer POL3 is disposed in an aspect in which the first absorption axis A1 and the third absorption axis A3 are not orthogonal to each other. That is, in the present example, the first absorption axis A1, the second absorption axis A2, and the third absorption axis A3 intersect with each other (are not parallel to each other) and are not orthogonal to each other. For example, an angle formed by the first absorption axis A1 and the second absorption axis A2 is 60°, and an angle formed by the first absorption axis A1 and the third absorption axis A3 is 120°. Similarly to the polarizing plate 6, the polarizing plate 7 shown in FIG. 13 outputs a first linearly polarized light L1, a second linearly polarized light L2, and a third linearly polarized light L3 having polarization directions different from each other, in a case where the non-polarized incidence ray L0 is incident. A functional difference between the polarizing plate 6 and the polarizing plate 7 is the polarization directions of the second linearly polarized light L2 and the third linearly polarized light L3, in particular, the third linearly polarized light L3 is not orthogonal to the first linearly polarized light L1.

In the polarizing plate 7, a relationship between the first retardation layer R1 and the second light absorption anisotropic layer POL2 is the same as that in the case of the polarizing plates 2 and 6. That is, in the polarizing plate 7, the first slow axis S1 and the second absorption axis A2 are orthogonal to each other, and the above-described expression E1 is satisfied. Therefore, the retardation imparted to the light having the first wavelength λ1 by the second light absorption anisotropic layer POL2 is offset by the retardation due to the first retardation layer R1.

In addition, in the polarizing plate 7, as in the polarizing plate 6, the second slow axis S2 and the third absorption axis A3 are orthogonal to each other, and the above-described expression E5 is satisfied. Therefore, the retardation imparted to the light having the second wavelength λ2 by the third light absorption anisotropic layer POL3 is offset by the retardation due to the second retardation layer R2.

Furthermore, in the polarizing plate 7, in a case where a retardation generated in the light having the first wavelength λ1, which has been transmitted through the third light absorption anisotropic layer POL3, is denoted by ReP3(λ1) and a retardation generated in the light having the first wavelength λ1, which has been transmitted through the second retardation layer R2, is denoted by ReR2(λ1), the second retardation layer R2 satisfies the following expression E6.

$$Re P 3 ( λ 1 ) / Re R 2 ( λ 1 ) = 1 \pm 0.2 \qquad Expression E6$$

The expression E6 means that the retardation ReP3(λ1) generated in the light having the first wavelength λ1, which has been transmitted through the third light absorption anisotropic layer POL3, and the retardation ReR2(λ1) generated in the light having the first wavelength λ1, which has been transmitted through the second retardation layer R2, are substantially the same. By arranging the second slow axis S2 of the second retardation layer R2 and the third absorption axis A3 of the third light absorption anisotropic layer POL3 in an aspect in which they are orthogonal to each other, the retardation imparted to the first wavelength λ1 by the third light absorption anisotropic layer POL3 is offset by the retardation imparted by the second retardation layer R2. As described above, the polarizing plate 7 is different from the polarizing plate 6 in that the angle formed by the first absorption axis A1 and the third absorption axis A3 is not orthogonal to each other and the second retardation layer R2 satisfies the expressions E5 and E6.

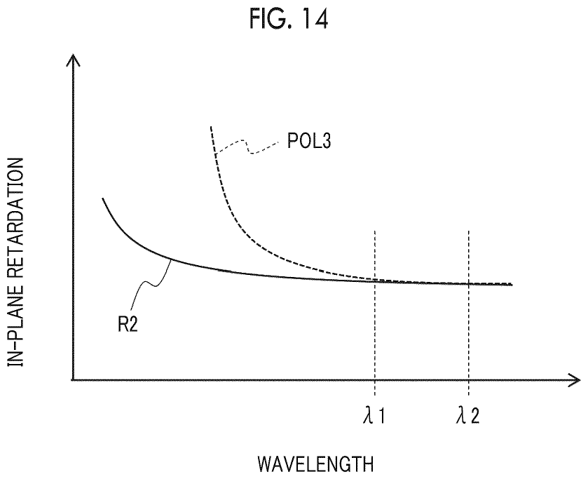

FIG. 14 shows an example of a wavelength dependence of the retardation of the third light absorption anisotropic layer POL3 and a wavelength dependence of the retardation of the second retardation layer R2 in the polarizing plate 7. As shown in FIG. 14, in the polarizing plate 7, the retardation ReP3(λ1) of the third light absorption anisotropic layer POL3 with respect to the first wavelength λ1 and the retardation ReR2(λ1) of the second retardation layer R2 with respect to the first wavelength λ1 are substantially the same; and the retardation ReP3(λ2) of the third light absorption anisotropic layer POL3 with respect to the second wavelength λ2 and the retardation ReR2(λ2) of the second retardation layer R2 with respect to the second wavelength λ2 are substantially the same.

In a case where the non-polarized incidence ray L0 including the first wavelength λ1, the second wavelength λ2, and the third wavelength λ3 is incident into the polarizing plate 7 from the first light absorption anisotropic layer POL1 side, light having the first wavelength λ1 is output as the first linearly polarized light L1, the second wavelength λ2 is output as the second linearly polarized light L2 having a polarization direction different from that of the first linearly polarized light L1, and the third wavelength λ3 is output as the third linearly polarized light L3 having a polarization direction different from that of the first linearly polarized light L1 and the second linearly polarized light L2. That is, the polarizing plate 7 on which the incidence ray L0 is incident converts the incidence ray L0 into light including the first linearly polarized light L1, the second linearly polarized light L2, and the third linearly polarized light L3 having different polarization directions.

The action of the polarizing plate 7 will be described in more detail with reference to the table in FIG. 13. The table in FIG. 13 shows polarization states of lights having the first wavelength λ1, the second wavelength λ2, and the third wavelength λ3, included in the incidence ray L0, before incidence and after transmission through each layer.

The incidence ray L0 is incident into the polarizing plate 5 from the third light absorption anisotropic layer POL3 side. The polarization states of the light having the first wavelength 21, the second wavelength λ2, and the third wavelength λ3 included in the incidence ray L0 are unpolarized as shown in “BEFORE INCIDENCE” in the table of FIG. 13.

The action of the polarizing plate 7 of the present example on the incidence ray L0 shown in FIG. 13 will be described for each of the first wavelength λ1, the second wavelength 22, and the third wavelength λ3.

The polarizing plate 7 acts on light having the first wavelength λ1 in the incidence ray L0 as follows. In the first light absorption anisotropic layer POL1 on which the incidence ray L0 is first incident, a polarized light component along the first absorption axis A1 in the light having the first wavelength λ1 is absorbed. As a result, as shown in “AFTER TRANSMISSION THROUGH POL1” in the table of FIG. 13, the light having the first wavelength λ1, which has been transmitted through the first light absorption anisotropic layer POL1, is linearly polarized light having a direction orthogonal to the first absorption axis A1.

The light having the first wavelength λ1 is incident into the first retardation layer R1 as the linearly polarized light. The polarization direction of the linearly polarized light of the first wavelength λ1 and the first slow axis S1 of the first retardation layer R1 are not parallel or orthogonal to each other. Therefore, the first retardation layer R1 imparts the retardation ReR1(λ1) to the light having the first wavelength λ1 incident into the first retardation layer R1 as linearly polarized light. Therefore, as shown in “AFTER TRANSMISSION THROUGH R1” in the table of FIG. 13, the linearly polarized light of the first wavelength λ1 is elliptically polarized light after passing through the first retardation layer R1. The light having the first wavelength λ1 is incident into the second light absorption anisotropic layer POL2 as elliptically polarized light. In the second light absorption anisotropic layer POL2, the light absorption anisotropy does not act on the light having the first wavelength λ1. On the other hand, the second light absorption anisotropic layer POL2 imparts the retardation ReP2(λ1) to the elliptically polarized light of the first wavelength λ1. As described above, the first slow axis S1 of the first retardation layer R1 and the second absorption axis A2 of the second light absorption anisotropic layer POL2 are arranged in an aspect in which they are orthogonal to each other. Therefore, the retardation imparted to the light having the first wavelength λ1 by the first retardation layer R1 is offset by the second light absorption anisotropic layer POL2. Therefore, as shown in “AFTER TRANSMISSION THROUGH POL2” in the table of FIG. 13, the light having the first wavelength λ1, which has been transmitted through the second light absorption anisotropic layer POL2, returns to linearly polarized light immediately after being transmitted through the first light absorption anisotropic layer POL1.

The light having the first wavelength λ1 is incident into the second retardation layer R2 as the linearly polarized light. The second slow axis S2 of the second retardation layer R2 is not parallel or orthogonal to the polarization direction of the first wavelength λ1. Therefore, the second retardation layer R2 imparts the retardation ReR2(λ1) to the linearly polarized light of the first wavelength λ1 incident into the second retardation layer R2. Therefore, as shown in “AFTER TRANSMISSION THROUGH R2” in the table of FIG. 13, the linearly polarized light of the first wavelength λ1 is elliptically polarized light after passing through the second retardation layer R2. The light having the first wavelength λ1 is incident into the third light absorption anisotropic layer POL3 as elliptically polarized light. In the third light absorption anisotropic layer POL3, the light absorption anisotropy does not act on the light having the first wavelength λ1. On the other hand, the third light absorption anisotropic layer POL3 imparts the retardation ReP3(λ1) to the elliptically polarized light of the first wavelength λ1. As described above, the retardation ReP3(λ1) and ReR2(λ1) are the same (satisfy the expression E6), and the second slow axis S2 of the second retardation layer R2 and the third absorption axis A3 of the third light absorption anisotropic layer POL3 are arranged to be orthogonal to each other. Therefore, the retardation imparted to the light having the first wavelength λ1 by the second retardation layer R2 is offset by the third light absorption anisotropic layer POL3. Accordingly, as shown in “AFTER TRANSMISSION THROUGH POL3” in the table of FIG. 13, the light having the first wavelength λ1, which has been transmitted through the third light absorption anisotropic layer POL3, returns to linearly polarized light immediately after being transmitted through the first light absorption anisotropic layer POL1. The linearly polarized light is output from the polarizing plate 7 as the first linearly polarized light L1.

The action of the polarizing plate 7 on the light having the second wavelength λ2 and the light having the third wavelength λ3 in the incidence ray L0 is the same as that in the case of the polarizing plate 6, and thus the details thereof will be omitted.

Due to the above-described actions, the polarizing plate 7 can convert the non-polarized incidence ray L0 into light including the first linearly polarized light L1 having the first wavelength λ1, the second linearly polarized light L2 having the second wavelength λ2, and the third linearly polarized light L3 having the third wavelength λ3.

In the polarizing plate 7 of the present example, the first absorption axis A1 and the third absorption axis A3 intersect with each other, but are not orthogonal to each other. In the polarizing plate 7, a retardation which offsets a retardation generated during transmission of the light having the first wavelength λ1 and the light having the second wavelength λ2 through the second retardation layer R2 and the third light absorption anisotropic layer POL3 can be provided. Even in a case where the first absorption axis A1 and the third absorption axis A3 are not orthogonal to each other, the first linearly polarized light L1, the second linearly polarized light L2, and the third linearly polarized light L3 having polarization directions intersecting with each other at any angle can be output.

### Eighth Embodiment

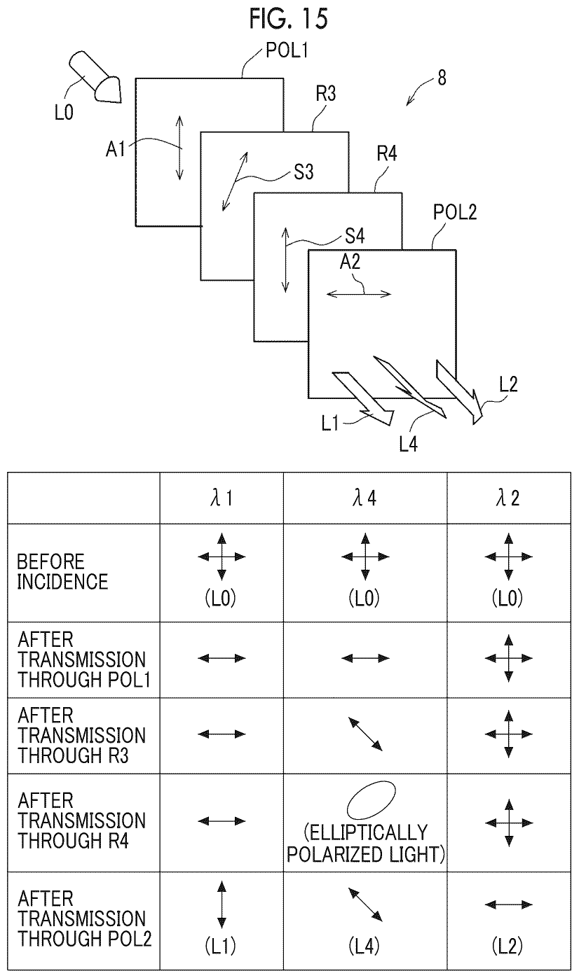

FIG. 15 is a view showing a polarizing plate 8 according to an eighth embodiment. In practice, the polarizing plate 8 is integrated by laminating the respective layers on the support 10, as in the polarizing plates 1 to 4.

The polarizing plate 8 according to the eighth embodiment includes a third retardation layer R3 and a fourth retardation layer R4 between the first light absorption anisotropic layer POL1 and the second light absorption anisotropic layer POL2, which are arranged in an aspect in which the first absorption axis A1 and the second absorption axis A2 intersect with each other. In the polarizing plate 8, the first light absorption anisotropic layer POL1, the third retardation layer R3, the fourth retardation layer R4, and the second light absorption anisotropic layer POL2 are laminated in this order from an incident direction of light.

In the present example, the first light absorption anisotropic layer POL1 contains a fourth dichroic coloring agent in addition to the first dichroic coloring agent. The fourth dichroic coloring agent is a dichroic coloring agent different from the first dichroic coloring agent and the second dichroic coloring agent. Therefore, the first absorption axis A1 of the first light absorption anisotropic layer POL1 exhibits a fourth light absorption property by the fourth dichroic coloring agent, in addition to the first light absorption property by the first dichroic coloring agent. In a case where non-polarized incidence ray L0 including light having a first wavelength λ1, light having a second wavelength λ2, and light having a fourth wavelength λ4 is incident into the polarizing plate 8, the polarizing plate 8 outputs first linearly polarized light L1, second linearly polarized light L2, and fourth linearly polarized light L4 having different polarization directions for each of the first wavelength λ1, the second wavelength λ2, and the fourth wavelength λ4.

The third retardation layer R3 selectively provides a retardation which changes a polarization direction with respect to any one of the light having the first wavelength λ1 or the light having the fourth wavelength λ4, which is output from the first light absorption anisotropic layer POL1. Therefore, in a case where the linearly polarized light of the first wavelength λ1 and the linearly polarized light of the fourth wavelength λ4 are incident, the third retardation layer R3 outputs one of the linearly polarized lights without changing the polarization direction thereof, and changes the polarization direction of the other linearly polarized light to convert the other linearly polarized light into linearly polarized light having a polarization direction different from that at the time of incidence and then outputs the linearly polarized light. In the present example, as an example, the third retardation layer R3 will be described as a layer which provides a retardation for selectively changing the polarization direction with respect to the linearly polarized light of the fourth wavelength λ4. In this case, the third retardation layer R3 does not cause a retardation which changes the polarization direction with respect to the linearly polarized light of the first wavelength λ1. In the present example, the third retardation layer R3 is disposed in an aspect in which a third slow axis S3 which is a slow axis of the third retardation layer R3 is inclined by 22.5° with respect to an axial direction of the first absorption axis A1. In this case, in a case where light having the fourth wavelength λ4 is incident as linearly polarized light, the third retardation layer R3 rotates the polarization direction thereof by 45° and converts the light into linearly polarized light which is inclined by 45° with respect to the polarization direction at the time of incidence, and transmits the linearly polarized light. On the other hand, in a case where the light having the first wavelength λ1 is incident as linearly polarized light, the third retardation layer R3 transmits the light while maintaining the polarization direction thereof.

As the third retardation layer R3, for example, a wavelength selective polarization conversion element manufactured by ColorLink Japan, Ltd. can be used.

The fourth retardation layer R4 imparts a retardation in transmitted light. Here, a retardation generated in the light having the first wavelength λ1 transmitted through the fourth retardation layer R4 is denoted by ReR4(λ1), and a retardation generated in the light having the first wavelength λ1, which has been transmitted through the second light absorption anisotropic layer, is denoted by ReP2(λ1). Here, a retardation generated in the light having the fourth wavelength λ4 transmitted through the fourth retardation layer R4 is denoted by ReR4(λ4), and a retardation generated in the light having the fourth wavelength λ4 which has been transmitted through the second light absorption anisotropic layer is denoted by ReP2(λ4). In this case, the fourth retardation layer R4 satisfies at least one of the following E7-1 or E7-2.

$$ReP 2 ( λ 1 ) / ReR 4 ( λ 1 ) = 1 \pm 0.2 \qquad Expression E7 - 1$$

$$ReP 2 ( λ 4 ) / ReR 4 ( λ 4 ) = 1 \pm 0.2 \qquad Expression E7 - 2$$

The fourth retardation layer R4 is disposed in an aspect in which a fourth slow axis S4 which is a slow axis thereof is orthogonal to the second absorption axis A2 of the second light absorption anisotropic layer POL2.

The expression E7-1 means that the retardation ReP2(λ1) generated in the light having the first wavelength λ1, which has been transmitted through the second light absorption anisotropic layer POL2, and the retardation ReR4(λ1) generated in the light having the first wavelength λ1, which has been transmitted through the fourth retardation layer R4, are substantially the same. In a case of satisfying the expression E7-1, by arranging the fourth slow axis S4 of the fourth retardation layer R4 and the second absorption axis A2 of the second light absorption anisotropic layer POL2 in an aspect in which they are orthogonal to each other, the retardation imparted to the light having the first wavelength λ1 by the second light absorption anisotropic layer POL2 is offset by the retardation imparted by the fourth retardation layer R4.

The expression E7-2 means that the retardation ReP2(λ4) generated in the light having the fourth wavelength λ4, which has been transmitted through the second light absorption anisotropic layer POL2, and the retardation ReR4(λ4) generated in the light having the fourth wavelength λ4, which has been transmitted through the fourth retardation layer R4, are substantially the same. In a case of satisfying the expression E7-2, by arranging the fourth slow axis S4 of the fourth retardation layer R4 and the second absorption axis A2 of the second light absorption anisotropic layer POL2 in an aspect in which they are orthogonal to each other, the retardation imparted to the light having the fourth wavelength λ4 by the second light absorption anisotropic layer POL2 is offset by the retardation imparted by the fourth retardation layer R4.

In a case where the first absorption axis A1 and the second absorption axis A2 are orthogonal to each other, the fourth retardation layer R4 may satisfy one of the expression E7-1 or the expression E7-2. On the other hand, in a case where the first absorption axis A1 and the second absorption axis A2 are not orthogonal to each other, the fourth retardation layer R4 satisfies both of the expression E7-1 and the expression E7-2.

In the polarizing plate 8 shown in FIG. 15, for example, the first absorption axis A1 and the second absorption axis A2 are orthogonal to each other, and the fourth retardation layer R4 satisfies the expression E7-2.

In a case where the non-polarized incidence ray L0 including the first wavelength λ1, the second wavelength λ2, and the fourth wavelength λ4 is incident into the polarizing plate 8, the light having the first wavelength λ1 is output as the first linearly polarized light L1 in which a polarization direction is orthogonal to the first absorption axis A1, the light having the second wavelength λ2 is output as the second linearly polarized light L2 in which a polarization direction is orthogonal to the second absorption axis A2, and the light having the fourth wavelength λ4 is output as the fourth linearly polarized light L4 in which a polarization direction is different from the polarization directions of the first linearly polarized light L1 and the second linearly polarized light L2. That is, the polarizing plate 8 converts the non-polarized incidence ray L0 into light including the first linearly polarized light L1, the second linearly polarized light L2, and the fourth linearly polarized light L4.

The action of the polarizing plate 8 will be described in more detail with reference to the table in FIG. 15. The table in FIG. 15 shows polarization states of lights having the first wavelength λ1, the second wavelength λ2, and the fourth wavelength λ4, included in the incidence ray L0, before incidence and after transmission through each layer.

The incidence ray L0 is incident into the polarizing plate 8 from the first light absorption anisotropic layer POL1 side. The polarization states of the light having the first wavelength 21, the second wavelength λ2, and the fourth wavelength λ4 included in the incidence ray L0 are unpolarized as shown in “BEFORE INCIDENCE” in the table of FIG. 15.

The action of the polarizing plate 8 of the present example on the incidence ray L0 shown in FIG. 15 will be described for each of the first wavelength λ1, the second wavelength 22, and the fourth wavelength λ4.

The polarizing plate 8 acts on the light having the first wavelength λ1 and the light having the fourth wavelength λ4 in the incidence ray L0 as follows. In the first light absorption anisotropic layer POL1 on which the incidence ray L0 is first incident, a polarized light component along the first absorption axis A1 in the light having the first wavelength λ1 and the light having the fourth wavelength λ4 is absorbed. As a result, as shown in “AFTER TRANSMISSION THROUGH POL1” in the table of FIG. 15, the light having the first wavelength λ1 and the light having the fourth wavelength λ4, which have been transmitted through the first light absorption anisotropic layer POL1, is linearly polarized light having a direction orthogonal to the first absorption axis A1. That is, the light having the first wavelength λ1 and the light having the fourth wavelength λ4, which have been transmitted through the first light absorption anisotropic layer POL1, are linearly polarized light having the same polarization direction.

As shown in “After transmission through R3” in the table of FIG. 15, the third retardation layer R3 transmits the linearly polarized light of the first wavelength λ1 as it is. The first wavelength λ1 is incident into the fourth retardation layer R4 as the linearly polarized light. Since the fourth slow axis S4 which is the slow axis of the fourth retardation layer R4 is orthogonal to the polarization direction of the linearly polarized light of the first wavelength λ1 immediately after transmission through the third retardation layer R3, the fourth retardation layer R4 does not impart a substantial retardation in the linearly polarized light of the first wavelength λ1. Therefore, as shown in “After transmission through R4” in the table of FIG. 15, the fourth retardation layer R4 allows the linearly polarized light of the first wavelength λ1 to transmit while maintaining the polarization direction. In the second light absorption anisotropic layer POL2, the light absorption anisotropy does not act on the light having the first wavelength λ1. Therefore, as shown in “AFTER TRANSMISSION THROUGH POL2” in the table of FIG. 15, the linearly polarized light of the first wavelength λ1 is transmitted through the second light absorption anisotropic layer POL2 while maintaining the polarization direction. The linearly polarized light is output from the polarizing plate 8 as the first linearly polarized light L1.

On the other hand, as shown in “After transmission through R3” in the table of FIG. 15, the third retardation layer R3 allows the linearly polarized light of the fourth wavelength λ4 to transmit by rotating the polarization direction by 45°. That is, the light having the fourth wavelength λ4 transmitted through the third retardation layer R3 is linearly polarized light having a polarization direction in which an angle with the polarization direction of the linearly polarized light of the first wavelength λ1 transmitted through the third retardation layer R3 is 45°. The fourth wavelength λ4 is incident into the fourth retardation layer R4 as the linearly polarized light. The fourth slow axis S4 which is the slow axis of the fourth retardation layer R4 is not parallel to or perpendicular to the linearly polarized light of the fourth wavelength λ4 immediately after the light is transmitted through the third retardation layer R3, so that the fourth retardation layer R4 imparts the retardation ReR4(λ4) to the transmitted linearly polarized light of the fourth wavelength λ4. As a result, as shown in “After transmission through R4” in the table of FIG. 15, the light having the fourth wavelength λ4 is elliptically polarized light after transmission through the fourth retardation layer R4. In the second light absorption anisotropic layer POL2, the light absorption anisotropy does not act on the light having the fourth wavelength λ4. On the other hand, the second light absorption anisotropic layer POL2 imparts the retardation ReP2(λ4) to the elliptically polarized light of the fourth wavelength λ4. As described above, the retardation ReP2(λ4) and the retardation ReR4(λ4) are the same (satisfy the expression E7-2), and the fourth slow axis S4 of the fourth retardation layer R4 and the second absorption axis A2 of the second light absorption anisotropic layer POL2 are arranged to be orthogonal to each other. Therefore, the retardation imparted to the light having the fourth wavelength λ4 by the fourth retardation layer R4 is offset by the second light absorption anisotropic layer POL2. Accordingly, as shown in “AFTER TRANSMISSION THROUGH POL2” in the table of FIG. 15, the light having the fourth wavelength λ4, which has been transmitted through the second light absorption anisotropic layer POL2, returns to linearly polarized light immediately after being transmitted through the third retardation layer R3. The linearly polarized light is output from the polarizing plate 8 as the fourth linearly polarized light L4.

The polarizing plate 8 acts on light having the second wavelength λ2 in the incidence ray L0 as follows. In the first light absorption anisotropic layer POL1 on which the incidence ray L0 is first incident, the light absorption anisotropy does not act on the light having the second wavelength λ2. Therefore, as shown in “AFTER TRANSMISSION THROUGH POL1” in the table of FIG. 15, the light having the second wavelength λ2 is transmitted through the first light absorption anisotropic layer POL1 in a non-polarized state. The third retardation layer R3 and the fourth retardation layer R4 do not impart a substantial retardation in non-polarized light. Therefore, as shown in “After transmission through R3” and “After transmission through R4” in the table of FIG. 15, the light having the second wavelength λ2 is transmitted through the third retardation layer R3 and the fourth retardation layer R4 in the non-polarized state. The light having the second wavelength λ2 is incident into the second light absorption anisotropic layer POL2 in the non-polarized state. In the second light absorption anisotropic layer POL2, a polarized light component along the second absorption axis A2 in the light having the second wavelength λ2 is absorbed. As a result, as shown in “AFTER TRANSMISSION THROUGH POL2” in the table of FIG. 15, the light having the second wavelength λ2, which has been transmitted through the second light absorption anisotropic layer POL2, is the second linearly polarized light L2 having a direction orthogonal to the second absorption axis A2.

Due to the above-described actions, the polarizing plate 8 can convert the non-polarized incidence ray L0 into light including the first linearly polarized light L1 having the first wavelength λ1, the second linearly polarized light L2 having the second wavelength λ2, and the fourth linearly polarized light L4 having the fourth wavelength λ4.

The polarizing plate 8 according to the present example has a configuration in which two light absorption anisotropic layers POL1 and POL2 are provided, and can convert three different wavelengths into the first linearly polarized light L1, the second linearly polarized light L2, and the fourth linearly polarized light L4 having different polarization directions.

In this manner, the polarizing plate according to the present disclosure is easily handled and can convert light in a plurality of different wavelength ranges into linearly polarized lights in different polarization directions.

In each of the above-described embodiments, the polarizing plate 1 to the polarizing plate 8, including two or three light absorption anisotropic layers, have been described, but the number of layers of the light absorption anisotropic layers is not limited to two or three. The polarizing plate according to the present disclosure may have a configuration in which four or more light absorption anisotropic layers are provided. By laminating four or more light absorption anisotropic layers having absorption maximal wavelengths different from each other and adjusting the inclination of the absorption axis of each light absorption anisotropic layer, the inclination of the slow axis of the retardation layer provided between the light absorption anisotropic layers, the retardation, and the like according to the examples of the first to eighth embodiments described above, a polarizing plate which converts linearly polarized light into linearly polarized light in different polarization directions can be obtained.

In addition, in a case where the polarizing plate includes three or more light absorption anisotropic layers, it is preferable that a relationship between adjacent absorption spectra is the same as the relationship between the first absorption spectrum 11 and the second absorption spectrum 12 as shown in FIG. 3. That is, it is desirable that an absolute value of a difference in wavelength between absorption maximal wavelengths of adjacent absorption spectra is larger than an average value of half widths at half maximum of the adjacent absorption spectra. It is preferable that the plurality of absorption spectra have a small overlap therebetween because higher polarization performance can be obtained.

Even in a case of a polarizing plate capable of converting three or more wavelengths into linearly polarized light in different polarization directions, the wavelengths are not limited. All of the light may be light in a visible range, or all of the light may be light in a near-infrared range (700 nm or more and 1500 nm or less). Alternatively, a part of the wavelengths may be in the visible range, and a part of the wavelengths may be in the near-infrared range.

In addition, in the polarizing plate according to the present disclosure, each light absorption anisotropic layer may contain two or more dichroic coloring agents, as in the first light absorption anisotropic layer of the eighth embodiment. The first absorption spectrum 11 and the second absorption spectrum shown in FIG. 3 above are an example in a case where the first light absorption anisotropic layer POL1 and the second light absorption anisotropic layer POL2 each contain one kind of dichroic coloring agent. The absorption spectrum of the light absorption anisotropic layer containing a plurality of dichroic coloring agents is an absorbance spectrum obtained by adding a plurality of absorbance spectra of the plurality of dichroic coloring agents. Therefore, the absorption spectrum of the light absorption anisotropic layer containing the plurality of dichroic coloring agents does not always have a single peak. That is, the absorption spectrum of the first light absorption anisotropic layer POL1, the second light absorption anisotropic layer POL2, or the third light absorption anisotropic layer POL3 may have a plurality of peaks. In the absorption spectrum of the light absorption anisotropic layer having a plurality of peaks, in a case where a polarizing plate capable of outputting wavelengths indicating the respective peaks as light in polarization directions different from each other is used as in the eighth embodiment described above, a wavelength of each peak is treated as the absorption maximal wavelength. In addition, the light absorption spectrum of the first light absorption anisotropic layer POL1, the second light absorption anisotropic layer POL2, or the third light absorption anisotropic layer POL3 may exhibit a high absorbance (for example, an absorbance in a range of a strength of approximately +10%) substantially uniformly over a wide wavelength range, by adding a plurality of light absorption spectra of a plurality of dichroic coloring agents. For the light absorption anisotropic layer having an absorption spectrum exhibiting a substantially uniform absorbance over a wide wavelength range, any wavelength in the wavelength range can be treated as the absorption maximal wavelength. For example, in a case where the first light absorption anisotropic layer POL1 has an absorption spectrum exhibiting a substantially uniform absorbance over a wide wavelength range, any wavelength desired to be output as linearly polarized light can be set as the first wavelength. In addition, for example, in a case where the first light absorption anisotropic layer POL1 has an absorption spectrum exhibiting a substantially uniform absorbance over a wide wavelength range, any two wavelengths in the wavelength range can be set as the first wavelength and the fourth wavelength for outputting linearly polarized light in different polarization directions.

In addition, the polarizing plate according to the present disclosure may include a C-plate which does not have an in-plane retardation, in addition to the above-described retardation layers R1 to R4 having an in-plane retardation.

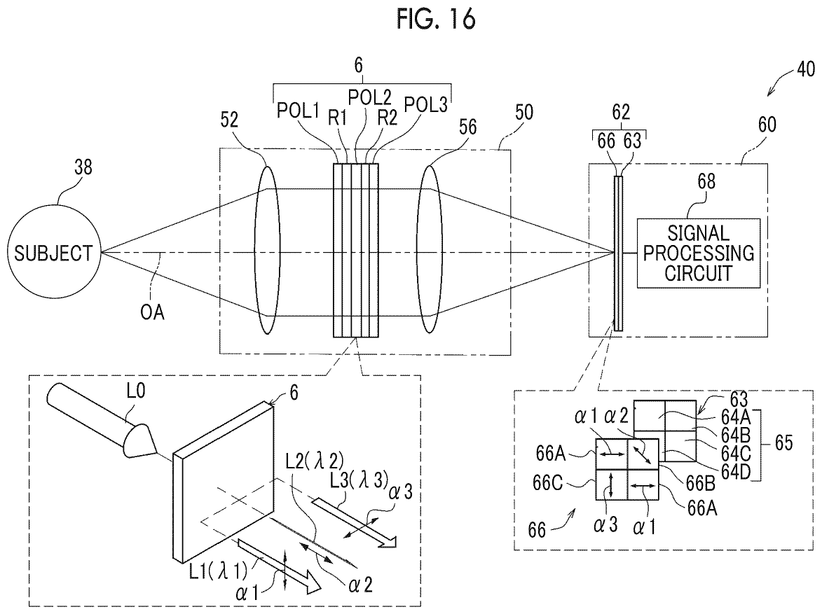

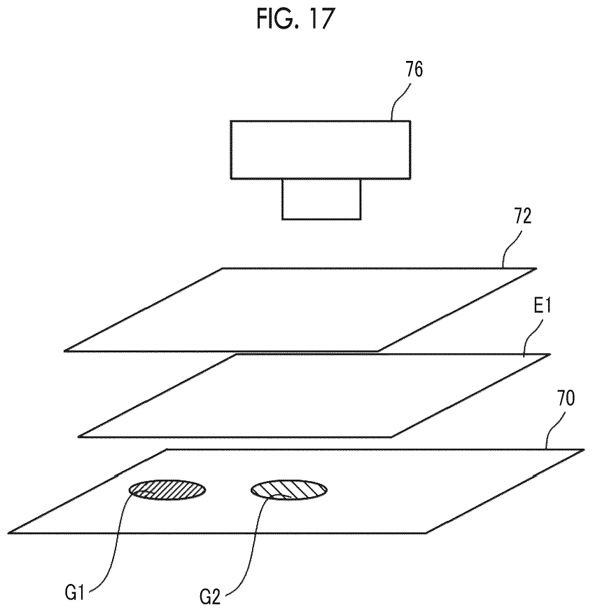

Examples of use of the polarizing plate according to the present disclosure will be described. FIG. 16 is a diagram schematically showing a configuration example of a multispectral camera 40 to which the polarizing plate according to the present disclosure (as an example, the polarizing plate 6 shown in FIG. 12) is applied. The multispectral camera 40 includes an optical system 50 and an image sensor 60. The multispectral camera 40 includes a control driver, an input/output interface, a computer, a display, and the like (not shown). The multispectral camera 40 is an example of an imaging apparatus which generates and outputs a multispectral image of a subject 38 by spectrally separating and imaging light incident from the subject 38 into a plurality of different wavelengths.

The optical system 50 includes a first lens 52, the polarizing plate 6, and a second lens 56. The first lens 52, the polarizing plate 6, and the second lens 56 are arranged in this order along an optical axis OA from the subject 38 side to the image sensor 60 side. The first lens 52 collimates light (hereinafter, referred to as “subject light”) obtained by reflecting light emitted from a light source (not shown) by the subject 38, and causes the light to be incident into the polarizing plate 6. The second lens 56 collects the subject light transmitted through the polarizing plate 6, and forms an image on a light-receiving surface of a photoelectric conversion element provided in the image sensor 60.

In the polarizing plate 6, the first light absorption anisotropic layer POL1, the first retardation layer R1, the second light absorption anisotropic layer POL2, the second retardation layer R2, and the third light absorption anisotropic layer POL3 are arranged in this order from the light incident side. The polarizing plate 6 is disposed in an aspect in which a light incident surface thereof is orthogonal to the optical axis OA. As described above, in a case where the non-polarized incidence ray L0 as the subject light is incident, the polarizing plate 6 outputs the first linearly polarized light L1 of the first wavelength λ1, the second linearly polarized light L2 of the second wavelength λ2, and the third linearly polarized light L3 of the third wavelength 23. The first linearly polarized light L1 to the third linearly polarized light L3 have different polarization directions.

The light of the first wavelength λ1 is converted into the first linearly polarized light L1 in a first polarization direction a1, the light of the second wavelength λ2 is converted into the second linearly polarized light L2 in a second polarization direction a2, and the light of the third wavelength λ3 is converted into the third linearly polarized light L3 in a third polarization direction a3. Here, in a case where the first polarization direction a1 is set to be an angle of 0° as a reference, the second polarization direction a2 is an angle of 45° and the third polarization direction a3 is an angle of 90°.

The image sensor 60 includes a photoelectric conversion element 62 and a signal processing circuit 68. The image sensor 60 is, for example, a complementary metal oxide semiconductor (CMOS) image sensor.

The photoelectric conversion element 62 has a pixel layer 63 and a polarization filter layer 66. For example, FIG. 16 shows a schematic configuration of the pixel layer 63 and the polarization filter layer 66. In the pixel layer 63, a plurality of pixel blocks 65 in which four pixels 64A to 64D of two vertically arranged pixels and two horizontally arranged pixels are included in one pixel block 65 are arranged in a matrix. FIG. 16 shows only the pixels 64A to 64D of one pixel block 65. The pixels 64A to 64D each are a physical pixel having a photodiode, which photoelectrically converts the received light and outputs an electric signal according to the light-receiving amount.

The photoelectric conversion element 62 outputs the electric signals output from the respective pixels 64A to 64D to the signal processing circuit 68 as imaging data. The signal processing circuit 68 converts the analog imaging data input from the photoelectric conversion element 62 into a digital form.

The polarization filter layer 66 includes a first polarizer 66A, a second polarizer 66B, and a third polarizer 66C. The first polarizer 66A has a transmission axis set to an angle of 0°, and transmits the first linearly polarized light L1 in the first polarization direction a1. The second polarizer 66B has a transmission axis set to an angle of 45°, and transmits the second linearly polarized light L2 in the second polarization direction a2. The third polarizer 66C has a transmission axis set to an angle of 90°, and transmits the third linearly polarized light L3 in the third polarization direction a3. Here, for one pixel block 65, as an example, two first polarizers 66A, one second polarizer 66B, and one third polarizer 66C are assigned.

The first linearly polarized light L1 in the incidence ray L0, which is output from the polarizing plate 6 and is the subject light reflected by the subject 38, is transmitted through the first polarizer 66A and is received by the pixels 64A and 64C. The second linearly polarized light L2 in the incidence ray L0, output from the polarizing plate 6, is transmitted through the second polarizer 66B and is received by the pixel 64B. The third linearly polarized light L3 in the incidence ray L0, output from the polarizing plate 6, is transmitted through the third polarizer 66C and is received by the pixel 64D.

The signal processing circuit 68 digitizes the received light signal of the first linearly polarized light L1 of the first wavelength λ1, the received light signal of the second linearly polarized light L2 of the second wavelength λ2, and the received light signal of the third linearly polarized light L3 of the third wavelength λ3, and outputs the digitized signals to the computer (not shown). Accordingly, image processing or the like is performed in the computer, and an image based on the light having the first wavelength λ1, an image based on the light having the second wavelength λ2, and an image based on the light having the third wavelength λ3 can be acquired, respectively.

### EXAMPLES

Hereinafter, features of the present disclosure will be described in more detail with reference to Examples and Comparative Examples. The materials, amounts used, proportions, treatment details, and treatment procedure shown in the following Examples can be appropriately changed without departing from the spirit and scope of the present disclosure. Accordingly, the scope of the present disclosure should not be construed as being limited by the specific examples given below.

### <Synthesis>

A rod-like compound I-1 and dichroic coloring agents II-1 to II-5 having a hydrophilic group were synthesized by a known method. The rod-like compound I-1 was a polymer (n was 2 or more), in which a number-average molecular weight was 25,000 and a molecular weight distribution was 5.1. The rod-like compound I-1 exhibited lyotropic liquid crystallinity.

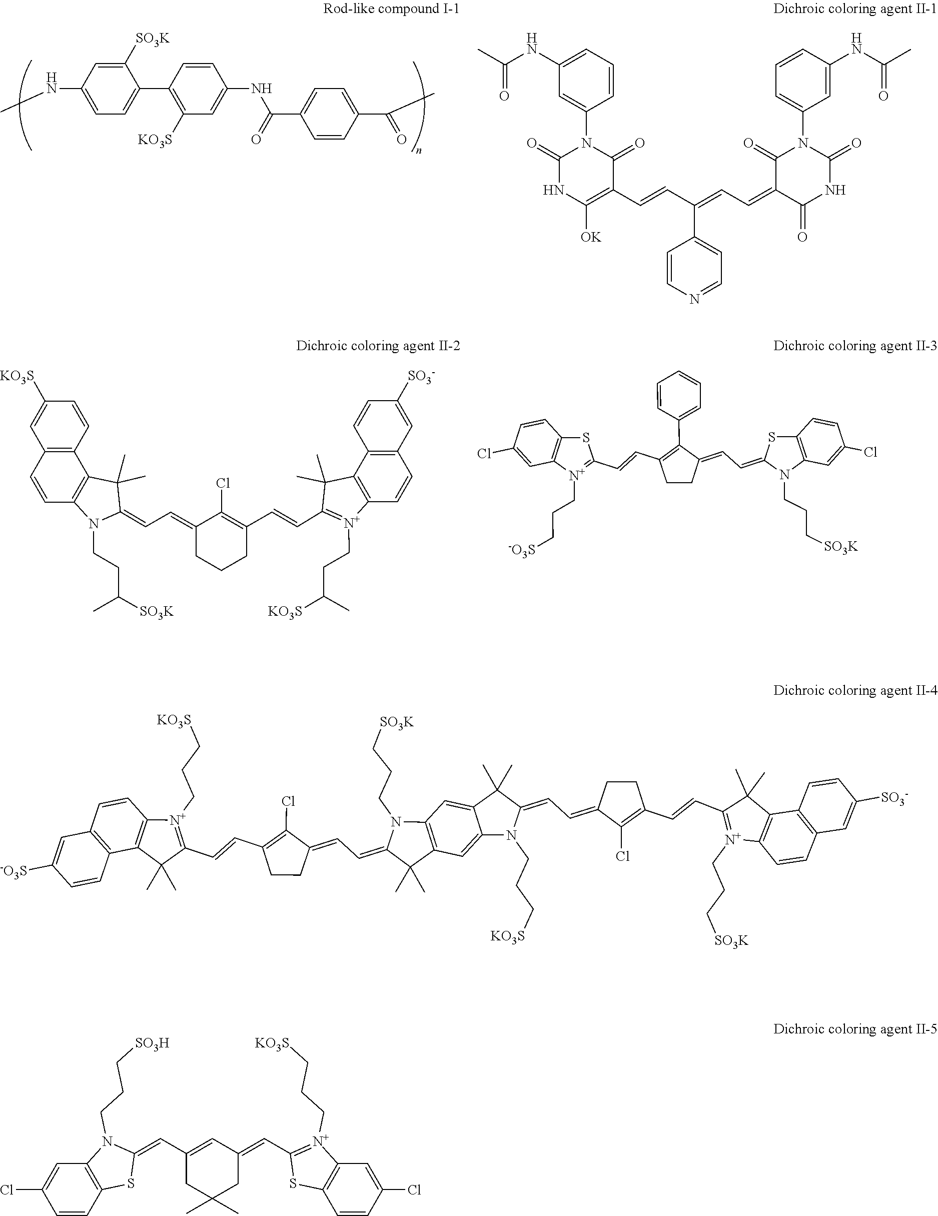

### Example 1

### “Production of Polarizing Plate E1”

A pressure sensitive adhesive (SK-2057, manufactured by Soken Chemical & Engineering Co., Ltd.) was applied onto a surface of a light absorption anisotropic layer P1 of a light absorption anisotropic layer laminate TP1 described later to form a pressure sensitive adhesive layer. A light absorption anisotropic layer laminate TP2 described later was bonded thereto such that the pressure sensitive adhesive layer and a light absorption anisotropic layer P2 were closely attached to each other, thereby obtaining a polarizing plate E1 of Example 1. The light absorption anisotropic layer P2 was bonded such that an angle between an absorption axis of the light absorption anisotropic layer P1 and an absorption axis of the light absorption anisotropic layer P2 was 90°. The polarizing plate E1 was a laminate in which a cellulose acylate film T1, the light absorption anisotropic layer P1, the pressure sensitive adhesive layer, the light absorption anisotropic layer P2, and a cellulose acylate film T1 were laminated in this order. The polarizing plate E1 is an example of the polarizing plate 1 according to the first embodiment, and the light absorption anisotropic layer P1 corresponds to the first light absorption anisotropic layer POL1 and the light absorption anisotropic layer P2 corresponds to the second light absorption anisotropic layer POL2 (see Table 2).

### {Production of Cellulose Acylate Film T1}

### (Preparation of Cellulose Ester Solution A-1)

The following composition was put into a mixing tank and stirred while being heated to dissolve each component, thereby preparing a cellulose ester solution A-1.

Formulation of cellulose ester solution A-1

| | |
|---|---|
| Cellulose acetate (acetylation degree: 2.86) | 100 parts by mass |
| Methylene chloride (first solvent) | 320 parts by mass |
| Methanol (second solvent) | 83 parts by mass |
| 1-Butanol (third solvent) | 3 parts by mass |
| Triphenyl phosphate | 7.6 parts by mass |
| Biphenyl diphenyl phosphate | 3.8 parts by mass |

### (Preparation of Matting Agent Dispersion Liquid B-1)

The following composition was put into a disperser and stirred to dissolve each component, thereby preparing a matting agent dispersion liquid B-1.

Formulation of matting agent dispersion liquid B-1

| | |
|---|---|
| Silica particle dispersion (average particle diameter: | 10.0 parts by mass |
| 16 nm) “AEROSIL R972”, manufactured by Nippon | |
| Aerosil Co., Ltd. | |
| Methylene chloride | 72.8 parts by mass |
| Methanol | 3.9 parts by mass |
| Butanol | 0.5 parts by mass |
| Cellulose ester solution A-1 | 10.3 parts by mass |

### (Preparation of Ultraviolet Absorbing Agent Solution C1)

The following composition was put into a mixing tank and stirred while being heated to dissolve each component, thereby preparing an ultraviolet absorbing agent solution C1.

Formulation of ultraviolet absorbing agent solution CI

| | |
|---|---|
| Ultraviolet absorbing agent (UV-1 shown below) | 10.0 parts by mass |
| Ultraviolet absorbing agent (UV-2 shown below) | 10.0 parts by mass |
| Methylene chloride | 55.7 parts by mass |
| Methanol | 10 parts by mass |
| Butanol | 1.3 parts by mass |
| Cellulose ester solution A-1 | 12.9 parts by mass |

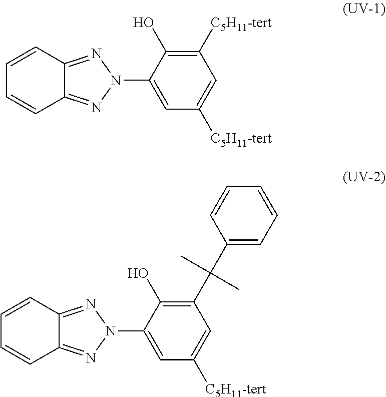

### (Production Step of Cellulose Acylate Film T1)

The ultraviolet absorbing agent solution C1 was added to a mixture of 94.6 parts by mass of the cellulose ester solution A-1 and 1.3 parts by mass of the matting agent dispersion liquid B-1 such that the amount of the ultraviolet absorbing agent (UV-1) and the amount of the ultraviolet absorbing agent (UV-2) respectively reached 1.0 parts by mass with respect to 100 parts by mass of cellulose acylate, and the solution was sufficiently stirred while being heated to dissolve each component, thereby preparing a dope. The obtained dope was heated to 30° C. and cast on a mirror surface stainless steel support, serving as a drum having a diameter of 3 m, through a casting geeser. The surface temperature of the mirror surface stainless steel support was set to −5° C., and the coating width was set to 1470 mm. The cast dope film was dried by applying drying air at 34° C. on the drum at 150 m³/min, and the dope film was peeled off from the drum in a state in which the residual solvent was 150% in a case where a solid component in the dope film was 100%. During the peeling, the film was stretched by 15% in the transport direction (longitudinal direction). Thereafter, both ends of the film in the width direction (that is, a direction orthogonal to the casting direction) were transported while being gripped by a pin tenter (specifically, a pin tenter described in FIG. 3 of JP1992-1009A (JP-H4-1009A)). In this case, the stretching treatment was not performed in the width direction of the film. Furthermore, the film was further dried by transporting the film between rolls of a heat treatment device to produce a cellulose acylate film T1. In the produced elongated cellulose acylate film T1, an amount of the residual solvent was 0.2%, a thickness was 60 μm, and an in-plane retardation Re and a thickness direction retardation Rth at a wavelength of 550 nm were 0.8 nm and 40 nm, respectively.

### (Alkali Saponification Treatment)

After passing the above-described cellulose acylate film T1 through a dielectric heating roll at a temperature of 60° C. to raise the film surface temperature to 40° C., an alkaline solution having the formulation shown below was applied onto a band surface of the film using a bar coater at a coating amount of 14 ml/m², followed by heating to 110° C., and transportation of the film under a steam type far-infrared heater manufactured by Noritake Company Limited for 10 seconds. Subsequently, pure water was applied at 3 mL/m² using the same bar coater. Next, the film was washed with water by a fountain coater and drained by an air knife three times, and then transported to a drying zone at 70° C. for 10 seconds and dried to produce a cellulose acylate film T1 subjected to an alkali saponification treatment.

Formulation of alkali solution

| | |
|---|---|
| Potassium hydroxide | 4.7 parts by mass |
| Water | 15.8 parts by mass |
| Isopropanol | 63.7 parts by mass |
| Surfactant SF-1 C₁₄H₂₉O(CH₂CH₂O)₂₀H | 1.0 part by mass |
| Propylene glycol | 14.8 parts by mass |

### {Production of Light Absorption Anisotropic Layer Laminate TP1}

A light absorption anisotropic layer P1 described below was formed on the cellulose acylate film T1 to produce a light absorption anisotropic layer laminate TP1 including the light absorption anisotropic layer P1 on the cellulose acylate film T1.

### (Formation of Light Absorption Anisotropic Layer P1)

A composition 1 for forming a light absorption anisotropic layer, having the following formulation, was prepared. The composition 1 for forming a light absorption anisotropic layer was a composition exhibiting lyotropic liquid crystallinity.

Formulation of composition 1 for forming light absorption
anisotropic layer

| | |
|---|---|
| Rod-like compound I-1 | 10 parts by mass |
| Dichroic coloring agent II-2 | 0.5 parts by mass |
| Water | 89.5 parts by mass |

5 g of the composition 1 for forming a light absorption anisotropic layer prepared above and 20 g of zirconia beads having a diameter Φ of 2 mm were filled in a 45 mL container made of zirconia, and using a planetary ball mill P-7 classic line manufactured by Frisch GmbH, milling was performed for 50 minutes at a rotation speed of 300 rpm. The composition 1 for forming a light absorption anisotropic layer, which had been subjected to the milling treatment as described above, was applied onto the surface of the cellulose acylate film T1, which had been subjected to the above-described alkali saponification treatment, using a wire bar (moving speed: 100 cm/s), and naturally dried. Next, the obtained coating film was immersed in a 1 mol/L calcium chloride aqueous solution for 5 seconds, washed with ion exchange water, and blast-dried to fix the alignment state, thereby producing a light absorption anisotropic layer P1 having a film thickness of 1 μm. An absorption maximal wavelength of the light absorption anisotropic layer P1 was 960 nm.

### {Production of Light Absorption Anisotropic Layer Laminate TP2}

A light absorption anisotropic layer laminate TP2 in which a light absorption anisotropic layer P2 was laminated on the cellulose acylate film T1 was produced in the same manner as in the production of the light absorption anisotropic layer laminate TP1, except that the light absorption anisotropic layer P1 was changed to the light absorption anisotropic layer P2 described later.

### (Formation of Light Absorption Anisotropic Layer P2)

A light absorption anisotropic layer P2 was formed on the cellulose acylate film T1 by the same method as that for the light absorption anisotropic layer P1, except that the dichroic coloring agent II-2 in the formulation of the composition 1 for forming a light absorption anisotropic layer was changed to the above-described dichroic coloring agent II-1. An absorption maximal wavelength of the light absorption anisotropic layer P2 was 850 nm.

### Example 2

### “Production of Polarizing Plate E2”

A polarizing plate E2 of Example 2 was produced in the same manner as in Example 1, except that, in the production of the polarizing plate E1 of Example 1, the light absorption anisotropic layer laminate TP1 was changed to a light absorption anisotropic layer laminate TP3 described below. The polarizing plate E2 was a laminate in which a cellulose acylate film T1, the light absorption anisotropic layer P3, the pressure sensitive adhesive layer, the light absorption anisotropic layer P2, and a cellulose acylate film T1 were laminated in this order. The polarizing plate E2 is an example of the polarizing plate 1 according to the first embodiment, and the light absorption anisotropic layer P3 corresponds to the first light absorption anisotropic layer POL1 and the light absorption anisotropic layer P2 corresponds to the second light absorption anisotropic layer POL2 (see Table 2).

### {Production of Light Absorption Anisotropic Layer Laminate TP3}

A light absorption anisotropic layer laminate TP3 in which a light absorption anisotropic layer P2 was laminated on the cellulose acylate film T1 was produced in the same manner as in the production of the light absorption anisotropic layer laminate TP1, except that the light absorption anisotropic layer P1 was changed to the light absorption anisotropic layer P3 described later.

### (Formation of Light Absorption Anisotropic Layer P3)

A light absorption anisotropic layer P3 was formed on the cellulose acylate film T1 by the same method as in Example 1, except that, in the formation of the light absorption anisotropic layer P1 of Example 1, the composition 1 for forming a light absorption anisotropic layer was changed to the following composition 3 for forming a light absorption anisotropic layer. An absorption maximal wavelength of the light absorption anisotropic layer P3 was 960 nm.

| Formulation of composition 3 for forming light absorption anisotropic layer | |
|---|---|
| Dichroic coloring agent II-2 | 7.5 parts by mass |
| Water | 92.5 parts by mass |

### Example 3

### “Production of Polarizing Plate E3”

A pressure sensitive adhesive (SK-2057, manufactured by Soken Chemical & Engineering Co., Ltd.) was applied onto the surface of the above-described light absorption anisotropic layer laminate TP1, which was a surface of the cellulose acylate film T1 and was not provided with the light absorption anisotropic layer P1. An optically anisotropic layer laminate TO1 described later, in which an optically anisotropic layer O1 was formed on the cellulose acylate film T1 through an alignment film 1, was bonded thereto such that the pressure sensitive adhesive layer and the optically anisotropic layer O1 were closely attached to each other. Thereafter, the cellulose acylate film T1 and the alignment film 1 were peeled off from the optically anisotropic layer O1 to obtain a laminate. Next, a pressure sensitive adhesive (SK-2057, manufactured by Soken Chemical & Engineering Co., Ltd.) was applied onto the surface of the optically anisotropic layer O1 exposed by peeling off the cellulose acylate film T1 and the alignment film 1 of the obtained laminate to form a pressure sensitive adhesive layer, and the above-described light absorption anisotropic layer laminate TP2 was bonded thereto such that the pressure sensitive adhesive layer and the light absorption anisotropic layer P2 were closely attached to each other. Thereafter, the cellulose acylate film T1 of the light absorption anisotropic layer laminate TP2 was peeled off to obtain a polarizing plate E3 of Example 3.

The polarizing plate E3 was a laminate in which the light absorption anisotropic layer P1, the cellulose acylate film T1, the pressure sensitive adhesive layer, the optically anisotropic layer O1, the pressure sensitive adhesive layer, and the light absorption anisotropic layer P2 were laminated in this order. The polarizing plate E3 is an example of the polarizing plate 2 according to the second embodiment, and the light absorption anisotropic layer P1 corresponds to the first light absorption anisotropic layer POL1, the optically anisotropic layer O1 corresponds to the first retardation layer R1, and the light absorption anisotropic layer P2 corresponds to the second light absorption anisotropic layer POL2 (see Table 2).

At 960 nm of the absorption maximal wavelength (corresponding to the first wavelength 21) of the light absorption anisotropic layer P1, an in-plane retardation Re of the optically anisotropic layer O1 was 244 nm, and an in-plane retardation Re of the light absorption anisotropic layer P2 was 249 nm. That is, the retardation ReR1(λ1)=244 nm generated in the light having the first wavelength λ1, which had been transmitted through the first retardation layer R1, was substantially the same as the retardation ReP2(λ1)=249 nm generated in the light having the first wavelength λ1, which had been transmitted through the second light absorption anisotropic layer POL2, and the expression E1 was satisfied.

In the polarizing plate E3, orientations of the absorption axis (corresponding to the first absorption axis A1) of the light absorption anisotropic layer P1, the slow axis (corresponding to the first slow axis S1) of the optically anisotropic layer O1, and the absorption axis (corresponding to the second absorption axis A2) of the light absorption anisotropic layer P2 were set to 0°, 150°, and 60°, respectively. The fact that the orientations of the first absorption axis A1, the first slow axis S1, and the second absorption axis A2 were respectively 0°, 150°, and 60° means that, with the first absorption axis A1 as 0° (reference), an angle formed by the first absorption axis A1 and the first slow axis S1 was 150° and an angle formed by the first absorption axis A1 and the second absorption axis A2 was 60°. The same applies to Examples below.

### {Production of Optically Anisotropic Layer Laminate TO1}

The following alignment film 1 was formed on the cellulose acylate film T1, and an optically anisotropic layer O1 was formed on the alignment film 1 to produce an optically anisotropic layer laminate TO1 in which the alignment film 1 and the optically anisotropic layer O1 were laminated in this order on the cellulose acylate film T1.

### (Formation of Alignment Film 1)

The surface of the above-described cellulose acylate film T1, on which the alkali saponification treatment had been performed, was continuously coated with an alignment film coating liquid (A) having the following formulation using a #14 wire bar. The coating film was dried with hot air at 60° C. for 60 seconds and further dried with hot air at 100° C. for 120 seconds.

Formulation of alignment film coating liquid (A)

| | |
|---|---|
| Modified polyvinyl alcohol 1 shown below | 10 parts by mass |
| Water | 308 parts by mass |
| Methanol | 70 parts by mass |
| Isopropanol | 29 parts by mass |
| Photopolymerization initiator (IRGACURE 2959, | 0.8 parts by mass |
| manufactured by BASF Japan Ltd.) | |

Modified polyvinyl alcohol 1

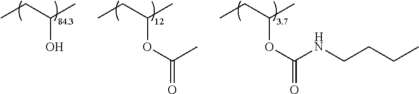

### (Formation of Optically Anisotropic Layer O1)

The alignment film 1 produced above was continuously subjected to a rubbing treatment. In this case, a longitudinal direction and a transport direction of the elongated film were parallel to each other, and an angle between the longitudinal direction (transport direction) of the film and a rotation axis of a rubbing roller was 72.5°. In a case where the longitudinal direction (transport direction) of the film was defined as 90° and a clockwise direction was represented by a positive value with reference to a width direction of the film as a reference) (0° in a case of being observed from the alignment film 1 side, the rotation axis of the rubbing roller was −17.5°. In other words, the position of the rotation axis of the rubbing roller corresponded to a position rotated by 72.5° clockwise with reference to the longitudinal direction of the film.

The alignment film 1 produced above was continuously coated with an optically anisotropic layer coating liquid (A) containing a discotic liquid crystal (DLC) compound having the following formulation using a wire bar. A transportation speed (V) of the film was 26 m/min. In order to dry the solvent of the coating liquid and to mature the alignment of the DLC compound, the film was heated with hot air at 115° C. for 90 seconds, further heated with hot air at 80° C. for 60 seconds, and irradiated with ultraviolet (UV) rays (irradiation amount: 70 mJ/cm²) at 80° C. to fix the alignment of the liquid crystal compound, thereby producing an optically anisotropic layer O1. A thickness of the optically anisotropic layer O1 was 2.3 μm. It was confirmed that an average tilt angle of a disc plane of the DLC compound with respect to the film surface was 90°, and the DLC compound was aligned perpendicular to the film surface. In addition, the angle of the slow axis was parallel to the rotation axis of the rubbing roller, and in a case where the longitudinal direction (transport direction) of the film was indicated by 90° (the width direction of the film was 0° and a counterclockwise direction was indicated by a positive value with reference to the width direction of the film as a reference) (0° observed from the alignment film 1 side), the angle of the slow axis was −17.5°.

Formulation of optically anisotropic layer coating liquid (A)

| | |
|---|---|
| Discotic liquid crystal compound (A) shown below | 80 parts by mass |
| Discotic liquid crystal compound (B) shown below | 20 parts by mass |
| Ethylene oxide-modified trimethylolpropane triacrylate | 5 parts by mass |
| (V#360, manufactured by Osaka Organic Chemical Industry Ltd.) | |
| Photopolymerization initiator (IRGACURE 907, manufactured by BASF Japan Ltd.) | 4 parts by mass |
| Compound A shown below | 2 parts by mass |
| Pyridinium salt (A) shown below | 1.2 parts by mass |
| Polymer A shown below | 0.2 parts by mass |
| Polymer B shown below | 0.1 parts by mass |
| Polymer C shown below | 0.06 parts by mass |
| Methyl ethyl ketone | 212.9 parts by mass |

Discotic liquid crystal compound (A) 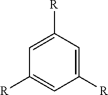 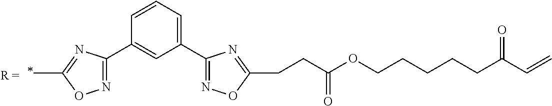 [SMILES: C=CC(=O)CCCCCOC(=O)CCc1nc(-c2cccc(-c3noc(C)n3)c2)no1]
Discotic liquid crystal compound (B) 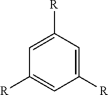 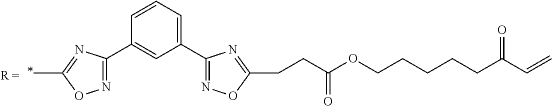 [SMILES: C=CC(=O)CCCCCOC(=O)CCc1nc(-c2cccc(-c3noc(C)n3)c2)no1]
Pyridinium salt (A) 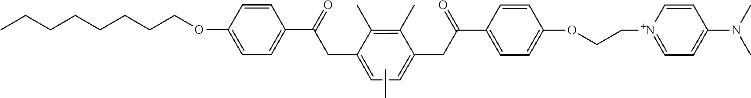 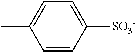
(Compound A) 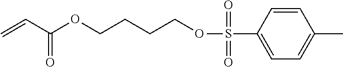 [SMILES: C=CC(=O)OCCCCOS(=O)(=O)c1ccc(C)cc1]
(Polymer A) 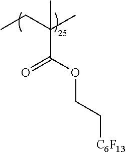 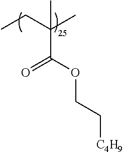 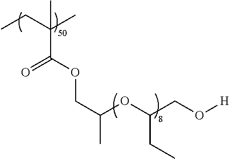
(Polymer B) 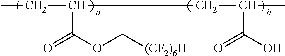
ₐrepresents 90 and
_{b}represents 10.
(Polymer C)

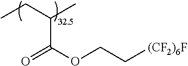

### Example 4

### “Production of Polarizing Plate E4”

A polarizing plate E4 of Example 4 was produced by the same method as in Example 3, except that, in the production of the polarizing plate E3 of Example 3, the light absorption anisotropic layer laminate TP2 was changed to a light absorption anisotropic layer laminate TP4 described later, and the optically anisotropic layer laminate TO1 including the optically anisotropic layer O1 was changed to an optically anisotropic layer laminate TO2 including an optically anisotropic layer O2 described later. In the production step of the polarizing plate E3, the pressure sensitive adhesive layer was formed on the surface of the optically anisotropic layer O1, the light absorption anisotropic layer laminate TP2 was bonded thereto such that the pressure sensitive adhesive layer and the light absorption anisotropic layer P2 were closely attached to each other, and then the cellulose acylate film T1 of the light absorption anisotropic layer laminate TP2 was peeled off. On the other hand, in the production step of the polarizing plate E4, the pressure sensitive adhesive layer was formed on the surface of the optically anisotropic layer O2, the light absorption anisotropic layer laminate TP4 was bonded thereto such that the pressure sensitive adhesive layer and an oxygen shielding layer B1 described later were closely attached to each other, and then the cellulose acylate film T2 and a photo-alignment film PA1 were peeled off from the light absorption anisotropic layer laminate TP4.

The polarizing plate E4 was a laminate in which the light absorption anisotropic layer P1, the cellulose acylate film T1, the pressure sensitive adhesive layer, the optically anisotropic layer O2, the pressure sensitive adhesive layer, the oxygen shielding layer B1, and the light absorption anisotropic layer P4 were laminated in this order. The polarizing plate E4 is an example of the polarizing plate 2 according to the second embodiment, and the light absorption anisotropic layer P1 corresponds to the first light absorption anisotropic layer POL1, the optically anisotropic layer O2 corresponds to the first retardation layer R1, and the light absorption anisotropic layer P4 corresponds to the second light absorption anisotropic layer POL2 (see Table 2).

At 960 nm of the absorption maximal wavelength (the first wavelength λ1) of the light absorption anisotropic layer P1, an in-plane retardation Re of the optically anisotropic layer O2 was 489 nm, and an in-plane retardation Re of the light absorption anisotropic layer P4 was 482 nm. That is, the retardation ReR1(λ1)=489 nm generated in the light having the first wavelength λ1, which had been transmitted through the first retardation layer R1, was substantially the same as the retardation ReP2(λ1)=482 nm generated in the light having the first wavelength λ1, which had been transmitted through the second light absorption anisotropic layer POL2, and the expression E1 was satisfied.

### {Production of Cellulose Acylate Film T2}

### (Preparation of Core Layer Cellulose Acylate Dope)

The following composition was put into a mixing tank and stirred to dissolve each component, thereby preparing a cellulose acetate solution used as a core layer cellulose acylate dope.

Core layer cellulose acylate dope

| | |
|---|---|
| Cellulose acetate having acetyl substitution | 100 parts by mass |
| degree of 2.88 | |
| Polyester compound B described in Examples | 12 parts by mass |
| of JP2015-227955A | |
| Compound F shown below | 2 parts by mass |
| Methylene chloride (first solvent) | 430 parts by mass |
| Methanol (second solvent) | 64 parts by mass |

Compound F

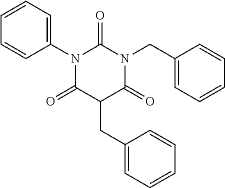 [SMILES: O=C1C(Cc2ccccc2)C(=O)N(c2ccccc2)C(=O)N1Cc1ccccc1]

### (Preparation of Outer Layer Cellulose Acylate Dope)

10 parts by mass of the following matte agent solution was added to 90 parts by mass of the core layer cellulose acylate dope to prepare a cellulose acetate solution to be used as an outer layer cellulose acylate dope.

Matting agent solution

| | |
|---|---|
| Silica particles with average particle size of 20 nm | 2 parts by mass |
| (AEROSIL R972, manufactured by Nippon | |
| Aerosil Co., Ltd.) | |
| Methylene chloride (first solvent) | 76 parts by mass |
| Methanol (second solvent) | 11 parts by mass |
| Core layer cellulose acylate dope described above | 1 part by mass |

### (Production Step of Cellulose Acylate Film T2)

The core layer cellulose acylate dope and the outer layer cellulose acylate dope were filtered through filter paper having an average hole diameter of 34 μm and a sintered metal filter having an average pore size of 10 μm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off from the drum in a state in which the solvent content was approximately 20% by mass, both ends of the film in the width direction were fixed by tenter clips, and the film was dried while being stretched at a stretching ratio of 1.1 times in the lateral direction.

Thereafter, the film was further dried by being transported between the rolls of the heat treatment device to produce an optical film (transparent support) having a thickness of 40 μm, and the optical film was used as a cellulose acylate film T2. An in-plane retardation Re of the obtained cellulose acylate film T2 was 0 nm.

### (Formation of Photo-Alignment Film PA1)

The above-described cellulose acylate film T2 was continuously coated with the following coating liquid for forming a photo-alignment film using a wire bar. The cellulose acylate film T2 on which the coating film was formed was dried with hot air at 140° C. for 120 seconds, and irradiated with polarized ultraviolet rays (10 mJ/cm², using an ultra-high pressure mercury lamp) to form a photo-alignment film PA1. A film thickness of the photo-alignment film PA1 was 0.5 μm.

Coating liquid for forming photo-alignment film

| | |
|---|---|
| Polymer PA-1 shown below | 100.00 parts by mass |
| Acid generator PAG-1 shown below | 8.25 parts by mass |
| Stabilizer DIPEA shown below | 0.6 parts by mass |
| Xylene | 1126.60 parts by mass |
| Methyl isobutyl ketone | 125.18 parts by mass |

Polymer PA-1 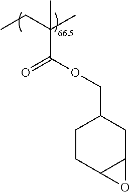 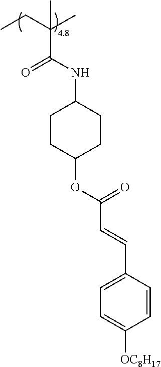 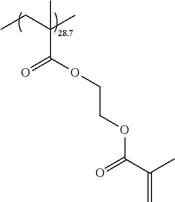
Acid generator PAG-1 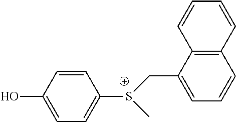 [SMILES: C[S+](Cc1cccc2ccccc12)c1ccc(O)cc1] 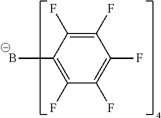
Stabilizer DIPEA

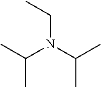

### {Production of Light Absorption Anisotropic Layer Laminate TP4}

A light absorption anisotropic layer P4 described below was formed on the photo-alignment film PA1 formed on the cellulose acylate film T2 described above, and an oxygen shielding layer B1 described later was further formed thereon. In this manner, a light absorption anisotropic layer laminate TP4 in which the cellulose acylate film T2, the photo-alignment film PA1, the light absorption anisotropic layer P4, and the oxygen shielding layer B1 were laminated was produced.

### (Formation of Light Absorption Anisotropic Layer P4)

A composition 4 for forming a light absorption anisotropic layer, having the following formulation, was prepared. The photo-alignment film PA1 was continuously coated with the composition 4 for forming a light absorption anisotropic layer using a wire bar to form a coating layer.

Next, the coating layer was heated at 140° C. for 15 seconds, and then cooled to room temperature (23° C.).

Next, the coating layer was heated at 80° C. for 60 seconds, and then cooled to room temperature again.

Thereafter, the coating layer was irradiated with light of a light emitting diode (LED) lamp (central wavelength: 365 nm) under an irradiation condition of an illuminance of 200 mW/cm² for 2 seconds, thereby curing the coating layer to produce the light absorption anisotropic layer P4 on the photo-alignment film PA1. A film thickness of the light absorption anisotropic layer P4 was 0.5 μm. An absorption wavelength of the light absorption anisotropic layer P4 was in the entire visible range. The light absorption anisotropic layer P4 contained the following three dichroic coloring agents C-1, M-1, and Y-1 having different absorption maximal wavelengths. In the light absorption anisotropic layer P4, absorption spectra of the dichroic coloring agents overlapped each other, and high light absorption anisotropy was exhibited over the entire visible range.

Formulation of composition 4 for forming light absorption anisotropic layer]

| | |
|---|---|
| Dichroic coloring agent C-1 shown below | 0.59 parts by mass |
| Dichroic coloring agent M-1 shown below | 0.36 parts by mass |
| Dichroic coloring agent Y-1 shown below | 0.24 parts by mass |
| Liquid crystal compound L-1 shown below | 5.55 parts by mass |
| Polymerization initiator | |
| IRGACURE OXE-02 (manufactured by BASF Japan Ltd.) | 0.21 parts by mass |
| Surfactant F-1 shown below | 0.055 parts by mass |
| Cyclopentanone | 45.34 parts by mass |
| Tetrahydrofuran | 45.34 parts by mass |
| Benzyl alcohol | 2.33 parts by mass |

Dichroic coloring agent C-1 (absorption maximal wavelength: 570 nm) 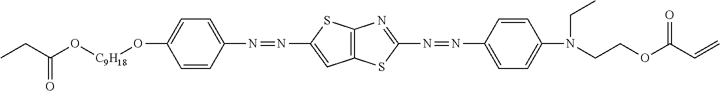
Dichroic coloring agent M-1 (absorption maximal wavelength: 466 nm) 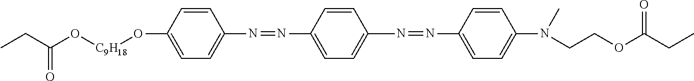
Dichroic coloring agent Y-1 (absorption maximal wavelength: 417 nm) 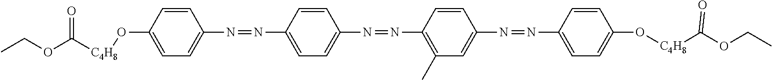
Liquid crystal compound L-1 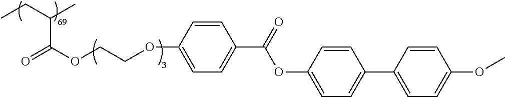 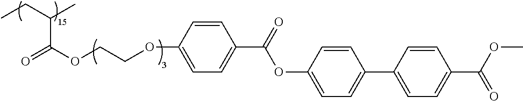 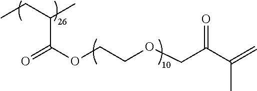
Surfactant F-1

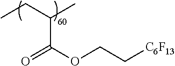

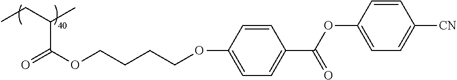

### (Formation of Oxygen Shielding Layer B1)

The light absorption anisotropic layer P4 was continuously coated with a coating liquid for forming an oxygen shielding layer, having the following formulation, using a wire bar to form a coating layer. Thereafter, the coating layer was dried with hot air at 80° C. for 5 minutes to form an oxygen shielding layer B1 consisting of polyvinyl alcohol (PVA), having a thickness of 1.0 μm. In this manner, the light absorption anisotropic layer laminate TP4 including the cellulose acylate film T2, the photo-alignment film PA1, the light absorption anisotropic layer P4, and the oxygen shielding layer B1 in this order was obtained.

Formulation of coating liquid for forming oxygen shielding layer

| | |
|---|---|
| Modified polyvinyl alcohol 2 shown below | 3.80 parts by mass |
| Photopolymerization initiator (IRGACURE 2959, | 0.20 parts by mass |
| manufactured by BASF Japan Ltd.) | |
| Water | 70 parts by mass |
| Methanol | 30 parts by mass |

Modified polyvinyl alcohol 2

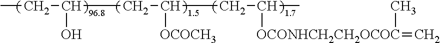

### {Production of Optically Anisotropic Layer Laminate TO2}

The following alignment film 1 was formed on the cellulose acylate film T1, and an optically anisotropic layer O2 was formed on the alignment film 1 to produce an optically anisotropic layer laminate TO2 in which the alignment film 1 and the optically anisotropic layer O2 were laminated in this order on the cellulose acylate film T1.

### (Formation of Optically Anisotropic Layer O2)

Two optically anisotropic layer laminates TO1 were produced. A pressure sensitive adhesive (SK-2057, manufactured by Soken Chemical & Engineering Co., Ltd.) was applied to a surface of an optically anisotropic layer O1 in one optically anisotropic layer laminate TO1 of the two optically anisotropic layer laminates TO1 to form a pressure sensitive adhesive layer, and the other optically anisotropic layer laminate TO1 was bonded thereto such that the pressure sensitive adhesive layer and the optically anisotropic layer O1 were closely attached to each other. As a result, an optically anisotropic layer O2 in which two optically anisotropic layers O1 were laminated with the pressure sensitive adhesive layer interposed therebetween was formed. In a case where the optically anisotropic layers O1 were bonded to each other, slow axes of the optically anisotropic layers O1 were parallel to each other.

Thereafter, the cellulose acylate film T1 and the alignment film 1 of the one optically anisotropic layer laminate TO1 were peeled off. In this manner, an optically anisotropic layer laminate TO2 in which the alignment film 1 and the optically anisotropic layer O2 were laminated on the cellulose acylate film T1 was obtained.

### Example 5

### “Production of Polarizing Plate E5”

A pressure sensitive adhesive (SK-2057, manufactured by Soken Chemical & Engineering Co., Ltd.) was applied onto the surface of the above-described light absorption anisotropic layer laminate TP1, which was a surface of the cellulose acylate film T1 and was not provided with the light absorption anisotropic layer P1. The above-described optically anisotropic layer laminate TO1 was bonded thereto such that the pressure sensitive adhesive layer and the optically anisotropic layer O1 were closely attached to each other. Thereafter, the cellulose acylate film T1 and the alignment film 1 were peeled off from the optically anisotropic layer O1 to obtain a laminate. A pressure sensitive adhesive (SK-2057, manufactured by Soken Chemical & Engineering Co., Ltd.) was applied onto the surface of the optically anisotropic layer O1 exposed by peeling off the cellulose acylate film T1 and the alignment film 1 of the obtained laminate to form a pressure sensitive adhesive layer, and the above-described light absorption anisotropic layer laminate TP2 was bonded thereto such that the pressure sensitive adhesive layer and the light absorption anisotropic layer P2 were closely attached to each other. Thereafter, the cellulose acylate film T1 of the light absorption anisotropic layer laminate TP2 was peeled off. A pressure sensitive adhesive (SK-2057, manufactured by Soken Chemical & Engineering Co., Ltd.) was applied onto the surface of the light absorption anisotropic layer P2 exposed by peeling off the cellulose acylate film T1 of the obtained laminate to form a pressure sensitive adhesive layer, and an optically anisotropic layer laminate TO3 described later was bonded thereto such that the pressure sensitive adhesive layer and the optically anisotropic layer O3 were closely attached to each other. Thereafter, the cellulose acylate film T1 and the alignment film 1 were peeled off from the optically anisotropic layer O3. Furthermore, a pressure sensitive adhesive (SK-2057, manufactured by Soken Chemical & Engineering Co., Ltd.) was applied onto the surface of the optically anisotropic layer O3 exposed by peeling off the cellulose acylate film T1 and the alignment film 1 of the obtained laminate to form a pressure sensitive adhesive layer, the above-described light absorption anisotropic layer laminate TP4 was bonded thereto such that the pressure sensitive adhesive layer and the oxygen shielding layer B1 were closely attached to each other, and then the cellulose acylate film T1 of the optically anisotropic layer laminate TP4 was peeled off to obtain a polarizing plate E5 of Example 5.

The polarizing plate E5 was a laminate in which the light absorption anisotropic layer P1, the cellulose acylate film T1, the pressure sensitive adhesive layer, the optically anisotropic layer O1, the pressure sensitive adhesive layer, the light absorption anisotropic layer P2, the pressure sensitive adhesive layer, the optically anisotropic layer O3, the pressure sensitive adhesive layer, the oxygen shielding layer B1, and the light absorption anisotropic layer P4 were laminated in this order. The polarizing plate E5 is an example of the polarizing plate 6 according to the sixth embodiment. The light absorption anisotropic layer P1 corresponds to the first light absorption anisotropic layer POL1, the optically anisotropic layer O1 corresponds to the first retardation layer R1, the light absorption anisotropic layer P2 corresponds to the second light absorption anisotropic layer POL2, the optically anisotropic layer O3 corresponds to the second retardation layer R2, and the light absorption anisotropic layer P4 corresponds to the third light absorption anisotropic layer POL3 (see Table 2).

At 960 nm of the absorption maximal wavelength (corresponding to the first wavelength 21) of the light absorption anisotropic layer P1, an in-plane retardation Re of the optically anisotropic layer O1 was 244 nm, and an in-plane retardation Re of the light absorption anisotropic layer P2 was 249 nm; and at 850 nm of the absorption maximal wavelength (corresponding to the second wavelength λ2) of the light absorption anisotropic layer P2, an in-plane retardation Re of the optically anisotropic layer O3 was 542 nm, and an in-plane retardation Re of the light absorption anisotropic layer P4 was 540 nm. That is, the retardation ReR1(λ1)=244 nm generated in the light having the first wavelength λ1, which had been transmitted through the first retardation layer R1, was substantially the same as the retardation ReP2(λ1)=249 nm generated in the light having the first wavelength λ1, which had been transmitted through the second light absorption anisotropic layer POL2, and the expression E1 was satisfied. In addition, the retardation ReR2(λ2)=542 nm generated in the light having the second wavelength λ2, which had been transmitted through the second retardation layer R2, was substantially the same as the retardation ReP3(λ2)=540 nm generated in the light having the second wavelength λ2, which had been transmitted through the third light absorption anisotropic layer POL3, and the expression E5 was satisfied.

In addition, in the polarizing plate E5, orientations of the absorption axis of each light absorption anisotropic layer and the slow axis of each optically anisotropic layer were as shown in Table 2.

### {Production of Optically Anisotropic Layer Laminate TO3}

The following alignment film 1 was formed on the cellulose acylate film T1, and an optically anisotropic layer O3 described below was formed on the alignment film 1 to produce an optically anisotropic layer laminate TO3.

### (Formation of Optically Anisotropic Layer O3)

A pressure sensitive adhesive (SK-2057, manufactured by Soken Chemical & Engineering Co., Ltd.) was applied onto a surface of an optically anisotropic layer B in a laminate TB including the optically anisotropic layer B described later to form a pressure sensitive adhesive layer, a laminate TA including an optically anisotropic layer A described later was bonded thereto such that the pressure sensitive adhesive layer and the optically anisotropic layer A were closely attached to each other, and then the cellulose acylate film T1 and the alignment film 1 of the laminate TA were peeled off. A pressure sensitive adhesive (SK-2057, manufactured by Soken Chemical & Engineering Co., Ltd.) was applied onto a surface of the obtained laminate, from which the cellulose acylate film T1 and the alignment film 1 were peeled off, to form a pressure sensitive adhesive layer. Another laminate TA was bonded thereto such that the pressure sensitive adhesive layer and the optically anisotropic layer A were closely attached to each other. In this manner, an optically anisotropic layer O3 in which the optically anisotropic layer B, the optically anisotropic layer A, and the optically anisotropic layer A were laminated was formed. In a case where the respective optically anisotropic layers were bonded, the orientation of the slow axis of the optically anisotropic layer B, the optically anisotropic layer A, and the optically anisotropic layer A was set to 0°.

Thereafter, the cellulose acylate film T1 and the alignment film 1 were peeled off from the finally bonded laminate TA to obtain an optically anisotropic layer laminate TO3 in which the alignment film 1 and the optically anisotropic layer O3 were laminated on the cellulose acylate film T1.

### —Production of Laminate TA Including Optically Anisotropic Layer A—

An optically anisotropic layer A was formed by the same method as that for the optically anisotropic layer O1, except that the coating thickness was changed. In this manner, a laminate TA in which the alignment film 1 and the optically anisotropic layer A were laminated on the cellulose acylate film T1 was obtained. In addition, two laminates TA were prepared. A thickness of the optically anisotropic layer A was 2.0 μm. An in-plane retardation Re and a thickness direction retardation Rth of the obtained optically anisotropic layer A at a wavelength of 550 nm were 238 nm and −119 nm, respectively.

### —Production of Laminate TB Including Optically Anisotropic Layer B—

A composition for forming an optically anisotropic layer B, having the following formulation, was continuously applied onto the rubbing-treated alignment film 1 using a #2.8 wire bar. A transportation speed (V) of the film was 26 m/min. In order to dry the solvent and to mature the alignment of the rod-like liquid crystal compound, the coating film on the alignment film 1 was heated with hot air at 60° C. for 60 seconds, and irradiated with UV rays at 60° C. to fix the alignment of the liquid crystal compound, thereby producing an optically anisotropic layer B. In this manner, a laminate TB in which the alignment film 1 and the optically anisotropic layer B were laminated on the cellulose acylate film T1 was obtained. A thickness of the optically anisotropic layer B was 1.0 μm. It was confirmed that the average tilt angle of the major axis of the rod-like liquid crystal compound with respect to the film surface was 0° and the liquid crystal compound was horizontally aligned with respect to the film surface. In addition, the angle of the slow axis was orthogonal to the rotation axis of the rubbing roller, and in a case where the width direction of the film was indicated by 0° (the longitudinal direction of the film was 90° and a counterclockwise direction was indicated by a positive value with reference to the width direction of the film observed from the optically anisotropic layer B side), the angle of the slow axis was −77.5°. An in-plane retardation Re of the optically anisotropic layer B at a wavelength of 550 nm was 116 nm.

Formulation of composition for forming optically anisotropic layer B

| | |
|---|---|
| Mixture (A) of rod-like liquid crystal compounds | 100 parts by mass |
| Photopolymerization initiator (IRGACURE 907, manufactured by BASF Japan Ltd.) | 6 parts by mass |
| Fluorine-containing compound (F-1) | 0.25 parts by mass |
| Fluorine-containing compound (F-2) | 0.1 parts by mass |
| Ethylene oxide-modified trimethylolpropane triacrylate | 4 parts by mass |
| Methyl ethyl ketone | 337 parts by mass |

Mixture (A) of rod-like liquid crystal compounds 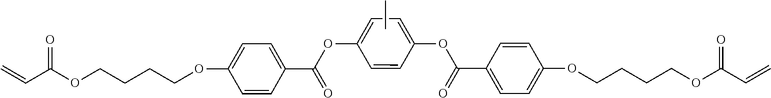
Fluorine-containing compound (F-1) 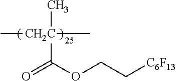 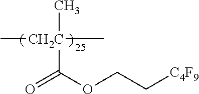 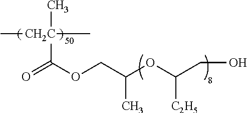
Fluorine-containing compound (F-2)

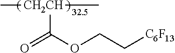

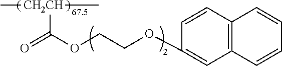

### Examples 6 to 11

According to the production methods of the polarizing plates E1 to E5 of Examples 1 to 5, polarizing plates E6 to E11 having layer configurations shown in Tables 2 to 5 were produced using light absorption anisotropic layer laminates TP5 to TP9 and optically anisotropic layer laminates TO4 to TO7 described later, in addition to the light absorption anisotropic layer laminates TP1 to TP4, the laminate TA, and the optically anisotropic layer laminates TO1 to TO3, which were produced in Examples 1 to 5.

### Example 6

The polarizing plate E6 of Example 6 was a laminate in which the light absorption anisotropic layer P5, the cellulose acylate film T1, the pressure sensitive adhesive layer, the optically anisotropic layer O5, the pressure sensitive adhesive layer, the light absorption anisotropic layer P1, the pressure sensitive adhesive layer, the optically anisotropic layer O4, the pressure sensitive adhesive layer, the oxygen shielding layer B1, and the light absorption anisotropic layer P4 were laminated in this order. The polarizing plate E6 is an example of the polarizing plate 7 according to the seventh embodiment. The light absorption anisotropic layer P5 corresponds to the first light absorption anisotropic layer POL1, the optically anisotropic layer O5 corresponds to the first retardation layer R1, the light absorption anisotropic layer P1 corresponds to the second light absorption anisotropic layer POL2, the optically anisotropic layer O4 corresponds to the second retardation layer R2, and the light absorption anisotropic layer P4 corresponds to the third light absorption anisotropic layer POL3 (see Table 2).

### Example 7

The polarizing plate E7 of Example 7 was a laminate in which the light absorption anisotropic layer P1, the cellulose acylate film T1, the pressure sensitive adhesive layer, the optically anisotropic layer O5, the pressure sensitive adhesive layer, the oxygen shielding layer B1, the light absorption anisotropic layer P7, the pressure sensitive adhesive layer, the optically anisotropic layer A, the pressure sensitive adhesive layer, the oxygen shielding layer B1, and the light absorption anisotropic layer P8 were laminated in this order. The polarizing plate E7 is an example of the polarizing plate 6 according to the sixth embodiment. The light absorption anisotropic layer P1 corresponds to the first light absorption anisotropic layer POL1, the optically anisotropic layer O5 corresponds to the first retardation layer R1, the light absorption anisotropic layer P7 corresponds to the second light absorption anisotropic layer POL2, the optically anisotropic layer A corresponds to the second retardation layer R2, and the light absorption anisotropic layer P8 corresponds to the third light absorption anisotropic layer POL3 (see Table 2).

### Example 8

The polarizing plate E8 of Example 8 was a laminate in which the light absorption anisotropic layer P1, the cellulose acylate film T1, the pressure sensitive adhesive layer, the optically anisotropic layer O1, the pressure sensitive adhesive layer, the light absorption anisotropic layer P2, the pressure sensitive adhesive layer, the optically anisotropic layer O6, the pressure sensitive adhesive layer, and the light absorption anisotropic layer P6 were laminated in this order. The polarizing plate E8 is an example of the polarizing plate 6 according to the sixth embodiment. The light absorption anisotropic layer P1 corresponds to the first light absorption anisotropic layer POL1, the optically anisotropic layer O1 corresponds to the first retardation layer R1, the light absorption anisotropic layer P2 corresponds to the second light absorption anisotropic layer POL2, the optically anisotropic layer O6 corresponds to the second retardation layer R2, and the light absorption anisotropic layer P6 corresponds to the third light absorption anisotropic layer POL3 (see Table 2).

### Example 9

The polarizing plate E9 of Example 9 was a laminate in which the light absorption anisotropic layer P1, the cellulose acylate film T1, the pressure sensitive adhesive layer, the optically anisotropic layer O7, the pressure sensitive adhesive layer, the oxygen shielding layer B1, and the light absorption anisotropic layer P4 were laminated in this order. The polarizing plate E9 had a structure similar to that of the polarizing plate 2 according to the second embodiment. The light absorption anisotropic layer P1 corresponds to the first light absorption anisotropic layer POL1, the optically anisotropic layer O7 corresponds to the first retardation layer R1, and the light absorption anisotropic layer P4 corresponds to the second light absorption anisotropic layer POL2 (see Table 2). However, as shown in Table 2, the in-plane retardation ReR1(λ1) of the first retardation layer R1 and the in-plane retardation ReP2(λ1) of the second light absorption anisotropic layer POL2 at the first wavelength λ1 (here, 960 nm) of the first light absorption anisotropic layer POL1 did not satisfy the expression E1.

### Example 10

The polarizing plate E10 of Example 10 was a laminate in which the light absorption anisotropic layer P6, the cellulose acylate film T1, the pressure sensitive adhesive layer, the light absorption anisotropic layer P1, the pressure sensitive adhesive layer, the optically anisotropic layer O4, the pressure sensitive adhesive layer, the oxygen shielding layer B1, and the light absorption anisotropic layer P4 were laminated in this order. The polarizing plate E10 is an example of the polarizing plate 5 according to the fifth embodiment. The light absorption anisotropic layer P6 corresponds to the third light absorption anisotropic layer POL3, the light absorption anisotropic layer P1 corresponds to the first light absorption anisotropic layer POL1, the optically anisotropic layer O4 corresponds to the first retardation layer R1, and the light absorption anisotropic layer P4 corresponds to the second light absorption anisotropic layer POL2 (see Table 3).

### Example 11

The polarizing plate E11 of Example 11 was a laminate in which the light absorption anisotropic layer P9, the cellulose acylate film T1, the pressure sensitive adhesive layer, the light absorption anisotropic layer P1, the pressure sensitive adhesive layer, the oxygen shielding layer B1, and the light absorption anisotropic layer P4 were laminated in this order. The polarizing plate E11 is an example of the polarizing plate 4 according to the fourth embodiment. The light absorption anisotropic layer P9 corresponds to the third light absorption anisotropic layer POL3, the light absorption anisotropic layer P1 corresponds to the first light absorption anisotropic layer POL1, and the light absorption anisotropic layer P4 corresponds to the second light absorption anisotropic layer POL2. The absorption maximal wavelength of the light absorption anisotropic layer P9 corresponds to the third wavelength λ3, the absorption maximal wavelength of the light absorption anisotropic layer P1 corresponds to the first wavelength λ1, and the absorption maximal wavelength of the light absorption anisotropic layer P4 corresponds to the second wavelength λ2 (see Table 4).

### {Production of Light Absorption Anisotropic Layer Laminate TP5}

A light absorption anisotropic layer laminate TP5 in which a light absorption anisotropic layer P5 was laminated on the cellulose acylate film T1 was produced in the same manner as in the production of the light absorption anisotropic layer laminate TP1, except that the light absorption anisotropic layer P1 was changed to the light absorption anisotropic layer P5 described later.

### (Formation of Light Absorption Anisotropic Layer P5)

A light absorption anisotropic layer P5 was formed on one surface of the cellulose acylate film T1 by the same method as that for the light absorption anisotropic layer P1, except that the dichroic coloring agent II-2 was changed to the above-described dichroic coloring agent II-3. An absorption maximal wavelength of the light absorption anisotropic layer P5 was 1,050 nm.

### {Production of Light Absorption Anisotropic Layer Laminate TP6}

A light absorption anisotropic layer laminate TP6 in which a light absorption anisotropic layer P6 was laminated on the cellulose acylate film T1 was produced in the same manner as in the production of the light absorption anisotropic layer laminate TP1, except that the light absorption anisotropic layer P1 was changed to the light absorption anisotropic layer P6 described later.

### (Formation of Light Absorption Anisotropic Layer P6)

A light absorption anisotropic layer P6 was formed by the same method as that for the light absorption anisotropic layer P1, except that the dichroic coloring agent II-2 was changed to the above-described dichroic coloring agent II-4. An absorption maximal wavelength of the light absorption anisotropic layer P6 was 1,160 nm.

### {Production of Light Absorption Anisotropic Layer Laminate TP7}

A light absorption anisotropic layer laminate TP7 in which the cellulose acylate film T2, the photo-alignment film PA1, the light absorption anisotropic layer P7, and the oxygen shielding layer B1 were laminated was produced in the same manner as in the production of the light absorption anisotropic layer laminate TP4, except that the light absorption anisotropic layer P4 was changed to the light absorption anisotropic layer P7 described below.

### (Formation of Light Absorption Anisotropic Layer P7)

A light absorption anisotropic layer P7 was formed by the same method as that for the light absorption anisotropic layer P1, except that the dichroic coloring agent II-2 was changed to the above-described dichroic coloring agent Y-1. An absorption maximal wavelength of the light absorption anisotropic layer P7 was 417 nm.

### {Production of Light Absorption Anisotropic Layer Laminate TP8}

A light absorption anisotropic layer laminate TP8 in which the cellulose acylate film T2, the photo-alignment film PA1, the light absorption anisotropic layer P8, and the oxygen shielding layer B1 were laminated was produced in the same manner as in the production of the light absorption anisotropic layer laminate TP4, except that the light absorption anisotropic layer P4 was changed to the light absorption anisotropic layer P8 described below.

### (Formation of Light Absorption Anisotropic Layer P8)

A light absorption anisotropic layer P8 was formed by the same method as that for the light absorption anisotropic layer P1, except that the dichroic coloring agent II-2 was changed to the above-described dichroic coloring agent C-1. An absorption maximal wavelength of the light absorption anisotropic layer P8 was 570 nm.

### {Production of Light Absorption Anisotropic Layer Laminate TP9}

A light absorption anisotropic layer laminate TP9 was produced in the same manner as in the production of the light absorption anisotropic layer laminate TP1, except that the light absorption anisotropic layer P1 was changed a light absorption anisotropic layer P9 described below.

### (Formation of Light Absorption Anisotropic Layer P9)

A light absorption anisotropic layer P9 was formed by the same method as that for the light absorption anisotropic layer P1, except that the dichroic coloring agent II-2 was changed to the above-described dichroic coloring agent II-5. An absorption maximal wavelength of the light absorption anisotropic layer P9 was 740 nm.

### {Production of Optically Anisotropic Layer Laminate TO4}

The alignment film 1 was formed on the cellulose acylate film T1 by the above-described procedure, and an optically anisotropic layer O4 was formed on the alignment film 1 to obtain an optically anisotropic layer laminate TO4.

### (Formation of Optically Anisotropic Layer O4)

A pressure sensitive adhesive (SK-2057, manufactured by Soken Chemical & Engineering Co., Ltd.) was applied onto a surface of the optically anisotropic layer O1 in the optically anisotropic layer laminate TO1 described above to form a pressure sensitive adhesive layer, the above-described laminate TA was bonded thereto such that the pressure sensitive adhesive layer and the optically anisotropic layer A were closely attached to each other, and then the cellulose acylate film T1 and the alignment film 1 of the laminate TA were peeled off, thereby obtaining an optically anisotropic layer O4. The orientations of the slow axes of the optically anisotropic layer O4 and the optically anisotropic layer A were set to be parallel to each other. An in-plane retardation Re of the obtained optically anisotropic layer O4 at a wavelength of 850 nm was 462 nm.

### {Production of Optically Anisotropic Layer Laminate TO5}

The alignment film 1 was formed on the cellulose acylate film T1 by the above-described procedure, and an optically anisotropic layer O5 was formed on the alignment film 1 to obtain an optically anisotropic layer laminate TO5.

### (Formation of Optically Anisotropic Layer O5)

A pressure sensitive adhesive (SK-2057, manufactured by Soken Chemical & Engineering Co., Ltd.) was applied onto the surface of the optically anisotropic layer A of the laminate TA described above to form a pressure sensitive adhesive layer, and the other laminate TA was bonded thereto such that the pressure sensitive adhesive layer and the optically anisotropic layer A were closely attached to each other. As a result, an optically anisotropic layer O5 in which two optically anisotropic layers A were laminated with the pressure sensitive adhesive layer interposed therebetween was formed. Thereafter, the cellulose acylate film T1 and the alignment film 1 were peeled off to obtain an optically anisotropic layer laminate TO5. The orientations of the slow axes of the optically anisotropic layer A were set to be parallel to each other. Re of the obtained optically anisotropic layer O5 at a wavelength of 960 nm was 435 nm.

### {Production of Optically Anisotropic Layer Laminate TO6}

The alignment film 1 was formed on the cellulose acylate film T1 by the above-described procedure, and an optically anisotropic layer O6 described below was formed on the alignment film 1 to produce an optically anisotropic layer laminate TO6.

### (Formation of Optically Anisotropic Layer O6)

An optically anisotropic layer O6 was formed on the alignment film 1 formed on the cellulose acylate film T1 by the same method as that for the optically anisotropic layer B, except that the coating thickness was changed. Re of the obtained optically anisotropic layer O6 at a wavelength of 850 nm was 150 nm.

In this manner, an optically anisotropic layer laminate TO6 in which the alignment film 1 and the optically anisotropic layer O6 were laminated in this order on the cellulose acylate film T1 was obtained.

### {Production of Optically Anisotropic Layer Laminate TO7}

The alignment film 1 was formed on the cellulose acylate film T1 by the above-described procedure, and an optically anisotropic layer O7 described below was formed on the alignment film 1 to produce an optically anisotropic layer laminate TO7.

### (Formation of Optically Anisotropic Layer O7)

A pressure sensitive adhesive (SK-2057, manufactured by Soken Chemical & Engineering Co., Ltd.) was applied to a surface of an optically anisotropic layer O1 in the optically anisotropic layer laminate TO1 described above to form a pressure sensitive adhesive layer, and the above-described laminate TB including the optically anisotropic layer B was bonded thereto such that the pressure sensitive adhesive layer and the optically anisotropic layer B were closely attached to each other. As a result, an optically anisotropic layer O7 obtained by laminating the optically anisotropic layer O1 and the optically anisotropic layer B was formed. In a case where the optically anisotropic layer B was bonded, the slow axis of the optically anisotropic layer O1 and the slow axis of the optically anisotropic layer B were set to be parallel to each other. Re of the obtained optically anisotropic layer O7 at a wavelength of 960 nm was 347 nm.

Thereafter, the cellulose acylate film T1 and the alignment film 1 were peeled off to obtain an optically anisotropic layer laminate TO7 in which the alignment film 1 and the optically anisotropic layer O7 were laminated on the cellulose acylate film T1.

### Example 12

### “Production of Polarizing Plate E12”

A pressure sensitive adhesive (SK-2057, manufactured by Soken Chemical & Engineering Co., Ltd.) was applied onto one surface of a wavelength selective polarization conversion element (ColorSelect-BY: BY Filter manufactured by ColorLink Japan, Ltd.) to form a pressure sensitive adhesive layer, the above-described light absorption anisotropic layer laminate TP4 was bonded thereto such that the pressure sensitive adhesive layer and the oxygen shielding layer B1 were closely attached to each other, and then the cellulose acylate film T2 and the photo-alignment film PA1 were peeled off. Next, a pressure sensitive adhesive (SK-2057, manufactured by Soken Chemical & Engineering Co., Ltd.) was applied onto the other surface of the above-described wavelength selective polarization conversion element to form a pressure sensitive adhesive layer, an optically anisotropic layer laminate TO8 described later was bonded thereto such that the pressure sensitive adhesive layer and the optically anisotropic layer O8 were closely attached to each other, and then the cellulose acylate film T1 and the alignment film 1 of the optically anisotropic layer laminate TO8 were peeled off. Furthermore, a pressure sensitive adhesive (SK-2057, manufactured by Soken Chemical & Engineering Co., Ltd.) was applied onto an exposed surface of the optically anisotropic layer O8 in the obtained laminate, from which the cellulose acylate film T1 and the alignment film 1 were peeled off, to form a pressure sensitive adhesive layer. Thereafter, the above-described light absorption anisotropic layer laminate TP1 was bonded thereto such that the pressure sensitive adhesive layer and the light absorption anisotropic layer P1 were closely attached to each other, and then the cellulose acylate film of the light absorption anisotropic layer laminate TP1 was peeled off to obtain a polarizing plate E12 of Example 12. The absorption axis of each of the light absorption anisotropic layers and the slow axis of each of the optically anisotropic layers were as shown in Table 5.

The polarizing plate E12 was a laminate in which the light absorption anisotropic layer P4, the oxygen shielding layer B1, the pressure sensitive adhesive layer, the wavelength selective polarization conversion element, the pressure sensitive adhesive layer, the optically anisotropic layer O8, the pressure sensitive adhesive layer, and the light absorption anisotropic layer P1 were laminated in this order. The polarizing plate E12 is an example of the polarizing plate 8 according to the eighth embodiment, and the light absorption anisotropic layer P4 corresponds to the first light absorption anisotropic layer POL1, the wavelength selective polarization conversion element corresponds to the third retardation layer R3, the optically anisotropic layer O8 corresponds to the fourth retardation layer R4, and the light absorption anisotropic layer P1 corresponds to the second light absorption anisotropic layer POL2, respectively. The light absorption anisotropic layer P4 exhibited light absorption anisotropy over the entire visible light range. In this case, in the light absorption anisotropic layer P4, any wavelength in the visible light range could be set as the first wavelength λ1 and the fourth wavelength λ4. In the present example, the fourth wavelength λ4 was set to 550 nm.

### {Production of Optically Anisotropic Layer Laminate TO8}

The alignment film 1 was formed on the cellulose acylate film T1, and an optically anisotropic layer O8 was formed on the alignment film 1 to produce an optically anisotropic layer laminate TO8.

### (Formation of Optically Anisotropic Layer O8)

An optically anisotropic layer O8 was formed on the alignment film 1 formed on the cellulose acylate film T1 by the same formulation and method as that for the optically anisotropic layer B, except that the coating thickness was changed. An in-plane retardation ReR4 (550) of the obtained optically anisotropic layer O8 at a wavelength of 550 nm was 200 nm.

### COMPARATIVE EXAMPLE

### “Production of Polarizing Plate C1”

In the production of the polarizing plate E1 of Example 1, in a case where the light absorption anisotropic layer P2 was bonded to the pressure sensitive adhesive layer formed on the surface of the light absorption anisotropic layer P1, the angle formed by the absorption axis of the light absorption anisotropic layer P1 and the absorption axis of the light absorption anisotropic layer P2 was set to 0°. A polarizing plate C1 of Comparative Example 1 was produced by the same method as in Example 1, except for the above.

Table 1 collectively shows the dichroic coloring agents contained in each of the light absorption anisotropic layers P1 to P9 and the absorption maximal wavelengths thereof.

TABLE 1

| Light | | |
|---|---|---|
| absorption | Dichroic | Absorption |
| anisotropic | coloring | maximal |
| layer | agent | wavelength |
| P1 | II-2 | 960 nm |
| P2 | II-1 | 850 nm |
| P3 | II-2 | 960 nm |
| P4 | C-1 | 570 nm |
| | M-1 | 466 nm |
| | Y-1 | 417 nm |
| P5 | II-3 | 1050 nm |
| P6 | II-4 | 1160 nm |
| P7 | Y-1 | 417 nm |
| P8 | C-1 | 570 nm |
| P9 | II-5 | 740 nm |

As described above, the light absorption anisotropic layer P4 contained three dichroic coloring agents. In Table 1, the absorption maximal wavelengths of the three dichroic coloring agents are shown as the absorption maximal wavelength. The light absorption anisotropic layer P4 exhibited an absorption spectrum in which absorption spectra of the three dichroic coloring agents were added, and exhibited a high absorbance substantially uniform over a visible range of 400 nm to 700 nm. Therefore, for the light absorption anisotropic layer P4, any wavelength desired to be extracted as linearly polarized light in a specific polarization direction could be set as the absorption maximal wavelength from the wavelength range of 400 nm to 700 nm, which is the absorption wavelength.

Table 2 collectively shows the configurations of the polarizing plates of Examples 1 to 9 and Comparative Example 1. In Table 2, the first light absorption anisotropic layer (the first light absorption anisotropic layer POL1), the first retardation layer (the first retardation layer R1), the second light absorption anisotropic layer (the second light absorption anisotropic layer POL2), the second retardation layer (the second retardation layer R2), and the third light absorption anisotropic layer (third light absorption anisotropic layer POL3) are described in this order from the light incident side. In Table 2, only layers which affect the polarization are described, and the pressure sensitive adhesive layer, the oxygen shielding layer B1, and the like are omitted. The same applies to Tables 3 to 5.

TABLE 2

| | | First light absorption | | | | | Second light absorption | | |
|---|---|---|---|---|---|---|---|---|---|
| | | anisotropic layer POL 1 | | | | | anisotropic layer POL 2 | | |
| | | Light | | First retardation layer R1 | | | Light | | |
| | | absorption | | Optically | | | absorption | | |
| | Polarizing | anisotropic | Absorption | anisotropic | | Slow | anisotropic | Absorption | |
| | plate | layer | axis | layer | ReR1(λ1) | axis | layer | axis | ReP2(λ1) |
| Example 1 | E1 | P1 | 0° | None | — | — | P2 | 90° | — |
| Example 2 | E2 | P3 | 0° | None | — | — | P2 | 90° | — |
| Example 3 | E3 | P1 | 0° | O1 | 244 nm | 150° | P2 | 60° | 249 nm |
| Example 4 | E4 | P1 | 0° | O2 | 489 nm | 150° | P4 | 60° | 482 nm |
| Example 5 | E5 | P1 | 0° | O1 | 244 nm | 135° | P2 | 45° | 249 nm |
| Example 6 | E6 | P5 | 0° | O5 | 426 nm | 150° | P1 | 60° | 409 nm |
| Example 7 | E7 | P1 | 0° | O5 | 435 nm | 135° | P7 | 45° | 428 nm |
| Example 8 | E8 | P1 | 0° | O1 | 244 nm | 135° | P2 | 45° | 249 nm |
| Example 9 | E9 | P1 | 0° | O7 | 347 nm | 150° | P4 | 60° | 482 nm |
| Comparative | C1 | P1 | 0° | None | — | — | P2 | 0° | |
| Example | | | | | | | | | |

| | | | | | Third light absorption | | | | |
|---|---|---|---|---|---|---|---|---|---|
| | | Second retardation | | | anisotropic layer POL3 | | | | |
| | | layer R2 | | | Light | | | | |
| | | Optically | | | absorption | | | Retardation ratio | |
| | Polarizing | anisotropic | | Slow | anisotropic | Absorption | | ReP2(λ1)/ | ReP3(λ2)/ |
| | plate | layer | ReR2(λ2) | axis | layer | axis | ReP3(λ2) | ReR1(λ1) | ReR2(λ2) |
| Example 1 | E1 | None | — | — | None | — | — | — | — |
| Example 2 | E2 | None | — | — | None | — | — | — | — |
| Example 3 | E3 | None | — | — | None | — | — | 1.02 | — |
| Example 4 | E4 | None | — | — | None | — | — | 0.99 | — |
| Example 5 | E5 | O3 | 542 nm | 0° | P4 | 90° | 540 nm | 1.02 | 1.00 |
| Example 6 | E6 | O4 | 462 nm | 30° | P4 | 120° | 482 nm | 0.96 | 1.04 |
| Example 7 | E7 | A | 268 nm | 0° | P8 | 90° | 283 nm | 0.98 | 1.06 |
| Example 8 | E8 | O6 | 150 nm | 0° | P6 | 90° | 145 nm | 1.02 | 0.97 |
| Example 9 | E9 | None | — | — | None | — | — | 1.39 | — |
| Comparative | C1 | None | — | — | None | — | — | — | — |
| Example | | | | | | | | | |

The configuration of the polarizing plate of Example 10 is shown in Table 3.

TABLE 3

| | | Third light absorption | | First light absorption anisotropic | | | |
|---|---|---|---|---|---|---|---|
| | | anisotropic layer POL3 | | layer POL1 | | | |
| | | Light | | Light | | | First retardation layer R1 |
| | | absorption | | absorption | | | Optically |
| | Polarizing | anisotropic | Absorption | anisotropic | Absorption | | anisotropic |
| | plate | layer | axis | layer | axis | ReP1(λ1) | layer |
| Example | E10 | P6 | 0° | P1 | 90° | — | 04 |
| 10 | | | | | | | |

| | | | | Second light absorption | | | |
|---|---|---|---|---|---|---|---|
| | | | | anisotropic layer POL2 | | | |
| | | | | Light | | | Retardation |
| | | First retardation layer R1 | | absorption | | | ratio |
| | Polarizing | | Slow | anisotropic | Absorption | | ReP1(λ1)/ |
| | plate | ReR1(λ1) | axis | layer | axis | ReP2(λ1) | ReP2(λ1) |
| Example | E10 | 462 nm | 135 | P4 | 45° | 482 nm | 1.04 |
| 10 | | | | | | | |

The configuration of the polarizing plate of Example 11 is shown in Table 4.

TABLE 4

| | | Third light absorption | | First light absorption | | Second light absorption | | | |
|---|---|---|---|---|---|---|---|---|---|
| | | anisotropic layer POL3 | | anisotropic layer POL1 | | anisotropic layer POL2 | | | |
| | | Light | | Light | | Light | | | |
| | | absorption | | absorption | | absorption | | | |
| | Polarizing | anisotropic | Absorption | anisotropic | Absorption | anisotropic | Absorption | | |
| | plate | layer | axis | layer | axis | layer | axis | Re(λ3)/λ3 | Re(λ1)/λ1 |
| Example 11 | E11 | P9 | 0° | P1 | 0° | P4 | 45° | 1.0 | 0.5 |

The configuration of the polarizing plate of Example 12 is shown in Table 5.

TABLE 5

| | | | | Third retardation | | | | | | | | |
|---|---|---|---|---|---|---|---|---|---|---|---|---|
| | | First light absorption | | layer R3 | | | | | Second light absorption | | | |
| | | anisotropic layer POL1 | | Wavelength | | Fourth retardation | | | anisotropic layer POL2 | | | |
| | | Light | | selective | | layer R4 | | | Light | | | Retardation |
| | | absorption | Absorp- | polarization | | Optically | | | absorption | Absorp- | | ratio |
| | Polarizing | anisotropic | tion | conversion | Slow | anisotropic | ReR4 | Slow | anisotropic | tion | ReP2 | ReR4(550)/ |
| | plate | layer | axis | element | axis | layer | (550) | axis | layer | axis | (550) | ReP2(550) |
| Example | E12 | P4 | 0° | BY Filter | 22.5° | O8 | 200 nm | 0° | P1 | 90° | 198 nm | 1.0 |
| 12 | | | | | | | | | | | | |

The in-plane retardation of the light absorption anisotropic layer and the optically anisotropic layer described above was obtained by measuring and analyzing a wavelength range of 246 to 1698 nm using spectral ellipsometry (manufactured by J. A. Woollam Co., Inc.).

### <Evaluation>

The polarizing plates of Examples and Comparative Example were evaluated as follows.

### [Optical Properties]

The transmittance (single transmittance) of each of the polarizing plates E1 to E12 and C1 with respect to unpolarized light was measured with an ultraviolet-visible-near infrared spectrophotometer UV-3600 (manufactured by Shimadzu Corporation). The measured transmittances were averaged in a wavelength range of 400 to 700 nm, and transmitting property with respect to visible light (visible light-transmitting property) was evaluated according to the following standard.

A: average of transmittances at a wavelength of 400 to 700 nm was 50% or more.

B: average of transmittances at a wavelength of 400 to 700 nm was less than 50%.

The polarizing plate including any of the light absorption anisotropic layers P4, P7, and P8, having an absorption maximal wavelength in the visible range, was evaluated as B, whereas the polarizing plate including only the light absorption anisotropic layer having an absorption maximal wavelength in the near-infrared range was evaluated as A. In this way, by measuring the average of the single transmittances in the visible range of a wavelength of 400 nm to 700 nm, it was possible to confirm that the absorption maximal wavelength of the light absorption anisotropic layer provided in the polarizing plate was not in the visible light range.

### [Discriminability]

Discriminability of the polarizing plate of each of Examples and Comparative Example was evaluated. An evaluation method for the polarizing plate E1 of Example 1 will be described as an example with reference to FIG. 17.

A solution obtained by dissolving 0.05 parts by mass of an absorptive coloring agent FDN-007 (Yamada Chemical Co., Ltd.) having an absorption maximal wavelength of 956 nm in 95.5 parts by mass of toluene and a solution obtained by dissolving 0.05 parts by mass of an absorptive coloring agent FDN-003 (Yamada Chemical Co., Ltd.) having an absorption maximal wavelength of 853 nm in 95.5 parts by mass of toluene were each cast on one glass 70 so as not to overlap each other, and naturally dried to obtain evaluation images G1 and G2. The glass 70 on which the evaluation images G1 and G2 were formed, the polarizing plate E1, and a commercially available wire grid polarizing plate (MLP-WG) 72 were stacked in this order, and the evaluation images G1 and G2 were observed with a CMOS camera 76 from the wire grid polarizing plate 72 side. The evaluation image G1 absorbed the first wavelength λ1 of the polarizing plate E1, and the evaluation image G2 absorbed the second wavelength λ2.

The wire grid polarizing plate 72 was rotated to change an angle formed by an absorption axis of the wire grid polarizing plate 72 and the absorption axis of the first light absorption anisotropic layer in the polarizing plate E1, disposed closest to the light incident side. In this case, the angle between the two absorption axes in a case where the evaluation images G1 and G2 were most visually recognized was investigated. The results are shown in Table 6 as “Best viewed angle”.

In the case of the polarizing plate E1 of Example 1, in a case where the wire grid polarizing plate 72 was rotated, the evaluation image G1 was well visible as the angle with the absorption axis of the wire grid polarizing plate 72 was 0°, and the evaluation image G2 was well visible as the angle with the absorption axis was 90°. Here, the angle with the absorption axis of the wire grid polarizing plate 72 was an angle between the absorption axis of the wire grid polarizing plate 72 and the absorption axis of the first light absorption anisotropic layer in the polarizing plate E1. The evaluation image G1 and the evaluation image G2 could be distinguished from each other based on a change in intensity of light, which was visually recognized in a case where the wire grid polarizing plate 72 was rotated. The evaluation image G1 was an image in which the light having the first wavelength λ1 of the polarizing plate E1 was absorbed, and the evaluation image G2 was an image in which the light having the second wavelength λ2 of the polarizing plate E1 was absorbed. In a case where the wire grid polarizing plate 72 was rotated, the angles at which the evaluation image G1 and the evaluation image G2 were most visible were different from each other; and in a case where the evaluation images G1 and G2 could be distinguished from each other, it means that the polarizing plate E1 transmitted the light having the first wavelength λ1 and the light having the second wavelength 22, as linearly polarized lights having different polarization directions.

Discriminability of the polarizing plate of each of Examples and Comparative Example was evaluated by the same method. Evaluation images G1, G2, and G3 corresponding to the first wavelength λ1, the second wavelength λ2, and the third wavelength λ3 in each polarizing plate were produced and evaluated. The absorptive coloring agents used in the evaluation images G1, G2, and G3 in each of Examples and Comparative Example were as shown in Table 6 below. In addition, as the absorptive coloring agent, an absorptive coloring agent (FDB series) of 400 to 500 nm, an absorptive coloring agent (FDG series) of 500 to 750 nm, and an absorptive coloring agent (FDN series) of 750 to 1,000 nm of Yamada Chemical Co., Ltd. were used, and as the solvent, toluene or methyl ethyl ketone was used in a case where the absorptive coloring agent was not dissolved in toluene.

The discriminability was evaluated by sensory evaluation according to the following standard. A: evaluation images could be clearly distinguished from the change in intensity of light due to the rotation of the polarizing plate.

B: evaluation images could be generally distinguished from the change in intensity of light due to the rotation of the polarizing plate.

C: evaluation images could be slightly distinguished from the change in intensity of light due to the rotation of the polarizing plate.

D: evaluation images could not be slightly distinguished from the change in intensity of light due to the rotation of the polarizing plate.

Table 6 collectively shows the evaluation images, the evaluation results of the discriminability, and the evaluation results of the visible light-transmitting property.

TABLE 6

| | | Evaluation image G1 | | Evaluation image G2 | | Evaluation image G3 | | | | | | |
|---|---|---|---|---|---|---|---|---|---|---|---|---|
| | | | Absorption | | Absorption | | Absorption | | | | | Visible light- |
| | Polarizing | Coloring | maximal | Coloring | maximal | Coloring | maximal | Best viewed angle | | | Discrimi- | transmitting |
| | plate | agent | wavelength | agent | wavelength | agent | wavelength | G1 | G2 | G3 | nability | property |
| Example 1 | E1 | FDN-007 | 956 nm | FDN-003 | 853 nm | — | — | 0° | 90° | — | A | A |
| Example 2 | E2 | FDN-007 | 956 nm | FDN-003 | 853 nm | — | — | 0° | 90° | — | A | A |
| Example 3 | E3 | FDN-007 | 956 nm | FDN-003 | 853 nm | — | — | 0° | 60° | — | A | A |
| Example 4 | E4 | FDN-007 | 956 nm | FDG-004 | 576 nm | — | — | 0° | 60° | — | A | B |
| Example 5 | E5 | FDN-007 | 956 nm | FDN-003 | 853 nm | FDG-004 | 576 nm | 0° | 45° | 90° | A | B |
| Example 6 | E6 | FDN-007 | 956 nm | FDN-003 | 853 nm | FDG-004 | 576 nm | 0° | 60° | 120° | B | B |
| Example 7 | E7 | FDN-010 | 1014 nm | FDN-007 | 956 nm | FDG-004 | 576 nm | 0° | 90° | 45° | B | B |
| Example 8 | E8 | FDN-007 | 956 nm | FDB-004 | 445 nm | FDG-004 | 576 nm | 0° | 45° | 90° | A | B |
| Example 9 | E9 | FDN-007 | 956 nm | FDN-003 | 853 nm | FDN-010 | 1014 nm | 0° | 45° | 90° | A | A |
| Example 10 | E10 | FDN-007 | 956 nm | FDG-004 | 576 nm | — | — | 0° | 60° | — | C | B |
| Example 11 | E11 | FDN-001 | 754 nm | FDN-007 | 956 nm | FDG-004 | 576 nm | 0° | 90° | 45° | A | B |
| Example 12 | E12 | FDG-004 | 576 nm | FDB-004 | 445 nm | FDN-007 | 956 nm | 0° | 45° | 90° | A | B |
| Comparative | C1 | FDN-007 | 956 nm | FDN-003 | 853 nm | — | — | 0° | 0° | — | D | A |
| Example | | | | | | | | | | | | |

As shown in Table 6, the polarizing plates E1 to E12 of Examples of the present disclosure exhibited excellent discriminability. On the other hand, in the polarizing plate C1 of Comparative Example, a desired effect was not obtained.

The following appendixes are further disclosed with respect to the above embodiments.

### (Appendix 1)

A polarizing plate including:
a first light absorption anisotropic layer containing a first dichroic coloring agent, which has a first light absorption property in which an absorbance is maximal at a first wavelength, and has a first absorption axis exhibiting the first light absorption property along one direction; and
a second light absorption anisotropic layer containing a second dichroic coloring agent, which has a second light absorption property in which an absorbance is maximal at a second wavelength different from the first wavelength, and has a second absorption axis exhibiting the second light absorption property along one direction,
in which the first light absorption anisotropic layer and the second light absorption anisotropic layer are laminated in an aspect in which the first absorption axis and the second absorption axis intersect with each other.

### (Appendix 2)

The polarizing plate according to the appendix 1,
in which at least one of the first wavelength or the second wavelength is in a range of 700 nm or more and 1500 nm or less.

### (Appendix 3)

The polarizing plate according to the appendix 1 or 2,
in which both of the first wavelength or the second wavelength are in a range of 700 nm or more and 1500 nm or less.

### (Appendix 4)

The polarizing plate according to any one of the appendices 1 to 3,
in which an absolute value of a difference between the first wavelength at which a maximal value is exhibited in a first absorption spectrum of the first light absorption anisotropic layer and the second wavelength at which a maximal value is exhibited in a second absorption spectrum of the second light absorption anisotropic layer is larger than an average value of a half width at half maximum of the first absorption spectrum and a half width at half maximum of the second absorption spectrum.

### (Appendix 5)

The polarizing plate according to any one of the appendices 1 to 4,
in which an average of single transmittances in a wavelength range of 400 nm or more and less than 700 nm is 50% or more.

### (Appendix 6)

The polarizing plate according to any one of the appendices 1 to 5,
in which the first absorption axis and the second absorption axis are orthogonal to each other, and no retardation layer which provides a retardation in transmitted light is provided between the first light absorption anisotropic layer and the second light absorption anisotropic layer.

### (Appendix 7)

The polarizing plate according to any one of the appendices 1 to 5,
in which the first absorption axis and the second absorption axis are not orthogonal to each other,
the polarizing plate includes, between the first light absorption anisotropic layer and the second light absorption anisotropic layer, a first retardation layer that is a retardation layer which provides a retardation in transmitted light, in which in a case where the first wavelength is denoted by λ1, a retardation generated in light having the first wavelength λ1, which has been transmitted through the second light absorption anisotropic layer, is denoted by ReP2(λ1), and a retardation generated in light having the first wavelength λ1, which has been transmitted through the retardation layer, is denoted by ReR1(λ1), the following expression E1 is satisfied, and
the first retardation layer is disposed in an aspect in which a first slow axis which is a slow axis of the first retardation layer is orthogonal to the second absorption axis,

$$ReP 2 ( λ 1 ) / ReR 1 ( λ1 ) = 1 \pm 0.2 . \qquad expression E 1$$

### (Appendix 8)

The polarizing plate according to any one of the appendices 1 to 5,
in which the first absorption axis and the second absorption axis are not orthogonal to each other, and
in a case where the first wavelength is denoted by λ1 and a retardation generated in light having the first wavelength λ1, which has been transmitted through the second light absorption anisotropic layer, is denoted by ReP2(λ1), the following expression E2-1 or E2-2 is satisfied,

$$ReP 2 ( λ 1 ) / λ 1 = 1 \pm 0.2 , \qquad expression E 2 - 1$$

$$ReP 2 ( λ 1 ) / λ 1 = 0.5 \pm 0.1 . \qquad expression E 2 - 2$$

### (Appendix 9)

The polarizing plate according to any one of the appendices 1 to 8, further comprising:
a third light absorption anisotropic layer containing a third dichroic coloring agent, which has a third light absorption property in which an absorbance is maximal at a third wavelength different from the first wavelength and the second wavelength, and has a third absorption axis exhibiting the first light absorption property along one direction,
in which the third light absorption anisotropic layer is disposed in an aspect in which the third absorption axis intersects with at least one of the first absorption axis or the second absorption axis.

### (Appendix 10)

The polarizing plate according to the appendix 9 based on the appendix 7,
in which the third light absorption anisotropic layer, the first light absorption anisotropic layer, and the second light absorption anisotropic layer are laminated in this order from an incident direction of light,
the first absorption axis and the third absorption axis are parallel to each other, and
in a case where the third wavelength is denoted by λ3 and a retardation generated in light having the third wavelength λ3, which has been transmitted through the second light absorption anisotropic layer, is denoted by ReP2(λ3), two expressions of the expression E2-1 and the following expression E3-1 are satisfied, or two expressions of the expression E2-2 and the following expression E3-2 are satisfied,

$$ReP 2 ( λ 3 ) / λ 3 = 0.5 \pm 0.1 , \qquad expression E 3 - 1$$

$$ReP 2 ( λ 3 ) / λ 3 = 1 \pm 0.2 . \qquad expression E3 - 2$$

### (Appendix 11)

The polarizing plate according to the appendix 9 based on the appendix 7,
in which the third light absorption anisotropic layer, the first light absorption anisotropic layer, the first retardation layer, and the second light absorption anisotropic layer are laminated in this order from an incident direction of light,
the first absorption axis and the third absorption axis are orthogonal to each other, and
in a case where the third wavelength is denoted by λ3, a retardation generated in light having the third wavelength λ3, which has been transmitted through the second light absorption anisotropic layer, is denoted by ReP2(λ3), and a retardation generated in light having the third wavelength λ3, which has been transmitted through the first retardation layer, is denoted by ReR1(λ3), the following expression E4 is satisfied,

$$ReP 2 ( λ 3 ) / ReR 1 ( λ3 ) = 1 \pm 0.2 . \qquad expression E 4$$

### (Appendix 12)

The polarizing plate according to the appendix 9 based on the appendix 7,
in which the first light absorption anisotropic layer, the first retardation layer, the second light absorption anisotropic layer, and the third light absorption anisotropic layer are laminated in this order from an incident direction of light,
the third light absorption anisotropic layer is disposed in an aspect in which the third absorption axis intersects with the first absorption axis and the second absorption axis,
the polarizing plate further includes, between the second light absorption anisotropic layer and the third light absorption anisotropic layer, a second retardation layer which provides a retardation in transmitted light,
in a case where a retardation generated in light having a second wavelength λ2, which has been transmitted through the third light absorption anisotropic layer, is denoted by ReP3(λ2), and a retardation generated in light having the second wavelength λ2, which has been transmitted through the second retardation layer, is denoted by ReR2(λ2), the second retardation layer satisfies the following expression E5, and
the second retardation layer is disposed in an aspect in which a second slow axis which is a slow axis of the second retardation layer is orthogonal to the third absorption axis,

$$ReP 3 ( λ 2 ) / ReR 2 ( λ 2 ) = 1 \pm 0.2 . \qquad expression E 5$$

### (Appendix 13)

The polarizing plate according to the appendix 12,
in which the first absorption axis and the third absorption axis intersect with each other and are not orthogonal to each other, and
in a case where a retardation generated in light having the first wavelength λ1, which has been transmitted through the third light absorption anisotropic layer, is denoted by ReP3(λ1), and a retardation generated in light having the first wavelength λ1, which has been transmitted through the second retardation layer, is denoted by ReR2(λ1), the second retardation layer satisfies the following expression E6,

$$ReP 3 ( λ 1 ) / ReR 2 ( λ 1 ) = 1 \pm 0.2 . \qquad expression E 6$$

The polarizing plate according to any one of the appendices 1 to 5,
in which the first light absorption anisotropic layer contains a fourth dichroic coloring agent in addition to the first dichroic coloring agent, and has a fourth light absorption property in which an absorbance is maximal at a fourth wavelength different from the first wavelength and the second wavelength, in which the first absorption axis is an absorption axis exhibiting the fourth light absorption property in addition to the first light absorption property,
the first light absorption anisotropic layer, a third retardation layer, a fourth retardation layer, and the second light absorption anisotropic layer are laminated in this order from an incident direction of light,
the third retardation layer is a retardation layer which selectively provides a retardation for changing a polarization direction with respect to one light having the first wavelength or the fourth wavelength, which is output from the first light absorption anisotropic layer,
in a case where the first wavelength is denoted by λ1, the fourth wavelength is denoted by λ4, a retardation generated in light the first wavelength λ1 transmitted through the fourth retardation layer is denoted by ReR4(λ1), a retardation generated in light having the first wavelength λ1, which has been transmitted through the second light absorption anisotropic layer, is denoted by ReP2(λ1), a retardation generated in light the fourth wavelength λ4 transmitted through the fourth retardation layer is denoted by ReR4(λ4), and a retardation generated in light having the fourth wavelength λ4, which has been transmitted through the second light absorption anisotropic layer, is denoted by ReP2(λ4), the fourth retardation layer satisfies at least one of the following expression E7-1 or E7-2, and
the fourth retardation layer is disposed in an aspect in which a fourth slow axis which is a slow axis of the fourth retardation layer is orthogonal to the second absorption axis,

$$ReP 2 ( λ 1 ) / ReR 4 ( λ 1 ) = 1 \pm 0.2 , \qquad expression E 7 - 1$$

$$ReP 2 ( λ 4 ) / ReR 4 ( λ 4 ) = 1 \pm 0.2 . \qquad expression E 7 - 2$$

The disclosure of Japanese Patent Application No. 2022-122203 filed on Jul. 29, 2022 is incorporated in the present specification by reference. In addition, all documents, patent applications, and technical standards described in the present specification are incorporated herein by reference to the same extent as in a case of being specifically and individually noted that individual documents, patent applications, and technical standards are incorporated by reference.

What is claimed is:

1. A polarizing plate comprising:
a first light absorption anisotropic layer containing a first dichroic coloring agent, which has a first light absorption property in which an absorbance is maximal at a first wavelength, and has a first absorption axis exhibiting the first light absorption property along one direction; and
a second light absorption anisotropic layer containing a second dichroic coloring agent, which has a second light absorption property in which an absorbance is maximal at a second wavelength different from the first wavelength, and has a second absorption axis exhibiting the second light absorption property along one direction,
wherein the first light absorption anisotropic layer and the second light absorption anisotropic layer are laminated in an aspect in which the first absorption axis and the second absorption axis intersect with each other.

2. The polarizing plate according to claim 1,
wherein at least one of the first wavelength or the second wavelength is in a range of 700 nm or more and 1500 nm or less.

3. The polarizing plate according to claim 1,
wherein both of the first wavelength or the second wavelength are in a range of 700 nm or more and 1500 nm or less.

4. The polarizing plate according to claim 1,
wherein an absolute value of a difference between the first wavelength at which a maximal value is exhibited in a first absorption spectrum of the first light absorption anisotropic layer and the second wavelength at which a maximal value is exhibited in a second absorption spectrum of the second light absorption anisotropic layer is larger than an average value of a half width at half maximum of the first absorption spectrum and a half width at half maximum of the second absorption spectrum.

5. The polarizing plate according to claim 1,
wherein an average of single transmittances in a wavelength range of 400 nm or more and less than 700 nm is 50% or more.

6. The polarizing plate according to claim 1,
wherein the first absorption axis and the second absorption axis are orthogonal to each other, and no retardation layer which provides a retardation in transmitted light is provided between the first light absorption anisotropic layer and the second light absorption anisotropic layer.

7. The polarizing plate according to claim 1,
wherein the first absorption axis and the second absorption axis are not orthogonal to each other,
the polarizing plate includes, between the first light absorption anisotropic layer and the second light absorption anisotropic layer, a first retardation layer that is a retardation layer which provides a retardation in transmitted light, in which in a case where the first wavelength is denoted by λ1, a retardation generated in light having the first wavelength λ1, which has been transmitted through the second light absorption anisotropic layer, is denoted by ReP2(λ1), and a retardation generated in light having the first wavelength λ1, which has been transmitted through the retardation layer, is denoted by ReR1(λ1), the following expression E1 is satisfied, and
the first retardation layer is disposed in an aspect in which a first slow axis which is a slow axis of the first retardation layer is orthogonal to the second absorption axis,
$$ReP 2 ( λ 1 ) / ReR 1 ( λ1 ) = 1 \pm 0.2 . \qquad expression E1$$

8. The polarizing plate according to claim 1,
wherein the first absorption axis and the second absorption axis are not orthogonal to each other, and
in a case where the first wavelength is denoted by λ1 and a retardation generated in light having the first wavelength λ1, which has been transmitted through the second light absorption anisotropic layer, is denoted by ReP2(λ1), the following expression E2-1 or E2-2 is satisfied,
$$ReP 2 ( λ 1 ) / λ 1 = 1 \pm 0.2 , \qquad expression E 7 - 1$$
$$ReP 2 ( λ 1 ) / λ 1 = 0.5 \pm 0.1 . \qquad expression E 7 - 2$$

9. The polarizing plate according to claim 1, further comprising:
a third light absorption anisotropic layer containing a third dichroic coloring agent, which has a third light absorption property in which an absorbance is maximal at a third wavelength different from the first wavelength and the second wavelength, and has a third absorption axis exhibiting the first light absorption property along one direction,
wherein the third light absorption anisotropic layer is disposed in an aspect in which the third absorption axis intersects with at least one of the first absorption axis or the second absorption axis.

10. The polarizing plate according to claim 7, further comprising:
a third light absorption anisotropic layer containing a third dichroic coloring agent, which has a third light absorption property in which an absorbance is maximal at a third wavelength different from the first wavelength and the second wavelength, and has a third absorption axis exhibiting the first light absorption property along one direction,
wherein the third light absorption anisotropic layer is disposed in an aspect in which the third absorption axis intersects with at least one of the first absorption axis or the second absorption axis.

11. The polarizing plate according to claim 10,
wherein the third light absorption anisotropic layer, the first light absorption anisotropic layer, and the second light absorption anisotropic layer are laminated in this order from an incident direction of light,
the first absorption axis and the third absorption axis are parallel to each other, and
in a case where the third wavelength is denoted by λ3 and a retardation generated in light having the third wavelength λ3, which has been transmitted through the second light absorption anisotropic layer, is denoted by ReP2(λ3), two expressions of the expression E2-1 and the following expression E3-1 are satisfied, or two expressions of the expression E2-2 and the following expression E3-2 are satisfied,
$$ReP 2 ( λ 3 ) / λ 3 = 0.5 \pm 0.1 , \qquad expression E 3 - 1$$
$$ReP 2 ( λ 3 ) / λ 3 = 1 \pm 0.2 . \qquad expression E 3 - 2$$

12. The polarizing plate according to claim 10,
wherein the third light absorption anisotropic layer, the first light absorption anisotropic layer, the first retardation layer, and the second light absorption anisotropic layer are laminated in this order from an incident direction of light,
the first absorption axis and the third absorption axis are orthogonal to each other, and
in a case where the third wavelength is denoted by λ3, a retardation generated in light having the third wavelength λ3, which has been transmitted through the second light absorption anisotropic layer, is denoted by ReP2(λ3), and a retardation generated in light having the third wavelength λ3, which has been transmitted through the first retardation layer, is denoted by ReR1(λ3), the following expression E4 is satisfied,
$$ReP 2 ( λ 3 ) / ReR 1 ( λ3 ) = 1 \pm 0.2 . \qquad expression E4$$

13. The polarizing plate according to claim 10,
wherein the first light absorption anisotropic layer, the first retardation layer, the second light absorption anisotropic layer, and the third light absorption anisotropic layer are laminated in this order from an incident direction of light,
the third light absorption anisotropic layer is disposed in an aspect in which the third absorption axis intersects with the first absorption axis and the second absorption axis, the polarizing plate further includes, between the second light absorption anisotropic layer and the third light absorption anisotropic layer, a second retardation layer which provides a retardation in transmitted light,
in a case where a retardation generated in light having a second wavelength λ2, which has been transmitted through the third light absorption anisotropic layer, is denoted by ReP3(λ2), and a retardation generated in light having the second wavelength λ2, which has been transmitted through the second retardation layer, is denoted by ReR2(λ2), the second retardation layer satisfies the following expression E5, and
the second retardation layer is disposed in an aspect in which a second slow axis which is a slow axis of the second retardation layer is orthogonal to the third absorption axis,
$$ReP 3 ( λ 2 ) / ReR 2 ( λ 2 ) = 1 \pm 0.2 . \qquad expression E5$$

14. The polarizing plate according to claim 13,
wherein the first absorption axis and the third absorption axis intersect with each other and are not orthogonal to each other, and
in a case where a retardation generated in light having the first wavelength λ1, which has been transmitted through the third light absorption anisotropic layer, is denoted by ReP3(λ1), and a retardation generated in light having the first wavelength λ1, which has been transmitted through the second retardation layer, is denoted by ReR2(λ1), the second retardation layer satisfies the following expression E6,
$$ReP 3 ( λ 1 ) / ReR 2 ( λ 1 ) = 1 \pm 0.2 . \qquad expression E6$$

15. The polarizing plate according claim 1,
wherein the first light absorption anisotropic layer contains a fourth dichroic coloring agent in addition to the first dichroic coloring agent, and has a fourth light absorption property in which an absorbance is maximal at a fourth wavelength different from the first wavelength and the second wavelength, in which the first absorption axis is an absorption axis exhibiting the fourth light absorption property in addition to the first light absorption property,
the first light absorption anisotropic layer, a third retardation layer, a fourth retardation layer, and the second light absorption anisotropic layer are laminated in this order from an incident direction of light,
the third retardation layer is a retardation layer which selectively provides a retardation for changing a polarization direction with respect to one light having the first wavelength or the fourth wavelength, which is output from the first light absorption anisotropic layer,
in a case where the first wavelength is denoted by λ1, the fourth wavelength is denoted by λ4, a retardation generated in light having the first wavelength λ1 transmitted through the fourth retardation layer is denoted by ReR4(λ1), a retardation generated in light having the first wavelength λ1, which has been transmitted through the second light absorption anisotropic layer, is denoted by ReP2(λ1), a retardation generated in light having the fourth wavelength λ4 transmitted through the fourth retardation layer is denoted by ReR4(λ4), and a retardation generated in light having the fourth wavelength λ4, which has been transmitted through the second light absorption anisotropic layer, is denoted by ReP2(λ4), the fourth retardation layer satisfies at least one of the following expression E7-1 or E7-2, and
the fourth retardation layer is disposed in an aspect in which a fourth slow axis which is a slow axis of the fourth retardation layer is orthogonal to the second absorption axis,
$$ReP 2 ( λ 1 ) / ReR 4 ( λ 1 ) = 1 \pm 0.2 , \qquad expression E 7 - 1$$
$$ReP 2 ( λ 4 ) / ReR 4 ( λ 4 ) = 1 \pm 0.2 . \qquad expression E 7 - 2$$
